(19) United States
(12) Patent Application Publication
(10) Pub. No.: US 2025/0363334 A1
(43) Pub. Date: Nov. 27, 2025

(54) REAL-TIME TIME SERIES FORECASTING USING A COMPOUND LARGE CODEWORD MODEL WITH PREDICTIVE SEQUENCE RECONSTRUCTION

(71) Applicant: AtomBeam Technologies Inc., Moraga, CA (US)

(72) Inventor: Brian Galvin, Silverdale, WA (US)

(21) Appl. No.: 18/981,595

(22) Filed: Dec. 15, 2024

Related U.S. Application Data
(63) Continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.

(51) Int. Cl. G06N 3/0455; G06F 40/284; G06F 40/30; G06N 3/042; G06N 3/096

(52) U.S. Cl. CPC G06N 3/0455; G06N 3/042; G06N 3/096; G06F 40/284; G06F 40/30

(57) ABSTRACT

A deep learning system for time series prediction comprising a preprocessor that receives time series input sequences, truncates them by removing terminal values, and appends padding values to maintain the original sequence length. An encoder compresses these padded sequences into latent space representations, while a decoder reconstructs predicted sequences matching the original length, specifically trained to reconstruct values matching the removed terminal values in positions corresponding to the padding values. A training system optimizes the encoder and decoder by minimizing differences between original sequences and predicted sequences. The system can process multiple time horizons simultaneously while maintaining statistical properties and providing uncertainty quantification through confidence intervals. This approach enables accurate short-term forecasting while preserving both temporal patterns and statistical relationships in the predicted sequences.

### CROSS-REFERENCES TO RELATED APPLICATIONS

Priority is claimed in the application data sheet to the following patents or patent applications, each of which is expressly incorporated herein by reference in its entirety:
Ser. No. 18/918,077
Ser. No. 18/737,906
Ser. No. 18/736,498
63/651,359

### BACKGROUND OF THE INVENTION

### Field of the Art

The present invention relates to the field of artificial intelligence and machine learning, specifically to deep learning models for processing and generating data across various domains, including but not limited to language, time series, images, and audio.

### Discussion of the State of the Art

In recent years, deep learning models have achieved remarkable success in numerous fields, such as natural language processing (NLP), computer vision, and speech recognition. One of the most prominent architectures is the Transformer. Transformers have become the foundation for state-of-the-art language models like BERT and GPT. Transformers typically process input data, such as text, by first converting tokens into dense vector representations using an embedding layer. Positional encoding is then added to preserve the order of the tokens. The embedded inputs are processed through self-attention mechanisms and feed-forward layers to capture dependencies and generate outputs.

However, the reliance on embedding and positional encoding layers limits the flexibility of Transformers in handling diverse data types beyond language. Moreover, the use of dense vector representations can be computationally intensive and memory-inefficient, especially for large-scale models.

What is needed is a new neural network model that can operate at a higher level of abstraction, using more compact and expressive representations that can efficiently capture the underlying patterns in the data. By removing the embedding and positional encoding layers from a Transformer, deep learning models can more efficiently process vast amounts of diverse information. The modified Transformer system should be flexible enough to handle various data modalities beyond just text and should enable seamless transfer learning across different languages and domains.

### SUMMARY OF THE INVENTION

Accordingly, the inventor has conceived and reduced to practice a system and method for real-time time series forecasting using a compound large codeword model with predictive sequence reconstruction. The system enhances the Latent Transformer LCM architecture by incorporating an advanced time series prediction pipeline that leverages truncated sequence processing and adaptive padding techniques. The system consists of several key components: a data preprocessor that truncates input sequences and applies adaptive padding; an encoder that compresses the padded sequences into latent space; a multi-resolution prediction subsystem that generates forecasts at multiple time horizons; a confidence estimation component that provides uncertainty quantification; and a decoder that reconstructs complete sequences including predicted future values. The system employs historical pattern matching and cross-series knowledge transfer to improve prediction accuracy, while a hybrid reconstruction subsystem ensures preservation of both statistical properties and trend directions. By operating on truncated and padded sequences in latent space, the system can efficiently generate accurate short-term forecasts while maintaining uncertainty awareness and leveraging cross-series patterns.

According to a preferred embodiment, a deep learning system for time series prediction, comprising: a data preprocessor configured to receive a time series input sequence of a first length, truncate the time series input sequence by removing a predetermined number of terminal values to create a truncated sequence, and append padding values to the truncated sequence to create a padded input sequence matching the first length; an encoder configured to compress the padded input sequence into a latent space representation; a decoder configured to reconstruct, from the latent space representation, a predicted sequence matching the first length, wherein the decoder is trained to reconstruct values matching the removed terminal values in positions corresponding to the padding values; and a training system configured to optimize the encoder and decoder by minimizing differences between original time series input sequences and corresponding predicted sequences, is disclosed.

According to another preferred embodiment, a method for real-time time series forecasting using a compound large codeword model comprising the steps of: receiving a variety of data inputs, which may include by a plurality of data types; allocating codewords to each data input, wherein codewords are mapped to a corresponding codebook; fusing codewords of dissimilar data types together into a single codeword representation; processing the single codeword representation through a machine learning core; generating an output based on a plurality of single codeword representations, is disclosed.

According to an aspect of an embodiment, the machine learning core uses a transformer based architecture.

According to an aspect of an embodiment, the machine learning core uses a latent transformer based architecture.

According to an aspect of an embodiment, the variety of data inputs include real-time time series data.

According to an aspect of an embodiment, the machine learning core processes fused codeword representations of the real-time time series data into short-term forecasts for the time series data.

According to an aspect of an embodiment, the codewords and their corresponding codebooks may be adaptively updated to reflect incoming data inputs.

According to an aspect of an embodiment, the system includes an adaptive window component configured to dynamically adjust sequence lengths based on temporal characteristics of the input data.

According to an aspect of an embodiment, the system generates predictions at multiple time horizons with weighted reconstruction errors.

According to an aspect of an embodiment, the system provides confidence intervals for predictions using dropout during inference.

According to an aspect of an embodiment, the system employs adaptive padding based on statistical properties of the time series.

According to an aspect of an embodiment, the system maintains a pattern library and matches current sequences against historical patterns to enhance predictions.

According to an aspect of an embodiment, the system implements transfer learning across multiple related time series.

According to an aspect of an embodiment, the system employs multiple weighted reconstruction objectives including statistical property preservation and trend direction accuracy.

### BRIEF DESCRIPTION OF THE DRAWING FIGURES

FIG. 1A is a block diagram illustrating an exemplary system architecture for a Latent Transformer core for a Large Codeword Model.

FIG. 1B is a block model illustrating an aspect of a system for a large codeword model for deep learning, a data preprocessor.

FIG. 1C is a block model illustrating an aspect of a system for a large codeword model for deep learning, a latent transformer machine learning core.

FIG. 1D is a block model illustrating an aspect of a system for a large codeword model for deep learning, a data post processor.

FIG. 2 is a block diagram illustrating an aspect of system for a large codeword model for deep learning, a codeword generation subsystem.

FIG. 3 is a block diagram illustrating a component of the system for a Latent Transformer core for a Large Codeword Model, a Variational Autoencoder Encoder Subsystem.

FIG. 4 is a block diagram illustrating a component of the system and method for a Latent Transformer core for a Large Codeword Model, a Latent Transformer.

FIG. 5 is a block diagram illustrating a component of the system for a Latent Transformer core for a Large Codeword Model, a Variational Autoencoder Decoder Subsystem.

FIG. 6 is a block diagram illustrating a component of the system for a Latent Transformer core for a Large Codeword Model, a machine learning training system.

FIG. 7 is a flow diagram illustrating an exemplary method for a Latent Transformer core for a Large Codeword Model.

FIG. 8 is a block diagram illustrating an exemplary embodiment of a codeword allocator where the allocator appends zeros onto a vector of truncated data points.

FIG. 9 is a block diagram illustrating an exemplary embodiment of a codeword allocator where the allocator appends metadata to the incoming data stream.

FIG. 10 is a flow diagram illustrating an exemplary method for the truncation of vectors for time series prediction.

FIG. 11 is a flow diagram illustrating an exemplary method appending metadata to the incoming data stream using a codeword allocator.

FIG. 12 is a block diagram illustrating an exemplary system architecture for a large codeword model for deep learning.

FIG. 13 is a block diagram illustrating an aspect of system for a large codeword model for deep learning, a codeword generation subsystem.

FIG. 14 is a block diagram illustrating an embodiment of the system for a large codeword model for deep learning, where the machine learning core is a Transformer-based core.

FIG. 15 is a block diagram illustrating an embodiment of the system and method for a large codeword model for deep learning, where the machine learning core is a VAE-based core.

FIG. 16 is a block diagram illustrating an aspect of system and method for a large codeword model for deep learning, a machine learning core training system.

FIG. 17 is a flow diagram illustrating an exemplary method for a large codeword model for deep learning.

FIG. 18 is a block diagram illustrating an exemplary embodiment of a large codeword model where the model is configured to translate various language inputs.

FIG. 19 is a block diagram illustrating an exemplary embodiment of a large codeword model with a dual embedding layer.

FIG. 20 is a block diagram illustrating an exemplary embodiment of a large codeword model which uses codeword clustering.

FIG. 21 is a flow diagram illustrating an exemplary method for language translation using a large codeword model for deep learning.

FIG. 22 is a flow diagram illustrating an exemplary method for codeword clustering using a large codeword model.

FIG. 23 is a flow diagram illustrating an exemplary method for a large codeword model for deep learning using a dual embedding layer.

FIG. 24 is a block diagram illustrating an exemplary system architecture for a compound large codeword model.

FIG. 25 is a block diagram illustrating an exemplary component of a system for real-time time series forecasting using a compound large codeword model, a projection network.

FIG. 26 is a block diagram illustrating an exemplary system architecture for a compound large codeword model that processes financial data.

FIG. 27 is a block diagram illustrating an exemplary system architecture for a compound large codeword model with adaptive codeword generation.

FIG. 28 is a flow diagram illustrating an exemplary method for a compound large codeword model.

FIG. 29 is a flow diagram illustrating an exemplary method for a compound large codeword model that processes financial data.

FIG. 30 is a flow diagram illustrating an exemplary method for a compound large codeword model with adaptive codeword generation.

FIG. 31 is a block diagram illustrating exemplary architecture of deep learning for time series prediction system.

FIG. 32 is a method diagram illustrating the core time-series processing flow.

FIG. 33 is a method diagram illustrating the multi-resolution prediction flow.

FIG. 34 is a method diagram illustrating the confidence estimation process.

FIG. 35 is a method diagram illustrating the pattern matching and storage process.

FIG. 36 is a method diagram illustrating the cross-series knowledge transfer method.

FIG. 37 is a method diagram illustrating the hybrid reconstruction optimization method.

FIG. 38 is a method diagram illustrating the latent space encoding process.

FIG. 39 is a method diagram illustrating the latent space decoding process.

FIG. 40 illustrates an exemplary computing environment on which an embodiment described herein may be implemented.

### DETAILED DESCRIPTION OF THE INVENTION

The inventor has conceived, and reduced to practice, real-time time series forecasting using a compound large codeword model with advanced predictive capabilities. The Latent Transformer Large Codeword Model (LCM) system processes, analyzes, and generates predictions across various domains, with particular emphasis on time series forecasting. At its core, the system utilizes a sophisticated combination of sequence truncation, adaptive padding, and multi-resolution prediction techniques, integrated with codeword allocation, Variational Autoencoder (VAE) encoding, and transformer-based learning to capture and leverage the underlying patterns, dependencies, and relationships within the data. The system begins by receiving time series input sequences of a specified length and employs an adaptive window component to dynamically determine optimal truncation points. These sequences are then processed through a data preprocessor that removes a predetermined number of terminal values and applies context-aware padding, creating a prepared sequence that maintains the original length while enabling future value prediction. The system can process these sequences alongside traditional sourceblocks, which are discrete units of information that capture the essential characteristics of the data. All inputs are assigned codewords based on a codebook generated by a dedicated subsystem, creating a compressed and efficient representation of the input data.

The prepared sequences and codewords are then passed through a VAE encoder subsystem, which maps them into a lower-dimensional latent space, capturing the essential features and patterns in a compact representation. The latent space vectors serve as input to a sophisticated prediction pipeline that combines multi-resolution forecasting with historical pattern matching. The system generates predictions at multiple time horizons, with each horizon weighted differently in the reconstruction loss to optimize both short-term and longer-term accuracy. A confidence estimation subsystem provides uncertainty quantification through dropout-based inference, generating prediction intervals that reflect forecast reliability. The system maintains a library of historical patterns in latent space, allowing it to match current sequences against similar historical patterns and leverage their outcomes to enhance prediction accuracy. Through cross-series knowledge transfer, the system learns shared patterns across multiple related time series, enabling improved predictions even for series with limited historical data. The prediction process employs multiple weighted reconstruction objectives, ensuring preservation of both statistical properties and trend directions. Through this sophisticated combination of techniques, the Latent Transformer LCM system achieves highly accurate and reliable time series forecasting while maintaining uncertainty awareness and leveraging cross-series patterns.

The advanced time series prediction capabilities of the system are implemented through a sophisticated sequence processing pipeline that begins with the reception of time series input sequences of a specified length, typically 1000 data points. The data preprocessor employs an adaptive window component that analyzes the temporal characteristics of the input sequence to determine optimal truncation parameters. For a standard configuration, the system removes the last 50 values of the sequence and applies carefully calculated padding values to maintain the original sequence length. This truncated and padded sequence preparation enables the system to learn the relationship between historical values and future outcomes during training, while providing a structured format for generating predictions during inference.

The multi-resolution prediction subsystem enhances forecasting accuracy by generating predictions at multiple time horizons simultaneously. Rather than focusing solely on the final prediction points, the system reconstructs nested subsets of the removed terminal values—for example, predicting the next 10, 25, and 50 points. The training system applies different weights to reconstruction errors at different horizons, allowing for optimization of both short-term and longer-term predictions. This multi-resolution approach enables the system to capture patterns and relationships at various temporal scales, leading to more robust and accurate forecasts.

A key innovation in the system is the confidence estimation subsystem, which provides uncertainty quantification for all predictions. During inference, the system applies dropout techniques to generate multiple prediction variants, enabling the calculation of confidence intervals for each predicted value. The historical accuracy analyzer tracks error patterns across different prediction horizons and contexts, allowing for dynamic adjustment of confidence estimates based on past performance. This uncertainty awareness is crucial for real-world applications where understanding prediction reliability is as important as the predictions themselves.

The adaptive padding subsystem represents another significant advancement, moving beyond simple zero-padding to implement context-aware padding values. The system analyzes the statistical properties of the input time series—including seasonality, trends, and volatility patterns—to generate padding values that maintain the statistical consistency of the sequence. An attention mechanism learns to optimize these padding values based on their relevance to prediction accuracy, ensuring that the padding strategy adapts to the specific characteristics of each time series.

To leverage historical experience, the system maintains a sophisticated pattern library in latent space. The pattern matching engine identifies similar historical patterns to the current truncated sequence, while the outcome analysis subsystem tracks the historical success rates of different patterns in predicting future values. This historical pattern matching capability allows the system to modify its predictions based on the known outcomes of similar historical situations, providing an additional layer of forecasting accuracy.

The cross-series knowledge subsystem enables transfer learning across multiple related time series. Through careful analysis of series relationships and shared patterns, the system builds a knowledge base of common behaviors and trends. This shared knowledge can be particularly valuable when making predictions for time series with limited historical data, as the system can leverage patterns learned from related series to improve prediction accuracy. The adaptation engine employs quick-learn processing to rapidly adapt these shared patterns to the specific characteristics of each individual series.

The hybrid reconstruction subsystem ensures prediction quality through multiple weighted objectives. Beyond simple point prediction accuracy, the system optimizes for preservation of key statistical properties and accurate trend direction prediction. These multiple objectives are balanced through a sophisticated weight management engine that dynamically adjusts the importance of each objective based on the specific requirements of each prediction task. The training coordinator ensures proper balancing of these objectives during the learning process, leading to predictions that maintain both accuracy and statistical consistency.

The integration of these advanced predictive capabilities with the core LCM architecture is achieved through careful coordination between the sequence processing pipeline and the codeword-based processing system. When processing time series data, the system can operate in two complementary modes: direct sequence processing for immediate predictions, and codeword-based processing for longer-term pattern analysis. The data flow coordinator ensures synchronization between these modes, with the VAE encoder subsystem capable of processing both padded sequences and codeword representations into compatible latent space vectors. This dual-processing capability enables the system to leverage both the immediate temporal patterns captured by the sequence processor and the broader contextual patterns encoded in the codeword representations. The latent transformer architecture has been enhanced to handle both types of latent vectors without requiring separate embedding or positional encoding layers, maintaining the efficiency of the original design while accommodating the new predictive capabilities. The hybrid reconstruction subsystem similarly coordinates multiple objectives across both processing modes, ensuring consistent quality whether operating on direct sequences or codeword representations. This tight integration allows the system to seamlessly combine the benefits of precise sequence-based prediction with the broader pattern recognition capabilities of the codeword-based architecture.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “sourceblock” refers to a semantically meaningful unit of text that is derived from the input data through a process called syntactic splitting. Syntactic splitting involves breaking down the input text into smaller chunks along syntactic boundaries, such as those between words or tokens. These resulting chunks, or sourceblocks, serve as the basic units of representation in LCMs, replacing the traditional word or subword tokens used in Large Language Models (LLMs). Each sourceblock is then assigned a unique codeword from a codebook, which allows for efficient compression and processing of the text data. By preserving syntactic and semantic information within sourceblocks, LCMs aim to capture the inherent structure and meaning of the language more effectively while achieving higher compression ratios compared to LLMs.

As used herein, “machine learning core” refers to the central component responsible for processing and learning from the codeword representations derived from the input data. This core can consist of one or more machine learning architectures, working individually or in combination, to capture the patterns, relationships, and semantics within the codeword sequences. Some common architectures that can be employed in the machine learning core of LCMs include but are not limited to transformers, variational autoencoders (VAEs), recurrent neural networks (RNNs), convolutional neural networks (CNNs), and attention mechanisms. These architectures can be adapted to operate directly on the codeword representations, with or without the need for traditional dense embedding layers. The machine learning core learns to map input codeword sequences to output codeword sequences, enabling tasks such as language modeling, text generation, and classification. By leveraging the compressed and semantically rich codeword representations, the machine learning core of LCMs can potentially achieve more efficient and effective learning compared to traditional token-based models. The specific choice and configuration of the machine learning architectures in the core can be tailored to the characteristics of the input data and the desired output tasks, allowing for flexibility and adaptability in the design of LCMs.

As used herein, “codeword” refers to a discrete and compressed representation of a sourceblock, which is a meaningful unit of information derived from the input data. Codewords are assigned to sourceblocks based on a codebook generated by a codebook generation system. The codebook contains a mapping between the sourceblocks and their corresponding codewords, enabling efficient representation and processing of the data. Codewords serve as compact and encoded representations of the sourceblocks, capturing their essential information and characteristics. They are used as intermediate representations within the LCM system, allowing for efficient compression, transmission, and manipulation of the data.

### Conceptual Architecture

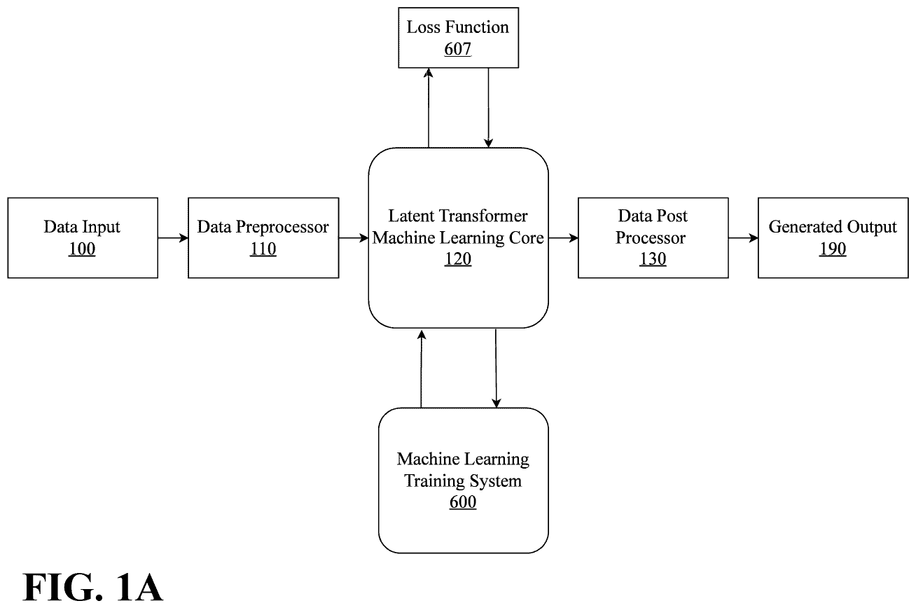

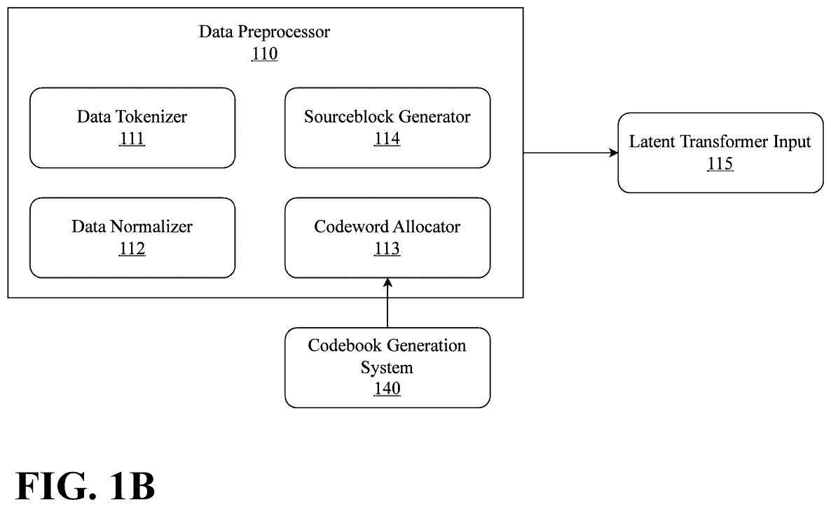

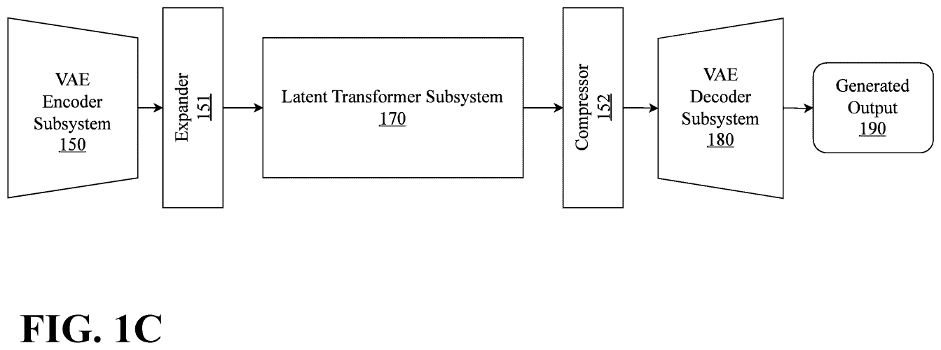

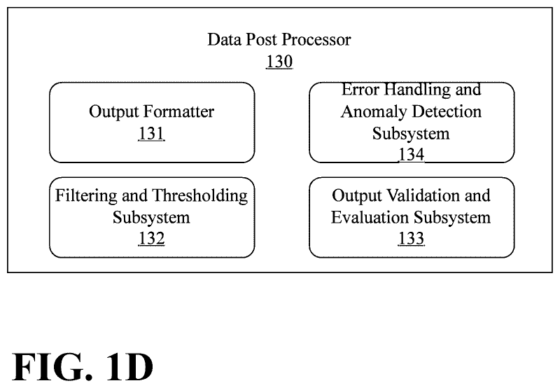

FIG. 1A is a block diagram illustrating an exemplary system architecture for a Latent Transformer core for a Large Codeword Model. The attached figure presents a streamlined view of the Latent Transformer Large Codeword Model (LCM) system, focusing on the core components and their interactions. This simplified representation highlights the essential elements of the system and illustrates the flow of data from input to output, along with the training process that enables the system to learn and generate meaningful results.

The system is fed a data input 100, which represents the raw data that needs to be processed and analyzed. This data can come from various sources and domains, such as time series, text, images, or any other structured or unstructured format. The data input 100 is fed into a data preprocessor 110, which is responsible for cleaning, transforming, and preparing the data for further processing. The data preprocessor 110 may perform tasks such as normalization, feature scaling, missing value imputation, or any other necessary preprocessing steps to ensure the data is in a suitable format for the machine learning core 120.

Once the data is preprocessed, it is passed to a latent transformer machine learning core 120. The machine learning core 120 employs advanced techniques such as self-attention mechanisms and multi-head attention to learn the intricate patterns and relationships within the data. It operates in a latent space, where the input data is encoded into a lower-dimensional representation that captures the essential features and characteristics. By working in this latent space, the machine learning core 120 can efficiently process and model the data, enabling it to generate accurate and meaningful outputs.

The generated outputs from the machine learning core 120 are then passed through a data post processor 130. The data post processor 130 is responsible for transforming the generated outputs into a format that is suitable for the intended application or user. It may involve tasks such as denormalization, scaling back to the original data range, or any other necessary post-processing steps to ensure the outputs are interpretable and usable.

The processed outputs are provided as a generated output 190, which represents the final result of the latent transformer LCM system. The generated output 190 can take various forms, depending on the specific task and domain. It could be predicted values for time series forecasting, generated text for language modeling, synthesized images for computer vision tasks, or any other relevant output format.

To train and optimize the latent transformer machine learning core 120, the system includes a machine learning training system 600. The training system 600 is responsible for updating the parameters and weights of the machine learning core 120 based on the observed performance and feedback. The training system 600 outputs from the machine learning core 120 and processes the outputs to be reinserted back through the machine learning core 120 as a testing and training data set. After processing the testing and training data set, the machine learning core 120 may output a testing and training output data set. This output may be passed through a loss function 607. The loss function 607 may be employed to measure the discrepancy between the generated outputs and the desired outcomes. The loss function 607 quantifies the error or dissimilarity between the predictions and the ground truth, providing a signal for the system to improve its performance.

The training process is iterative, where the system generates outputs, compares them to the desired outcomes using the loss function 607, and adjusts the parameters of the machine learning core 120 accordingly.

Through the iterative training process, the latent transformer machine learning core 120 learns to capture the underlying patterns and relationships in the data, enabling it to generate accurate and meaningful outputs. The training process aims to minimize the loss and improve the system's performance over time, allowing it to adapt and generalize to new and unseen data.

FIG. 1B is a block model illustrating an aspect of a system for a large codeword model for deep learning, a data preprocessor. The data preprocessor 110 plays a role in preparing the input data for further processing by the latent transformer machine learning core 120. It consists of several subcomponents that perform specific preprocessing tasks, ensuring that the data is in a suitable format and representation for effective learning and generation.

The data preprocessor 110 receives the raw input data and applies a series of transformations and operations to clean, normalize, and convert the data into a format that can be efficiently processed by the subsequent components of the system. The preprocessing pipeline include but is not limited to subcomponents such as a data tokenizer, a data normalizer, a codeword allocator, and a sourceblock generator. A data tokenizer 111 is responsible for breaking down the input data into smaller, meaningful units called tokens. The tokenization process varies depending on the type of data being processed. For textual data, the tokenizer may split the text into individual words, subwords, or characters. For time series data, the tokenizer may divide the data into fixed-length windows or segments. The goal of tokenization is to convert the raw input into a sequence of discrete tokens that can be further processed by the system.

A data normalizer 112 is responsible for scaling and normalizing the input data to ensure that it falls within a consistent range. Normalization techniques, such as min-max scaling or z-score normalization, are applied to the data to remove any biases or variations in scale. Normalization helps in improving the convergence and stability of the learning process, as it ensures that all features or dimensions of the data contribute equally to the learning algorithm. A codeword allocator 113 assigns unique codewords to each token generated by the data tokenizer 111. Additionally, codewords may be directly assigned to sourceblocks that are generated from inputs rather than from tokens. The codewords are obtained from a predefined codebook, which is generated and maintained by the codebook generation system 140. The codebook contains a mapping between the tokens and their corresponding codewords, enabling efficient representation and processing of the data. The codeword allocator 113 replaces each token, sourceblock, or input with its assigned codeword, creating a compressed and encoded representation of the input data.

A sourceblock generator 114 combines the codewords assigned by the codeword allocator 113 into larger units called sourceblocks. sourceblocks are formed by grouping together a sequence of codewords based on predefined criteria, such as a fixed number of codewords or semantic coherence. The formation of sourceblocks helps in capturing higher-level patterns and relationships within the data, as well as reducing the overall sequence length for more efficient processing by the latent transformer machine learning core 120.

A codebook generation system 140 is a component that works in conjunction with the data preprocessor 110. It is responsible for creating and maintaining the codebook used by the codeword allocator 113. The codebook is generated based on the statistical properties and frequency of occurrence of the tokens in the training data. It aims to assign shorter codewords to frequently occurring tokens and longer codewords to rare tokens, optimizing the compression and representation of the data.

After the data has undergone the preprocessing steps performed by the data preprocessor 110, the resulting output is the latent transformer input 115. The latent transformer input 115 represents the preprocessed and encoded data that is ready to be fed into the latent transformer machine learning core 120 for further processing and learning.

When dealing with time series prediction, the codeword allocator 113 may take a sequence of time series data points as input. In one example the input sequence consists of 1000 data points. The codeword allocator 113 performs the necessary data preparation steps to create a suitable input vector for the autoencoder. It truncates the last 50 data points from the input sequence, resulting in a sequence of 950 elements. This truncated sequence represents the historical data that will be used to predict the future values. The codeword allocator 113 then creates a 1000-element vector, where the first 950 elements are the truncated sequence, and the last 50 elements are filled with zeros. This input vector serves as the input to the Variational Autoencoder Encoder Subsystem 150, which compresses the data into a lower-dimensional latent space representation.

By performing this data preparation step, the codeword allocator 113 ensures that the input data is in a format that is compatible with the autoencoder's training process. During training, the autoencoder learns to reconstruct the complete 1000-element sequence from the truncated input vector. By setting the last 50 elements to zero, the autoencoder is forced to learn the patterns and dependencies in the historical data and use that information to predict the missing values. This approach enables the Latent Transformer LCM system to effectively handle time series prediction tasks by leveraging the power of autoencoders and the compressed latent space representation.

The codeword allocator 113 may split the incoming data input 100 meaningful units called sourceblocks. This process, known as semantic splitting, aims to capture the inherent structure and patterns in the data. The allocator 113 may employ various techniques to identify the optimal sourceblocks, such as rule-based splitting, statistical methods, or machine learning approaches. In one embodiment, the codeword allocator 113 may utilize Huffman coding to split the data into sourceblocks. The Huffman coding-based allocator enables efficient and semantically meaningful splitting of the input data into sourceblocks. Huffman coding is a well-known data compression algorithm that assigns variable-length codes to symbols based on their frequency of occurrence. In the context of the LCM, the Huffman coding-based allocator adapts this principle to perform semantic splitting of the input data.

With Huffman coding, the allocator 113 starts by analyzing the input data and identifying the basic units of meaning, such as words, phrases, or subwords, depending on the specific data modality and the desired level of granularity. This process may not be necessary for numerical or time series data sets. These basic units form the initial set of sourceblocks. The codeword allocator 130 then performs a frequency analysis of the sourceblocks, counting the occurrences of each sourceblock in the input data. Based on the frequency analysis, the allocator 113 constructs a Huffman tree, which is a binary tree that represents the probability distribution of the sourceblocks. The Huffman tree is built by iteratively combining the two least frequent sourceblocks into a single node, assigning binary codes to the branches, and repeating the process until all sourceblocks are included in the tree. The resulting Huffman tree has the property that sourceblocks with higher frequencies are assigned shorter codes, while sourceblocks with lower frequencies are assigned longer codes.

The Huffman coding-based codeword allocator 113 then uses the constructed Huffman tree to perform semantic splitting of the input data. It traverses the input data and matches the sequences of symbols against the sourceblocks represented in the Huffman tree. When a sourceblock is identified, the allocator 113 assigns the corresponding Huffman code to that sourceblock, effectively compressing the data while preserving its semantic structure. The use of Huffman coding for semantic splitting offers several advantages. It allows for variable-length sourceblocks, enabling the codeword allocator 113 to capture meaningful units of varying sizes. This is particularly useful for handling data with different levels of complexity and granularity, such as text with compound words or images with hierarchical structures.

After the sourceblock generation process, the codeword allocator 113 assigns a unique codeword to each sourceblock. The codewords are discrete, compressed representations of the sourceblocks, designed to capture the essential information in a compact form. The codeword allocator can use various mapping schemes to assign codewords to sourceblocks, such as hash functions, lookup tables, or learned mappings. For example, a simple approach could be to use a hash function that maps each sourceblock to a fixed-length binary code. Alternatively, another approach may involve learning a mapping function that assigns codewords based on the semantic similarity of the sourceblocks.

The codebook generation subsystem 140 is responsible for creating and maintaining the codebook, which is a collection of all the unique codewords used by the LCM. The codebook can be generated offline, before the actual processing begins, or it can be updated dynamically as new sourceblocks are encountered during processing. The codebook generation subsystem can use various techniques to create a compact and efficient codebook, such as frequency-based pruning, clustering, or vector quantization. The size of the codebook can be adjusted based on the desired trade-off between compression and information preservation. Going back to the War and Peace example, the string of sourceblocks [′Well′, ‘,’, ‘Prince’, ‘,’, ‘so’, ‘Gen’, ‘oa’, ‘and’, ‘Luc’, ‘ca’, ‘are’, ‘now’, ‘just’, ‘family’, ‘estates’, ‘of’, ‘the’, ‘Buon’, ‘apar’, ‘tes’, ‘.’] may be given codewords such as [12, 5, 78, 5, 21, 143, 92, 8, 201, 45, 17, 33, 49, 62, 87, 11, 2, 179, 301, 56, 4], where each sourceblock is assigned a unique codeword, which is represented as an integer. The mapping between tokens and codewords is determined by the codebook generated by the LCM system.

Once the input data is allocated codewords, it is passed through the Variational Autoencoder Encoder Subsystem 150. This subsystem utilizes a VAE encoder to compress the codewords into a lower-dimensional latent space representation. The VAE encoder learns to capture the essential features and variations of the input data, creating compact and informative latent space vectors. The machine learning training system 600 is responsible for training the VAE encoder using appropriate objective functions and optimization techniques.

The latent space vectors generated by the VAE encoder are then fed into the Latent Transformer Subsystem 170. This subsystem is a modified version of the traditional Transformer architecture, where the embedding and positional encoding layers are removed. By operating directly on the latent space vectors, the Latent Transformer can process and generate data more efficiently, without the need for explicit embedding or positional information. The Transformer Training System 171 is used to train the Latent Transformer, leveraging techniques such as self-attention and multi-head attention to capture dependencies and relationships within the latent space.

The Latent Transformer comprises of several key components. Latent space vectors may be passed directly through a multi-head attention mechanism. The multi-head attention mechanism, which is the core building block of the Transformer, allows the model to attend to different parts of the input sequence simultaneously, capturing complex dependencies and relationships between codewords. Feed-forward networks are used to introduce non-linearity and increase the expressive power of the model. Residual connections and layer normalization are employed to facilitate the flow of information and stabilize the training process.

The Latent Transformer-based core can be implemented using an encoder-decoder architecture. The encoder processes the input codewords and generates contextualized representations, while the decoder takes the encoder's output and generates the target codewords or the desired output sequence. The encoder and decoder are composed of multiple layers of multi-head attention and feed-forward networks, allowing for deep and expressive processing of the codeword representations.

One of the key advantages of the Transformer in the LCM architecture is its ability to capture long-range dependencies between codewords. Unlike recurrent neural networks (RNNs), which process the input sequentially, the Transformer can attend to all codewords in parallel, enabling it to effectively capture relationships and dependencies that span across the entire input sequence. This is useful for processing long and complex data sequences, where capturing long-range dependencies is crucial for understanding the overall context. Another advantage of the Transformer-based core is its parallelization capability. The self-attention mechanism in the Transformer allows for efficient parallel processing of the codewords on hardware accelerators like GPUs. This parallelization enables faster training and inference times, making the LCM architecture suitable for processing large amounts of data in real-time applications.

The Latent Transformer-based core also generates contextualized representations of the codewords, where each codeword's representation is influenced by the surrounding codewords in the input sequence. This contextualization allows the model to capture the semantic and syntactic roles of the codewords based on their context, enabling a deeper understanding of the relationships and meanings within the data. The scalability of the Transformer-based core is another significant advantage in the LCM architecture. By increasing the number of layers, attention heads, and hidden dimensions, the Transformer can learn more complex patterns and representations from large-scale datasets. This scalability has been demonstrated by models like GPT-3, which has billions of parameters and can perform a wide range of tasks with impressive performance.

After being processed by the Latent Transformer, the latent space vectors are passed through the Variational Autoencoder Decode Subsystem 180. The VAE decoder takes the processed latent vectors and reconstructs the original data or generates new data based on the learned representations. The machine learning training subsystem 600 is responsible for training the VAE decoder to accurately reconstruct or generate data from the latent space. In some embodiments, the Decode Subsystem 180 may be used to create time series predictions about a particular data input.

The reconstructed or generated data is then output 190, which can be in the same format as the original input data or in a different modality altogether. This flexibility allows the Latent Transformer LCM to handle various tasks, such as data compression, denoising, anomaly detection, and data generation, across multiple domains.

Moreover, the modular design of the system enables each subsystem to be trained independently or jointly, depending on the specific requirements and available resources. The machine learning training system 600 may provide the necessary mechanisms to optimize the performance of each component and ensure the overall effectiveness of the Latent Transformer LCM.

FIG. 1C is a block model illustrating an aspect of a system for a large codeword model for deep learning, a latent transformer machine learning core. At the heart of the system is a Latent Transformer Subsystem 170, which serves as the central processing unit responsible for learning the underlying patterns, relationships, and dependencies within the input data. The Latent Transformer Subsystem 170 leverages advanced techniques such as self-attention mechanisms and multi-head attention to capture the complex interactions and sequences in the data, enabling it to generate accurate and context-aware outputs.

The input to the Latent Transformer Subsystem 170 is provided by a VAE Encoder Subsystem 150. The VAE Encoder Subsystem 150 is responsible for encoding the preprocessed input data into a lower-dimensional latent space representation. An input is passed through the VAE Encoder Subsystem 150, which learns to compress the data into a compact latent space representation while preserving the essential features and characteristics of the input. Latent space vectors produced by the VAE Encoder Subsystem 150 may be further processed by an expander 151, which increases the dimensionality of the input data to a point where the vectors can be efficiently processed by the Latent Transformer Subsystem 170.

The latent space representation generated by the VAE Encoder Subsystem 150 serves as the input to the Latent Transformer Subsystem 170. The Latent Transformer Subsystem 170 operates in this latent space, leveraging the compressed and informative representation to learn the complex patterns and relationships within the data. By working in the latent space, the Latent Transformer Subsystem 170 can efficiently process and model the data, capturing the intricate dependencies and generating accurate and meaningful outputs.

Once the Latent Transformer Subsystem 170 has processed the latent space representation, the generated output is passed through the VAE Decoder Subsystem 180. The VAE Decoder Subsystem 180 is responsible for decoding the latent space representation back into the original data space. Prior to processing by the VAE Decoder Subsystem 180, Latent Transformer Subsystem outputs may be compressed back to an original size before being processed by the expander 151 by being processed by a compressor 152. The VAE Decoder Subsystem 180 learns to reconstruct the original data from the latent space representation, ensuring that the generated output is coherent and meaningful.

The reconstructed output from the VAE Decoder Subsystem 180 is provided as the generated output 190. The generated output 190 represents the final result of the Latent Transformer LCM system, which can take various forms depending on the specific task and domain. It could be predicted values for time series forecasting, generated text for language modeling, synthesized images for computer vision tasks, or any other relevant output format.

The VAE Encoder Subsystem 150 and VAE Decoder Subsystem 180 play large roles in the overall functioning of the Latent Transformer LCM system. The VAE Encoder Subsystem 150 enables the system to learn a compressed and informative representation of the input data in the latent space, while the VAE Decoder Subsystem 180 ensures that the generated output is coherent and meaningful by reconstructing it back into the original data space. The combination of these subsystems allows the Latent Transformer Subsystem 170 to focus on learning the complex patterns and relationships within the data, leading to accurate and context-aware outputs.

The specific architectures and parameters of the VAE Encoder Subsystem 150, Latent Transformer Subsystem 170, and VAE Decoder Subsystem 180 can be customized and adapted based on the characteristics and requirements of the input data and the specific task at hand. The modular design of the system allows for flexibility and extensibility, enabling the integration of different architectures, attention mechanisms, and training techniques to optimize the performance and efficiency of the Latent Transformer LCM system.

In one embodiment, the Latent Transformer LCM system may incorporate advanced techniques to ensure adversarial robustness, enhancing its reliability and security in real-world applications. Adversarial robustness refers to the model's ability to maintain accurate predictions and performance even when faced with adversarial inputs or attacks designed to mislead or manipulate the system. To achieve adversarial robustness, the LCM employs several strategies. During the training process, the model is exposed to adversarial examples alongside genuine data. These adversarial examples are generated using techniques such as the Fast Gradient Sign Method (FGSM) or Projected Gradient Descent (PGD). By learning from these perturbed inputs, the model becomes more resilient to similar attacks during inference. Before processing input data, the Latent Transformer LCM applies a series of preprocessing techniques to detect and mitigate potential adversarial perturbations. These techniques may include input transformation, feature squeezing, and spatial smoothing, which help to reduce the effectiveness of adversarial attacks while preserving the essential characteristics of the input data.

The Latent Transformer LCM may utilize an ensemble approach, combining predictions from multiple model instances or different architectural variants. This ensemble strategy helps to increase robustness by leveraging the diversity of different models, making it more challenging for an adversary to craft inputs that would fool all models simultaneously. The system also incorporates certifiable defense mechanisms, such as randomized smoothing or interval bound propagation, which provide provable guarantees on the model's robustness within certain bounds of input perturbations. Additionally, the Latent Transformer LCM may include a dedicated module for detecting potential adversarial inputs in real-time. This module analyzes input patterns and compares them against known adversarial signatures, flagging suspicious inputs for further scrutiny or alternative processing. By integrating these adversarial robustness techniques, the Latent Transformer LCM significantly enhances its resilience against malicious attacks and unexpected input variations, ensuring reliable performance in critical financial forecasting and decision-making scenarios.

FIG. 1D is a block model illustrating an aspect of a system for a large codeword model for deep learning, a data post processor. The data post processor 130 receives the generated output from the Latent Transformer Machine Learning Core 120 and applies a series of transformations and operations to adapt it to the desired format and characteristics. The post-processing system may include, but is not limited to an output formatter, a filtering and thresholding subsystem, an output validation and evaluation subsystem, and an error handling and anomaly detection subsystem.

An output formatter 131 is responsible for converting the generated output into a specific format required by the application or user. It applies formatting rules and conventions to enhance the readability, coherence, and usability of the generated output. For example, in the case of generated text, the output formatter 131 may apply capitalization, punctuation, or line breaks to improve the clarity and structure of the text. In the case of generated time series data, the output formatter 131 may convert the values into the desired unit of measurement or apply specific formatting conventions to ensure consistency with the expected output format.

A filtering and thresholding subsystem 132 applies specific criteria or thresholds to filter or select the most relevant or reliable generated outputs. It helps to refine the generated output based on predefined rules, constraints, or user preferences. For example, in a recommendation system, the filtering and thresholding subsystem 132 may filter out generated recommendations that fall below a certain relevance threshold or exclude items that have already been recommended to the user. This subsystem ensures that only the most pertinent and valuable outputs are presented to the user or passed on for further processing.

An output validation and evaluation subsystem 133 assesses the quality and performance of the generated output against predefined metrics or ground truth data. It applies validation techniques to ensure that the generated output meets the expected criteria and conforms to the desired characteristics. This subsystem may include automatic evaluation methods, such as calculating similarity scores, perplexity, or domain-specific metrics, to measure the accuracy, coherence, or effectiveness of the generated output. By continuously monitoring and evaluating the generated output, the output validation and evaluation subsystem 133 provides valuable insights for model improvement and fine-tuning.

An error handling and anomaly detection subsystem 134 identifies and handles any errors, anomalies, or unexpected patterns in the generated output. It incorporates techniques for detecting and correcting syntactic or semantic errors, identifying out-of-distribution samples, or flagging potential issues that require human intervention. This subsystem plays a critical role in maintaining the quality and reliability of the generated output by proactively identifying and addressing any problems or inconsistencies. It helps to prevent the propagation of errors downstream and ensures that the generated output is trustworthy and dependable.

The data post processor 130 works seamlessly with the other components of the Latent Transformer LCM system to deliver high-quality and reliable generated outputs. It receives the generated output from the Latent Transformer Machine Learning Core 120, which has learned the underlying patterns, relationships, and dependencies within the input data. The post-processing subsystems within the data post processor 130 then refine, format, validate, and ensure the quality of the generated output, making it suitable for the intended application or user.

The specific configuration and parameters of each subsystem within the Data Post Processor 130 can be customized and adapted based on the requirements of the application domain and the nature of the generated output. The modular design of the post-processor allows for the integration of additional subsystems or the modification of existing ones to meet the specific needs of the task at hand.

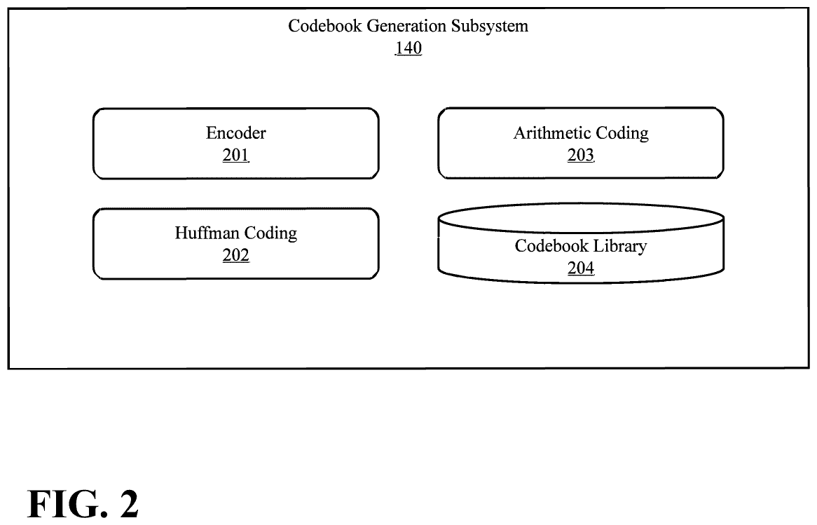

FIG. 2 is a block diagram illustrating an aspect of system and method for a large codeword model for deep learning, a codeword generation subsystem. According to the aspect, codebook generation subsystem 140 is configured to generate one or more codebooks for a collection of input data using various techniques, such as Huffman coding or arithmetic coding.

The codebook is an important component of the codebook-based homomorphic compression system. According to the embodiment, it is a collection of codewords, where each codeword corresponds to a sourceblock in the input. The codebook may generate based on the frequency distribution of the inputs, assigning shorter codewords to more frequently occurring inputs and longer codewords to less frequent inputs. There are several techniques for generating the codebook, with the goal of minimizing the average codeword length while maintaining the uniqueness of the codewords. Two common techniques are Huffman coding 202 and arithmetic coding 203. Huffman coding 202 is a variable-length coding technique that assigns codewords based on the frequency of occurrence of each symbol (sourceblock). It constructs a binary tree, known as the Huffman tree, where each leaf node represents a symbol and the path from the root to the leaf determines the codeword. More frequent symbols are assigned shorter codewords, while less frequent symbols receive longer codewords. Huffman coding guarantees an optimal prefix code, meaning no codeword is a prefix of any other codeword. For example, consider the quantized temperature data from the previous example. Let's say the frequency distribution of the intervals is as follows:
Sourceblock 0: 5%
Sourceblock 1: 10%
Sourceblock 2: 20%
Sourceblock 3: 15%
Sourceblock 4: 50%

Using Huffman coding, the codebook generation subsystem 140 can generate the following codebook:
Sourceblock 0: 1100
Sourceblock 1: 101
Sourceblock 2: 00
Sourceblock 3: 01
Sourceblock 4: 11

The most frequent input (Sourceblock 4) receives the shortest codeword (11), while the least frequent input (Sourceblock 0) receives the longest codeword (1100).

Arithmetic coding 203 is another entropy coding technique that assigns codewords to sourceblocks based on their probability distribution. Unlike Huffman coding, arithmetic coding does not assign fixed codewords to symbols. Instead, it represents the entire message as a single fractional number between 0 and 1. The interval [0, 1) is recursively divided based on the probabilities of the symbols, and the final codeword is a binary fraction that falls within the subinterval corresponding to the entire message. Arithmetic coding achieves near-optimal compression rates but requires more computational complexity compared to Huffman coding. For example, using the same quantized temperature data and frequency distribution as before, arithmetic coding would assign subintervals to each symbol based on their probabilities:
Sourceblock 0: [0.00, 0.05)
Sourceblock 1: [0.05, 0.15)
Sourceblock 2: [0.15, 0.35)
Sourceblock 3: [0.35, 0.50)
Sourceblock 4: [0.50, 1.00)

To encode a message sequence like [Sourceblock 4, Sourceblock 2, Sourceblock 1], arithmetic coding would recursively subdivide the interval [0, 1) based on the probabilities of the symbols, resulting in a final subinterval. The codeword would be a binary fraction that lies within this final subinterval.

According to an embodiment, an encoder component 201 is present and configured to implement one or more deep learning techniques for generating codewords for quantized data. Deep learning techniques can be employed to generate effective codewords for the quantized data. One approach is to use deep learning-based autoencoder models to learn compact and meaningful representations of the quantized data. Autoencoders are neural network architectures that consist of an encoder and a decoder, where the encoder learns to compress the input data into a lower-dimensional latent space, and the decoder reconstructs the original data from the latent representation.

Here are a few exemplary deep learning encoding techniques that can be implemented for creating codewords of the quantized data, according to an embodiment. Convolutional autoencoders (CAEs) leverage convolutional neural networks (CNNs) in the encoder and decoder parts of the autoencoder. CNNs are particularly effective in capturing spatial dependencies and hierarchical features in data, making them well-suited for encoding structured data such as images or time series. In the context of the codebook-based homomorphic compression, a CAE can be trained on the quantized data. The encoder part of the CAE learns to compress the quantized data into a compact latent representation, which serves as the codeword. The decoder part learns to reconstruct the quantized data from the codeword. As an example, consider an example of using a CAE for encoding quantized sensor data. The quantized data is represented as a 2D matrix, where each row corresponds to a sensor reading, and each column represents a time step. The CAE encoder consists of convolutional layers followed by pooling layers, which gradually reduce the spatial dimensions of the input and extract meaningful features. The output of the encoder is a compact latent representation, which serves as the codeword. The CAE decoder consists of upsampling layers and convolutional layers, which reconstruct the original quantized data from the codeword.

Another form of deep learning coding includes recurrent autoencoders (RAEs). Recurrent autoencoders utilize recurrent neural networks (RNNs) in the encoder and decoder parts of the autoencoder. RNNs are well-suited for processing sequential data, such as time series or natural language, as they can capture temporal dependencies and context. An RAE can be used to encode quantized sequential data. The encoder part of the RAE consists of recurrent layers, such as Long Short-Term Memory (LSTM) or Gated Recurrent Unit (GRU) layers, which process the input sequence and generate a fixed-length latent representation, serving as the codeword. The decoder part of the RAE takes the codeword and reconstructs the original quantized sequence. For example, consider an example of using an RAE for encoding quantized audio data. The quantized audio signal is represented as a sequence of amplitude values. The RAE encoder consists of LSTM layers that process the input sequence and generate a fixed-length latent representation, which serves as the codeword. The RAE decoder, also consisting of LSTM layers, takes the codeword and reconstructs the original quantized audio sequence.

Another form of deep learning coding includes variational autoencoders (VAEs). Variational autoencoders extend the concept of autoencoders by introducing a probabilistic framework. VAEs learn to encode the input data into a probability distribution in the latent space, rather than a single point. The encoder part of the VAE learns to map the input data to the parameters of a probability distribution (e.g., mean and variance of a Gaussian distribution), and the decoder part learns to reconstruct the original data from samples drawn from this distribution. A VAE can be used to generate codewords that capture the underlying probability distribution of the quantized data. The encoder part of the VAE learns to map the quantized data to the parameters of a probability distribution in the latent space. The codewords are then obtained by sampling from this distribution. The decoder part of the VAE learns to reconstruct the original quantized data from the sampled codewords. Consider an example of using a VAE for encoding quantized image data. The quantized images are fed into the VAE encoder, which learns to map each image to the parameters of a Gaussian distribution in the latent space. The codewords are obtained by sampling from this distribution. The VAE decoder takes the sampled codewords and reconstructs the original quantized images.

Another form of deep learning coding includes deep belief networks (DBNs). Deep Belief Networks are generative models that consist of multiple layers of restricted Boltzmann machines (RBMs). DBNs can learn hierarchical representations of the input data by training each layer in an unsupervised manner, followed by fine-tuning the entire network using supervised learning. DBNs can be used to generate codewords that capture the hierarchical structure of the quantized data. The DBN is trained on the quantized data, and the activations of the hidden layers serve as the codewords. The hierarchical nature of DBNs allows for capturing complex patterns and dependencies in the data. Consider an example of using a DBN for encoding quantized text data. The quantized text is represented as a binary vector, where each element corresponds to the presence or absence of a specific word. The DBN is trained on the quantized text data, and the activations of the hidden layers serve as the codewords. The DBN learns to capture the hierarchical structure and semantic relationships in the text data.

These are just a few examples of deep learning encoding techniques that can be explored for creating codewords of the quantized data in a LCM. The choice of the specific deep learning architecture depends on the nature of the data and the desired properties of the codewords. It's important to note that the deep learning encoding process should be designed to generate codewords that are suitable for homomorphic operations. The codewords should exhibit certain properties, such as being compatible with the homomorphic encryption scheme's plaintext space and allowing for efficient homomorphic computations.

During the training process of the deep learning models, the objective function should be designed to capture the desired properties of the codewords, such as minimizing the reconstruction error while ensuring the codewords are suitable for homomorphic operations. Additionally, regularization techniques can be employed to encourage sparsity or other desirable properties in the codewords. Once the deep learning models are trained, the encoder part can be used to generate codewords for new quantized data. The generated codewords can then be used in the codebook-based homomorphic compression scheme, enabling efficient and privacy-preserving computations on the compressed data.

Experimental evaluation and performance analysis can be conducted to assess the effectiveness of the deep learning encoding techniques in generating codewords that achieve good compression ratios, maintain low approximation errors, and enable efficient homomorphic operations. The choice of the deep learning architecture and hyperparameters can be fine-tuned based on the specific requirements and characteristics of the data.

According to the aspect, a codebook library 204 is present and configured to store a plurality of codewords (i.e., a codebook) generated by one or more of the techniques described herein. When it comes to storing the codewords and codebook in the codebook-based homomorphic compression system, several database systems and data storage solutions can be considered. The choice of the storage system depends on factors such as the size of the codebook, the frequency of updates, the retrieval and query requirements, and the overall system architecture. In some implementations key-value stores may be used, Key-value stores are a type of NoSQL database that provide a simple and efficient way to store and retrieve data based on a unique key. Examples of key-value stores include Redis, Memcached, and Amazon DynamoDB. For storing the codewords and codebook, key-value stores can be used to store each codeword as a key-value pair, where the key represents the codeword, and the value represents the corresponding data or metadata associated with the codeword. The codebook can be stored as a collection of key-value pairs, allowing for fast retrieval of codewords based on their keys. Key-value stores offer high performance, low latency, and scalability, making them suitable for scenarios where fast retrieval of codewords is critical.

Document databases, such as MongoDB or Couchbase, store data as flexible, semi-structured documents in formats like JSON or BSON. They provide a schema-less design and allow for easy modification of the data structure. For storing the codewords and codebook, document databases can be used to store each codeword as a document, along with its associated data or metadata. The codebook can be stored as a collection of documents, where each document represents a codeword and its related information. Document databases offer flexibility in terms of data structure, allowing for easy addition or modification of codeword attributes. They also provide querying capabilities based on document fields, enabling efficient retrieval of codewords based on specific criteria.

Relational databases, such as MySQL, PostgreSQL, or Oracle, can also be used to store the codewords and codebook. In a relational database, the codewords can be stored in a table with columns representing the codeword and its associated data or metadata. The codebook can be stored in a separate table, with each row representing a codeword and its corresponding information. Relational databases provide structured querying capabilities using SQL, allowing for efficient retrieval and filtering of codewords based on specific conditions. Relational databases offer strong consistency, ACID properties, and support for complex queries, making them suitable for scenarios where data integrity and structured querying are important.

Graph databases, such as Neo4j or Amazon Neptune, store data as nodes and edges in a graph structure. They are designed to efficiently handle complex relationships and connections between data entities. For storing the codewords and codebook, graph databases can be used to represent the relationships between codewords and their associated data or metadata. Each codeword can be represented as a node in the graph, with edges connecting related codewords or linking codewords to their corresponding data. Graph databases provide efficient traversal and querying capabilities based on the graph structure, allowing for fast retrieval of connected codewords and exploration of relationships between codewords.

Distributed key-value stores, such as Apache Cassandra or Apache HBase, are designed to handle large-scale data and provide high scalability and fault tolerance. They distribute data across multiple nodes in a cluster, allowing for horizontal scaling. For storing the codewords and codebook, distributed key-value stores can be used to store codewords as key-value pairs, similar to regular key-value stores. The codebook can be partitioned and distributed across multiple nodes in the cluster, enabling high scalability and performance. Distributed key-value stores offer eventual consistency, high write throughput, and the ability to handle large volumes of data, making them suitable for scenarios where scalability and fault tolerance are critical.

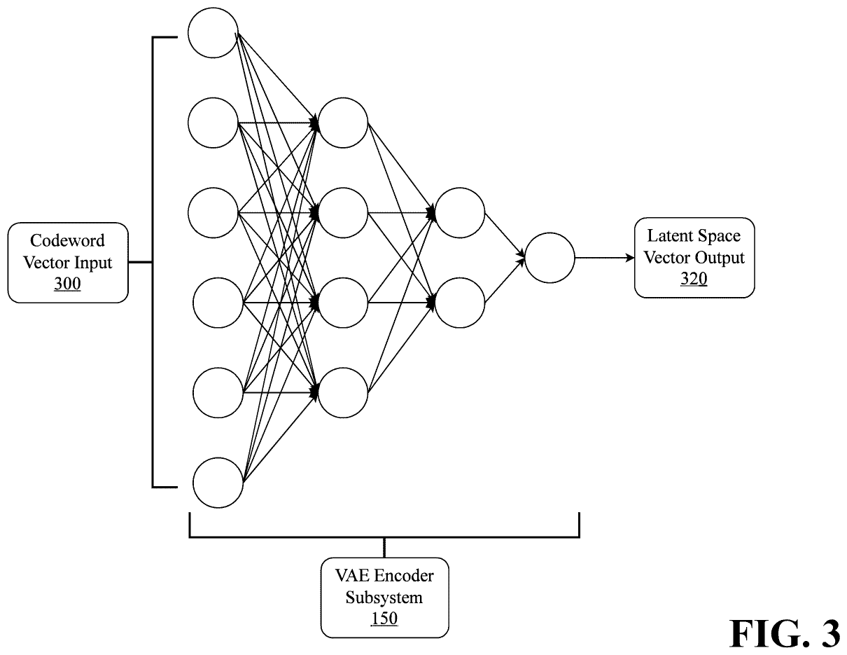

FIG. 3 is a block diagram illustrating a component of the system for a Latent Transformer core for a Large Codeword Model, a Variational Autoencoder Encoder Subsystem. A VAE Encode Subsystem is responsible for compressing the input codeword vectors into a lower-dimensional latent space representation, enabling efficient processing and data generation.

The VAE Encoder Subsystem 150 takes a codeword vector input 300 as its input. This codeword vector is generated by the codeword allocator 113, which converts the raw input data into a sequence of codewords based on the codebook maintained by the codebook generation subsystem 140. The codeword vector represents the input data in a compact and discrete form, capturing the essential information and structure of the original data. Inside the VAE Encode Subsystem 150, the codeword vector input 300 undergoes a series of transformations to map it into the latent space. The encoder architecture typically consists of multiple layers of neural networks, such as fully connected layers or convolutional layers, depending on the nature of the input data.

A layer of the encoder takes the codeword vector and applies a linear transformation to project it into a higher-dimensional space. This transformation is learned during the training process and helps to capture the complex patterns and relationships within the input data. The output of this layer may be passed through a non-linear activation function, such as the rectified linear unit (ReLU), to introduce non-linearity and enhance the representational power of the encoder.

As the codeword vector input 300 progresses through the subsequent layers of the encoder, the dimensionality of the representation is gradually reduced. Each layer applies a linear transformation followed by a non-linear activation function, allowing the encoder to learn hierarchical features and abstract representations of the input data.

The VAE Encoder Subsystem 150 in the Latent Transformer LCM system can be trained independently or jointly with the other machine learning components, such as the Latent Transformer Subsystem 170 and the VAE Decode Subsystem 180. The flexibility in training allows for optimizing the VAE encoder based on specific requirements and available resources. When trained individually, the VAE encoder can focus on learning the optimal compression and representation of the input codeword vectors in the latent space. The Encoder Training System 151 is responsible for updating the encoder's parameters using techniques like gradient descent and backpropagation, minimizing the reconstruction loss and the KL divergence. Individual training enables the encoder to specialize in mapping the input data to a meaningful latent space representation.

On the other hand, joint training of the VAE encoder 150 with the Latent Transformer 170 and VAE decoder 180 allows for end-to-end optimization of the entire system. By training all components simultaneously, the VAE encoder 150 can learn to generate latent space vectors that are well-suited for processing by the Latent Transformer and decoding by the VAE decoder 180. Joint training enables the system to capture the dependencies and interactions between the different components, leading to improved overall performance. However, joint training may be more computationally intensive and require careful coordination between the training systems. The choice between individual or joint training depends on factors such as the complexity of the data, the desired performance, and the available computational resources. Experimentation and evaluation can help determine the most suitable training approach for a given scenario.

Once the VAE Encoder Subsystem 150 is trained, it can map the input codeword vector to a lower-dimensional latent space representation. This latent space vector captures the essential features and characteristics of the input data in a compressed form. The dimensionality of the latent space vector is typically much smaller than the original codeword vector, allowing for efficient storage and processing.

The latent space vector output 320 serves as the input to the Latent Transformer Subsystem 170, which further processes and generates data based on the learned latent space representation. By compressing the input data into a compact latent space, the VAE Encoder Subsystem 150 enables the Latent Transformer LCM system to handle large-scale and complex datasets efficiently, while preserving the essential information and structure of the data.

Latent space vectors possess the property of continuous differentiability. This means that the latent space formed by these vectors is a smooth and continuous manifold, allowing for smooth interpolation and gradual transitions between different points in the latent space. The continuous differentiability of latent space vectors has important implications for the similarity and relatedness of the outputs generated by the LCM system. In the latent space, outputs that are more proximate to one another, i.e., closer in terms of their latent vector representations, tend to exhibit higher levels of similarity. This is because the VAE Encoder Subsystem 150 learns to map similar input data points to nearby regions in the latent space, capturing their shared characteristics and underlying patterns.

As a result, when the Latent Transformer Subsystem 170 operates on the latent space vectors and generates outputs, the proximity of the latent vectors directly influences the similarity of the generated outputs. Outputs corresponding to latent vectors that are close to each other in the latent space are more likely to share common features, styles, or semantics. This property enables smooth interpolation between different outputs, allowing for the generation of intermediate or blended results that exhibit gradual variations along the latent space. The continuous differentiability of latent space vectors also facilitates the learning and optimization process of the LCM system. During training, the gradients can be computed and propagated smoothly through the latent space, enabling efficient updates of the model parameters. This allows the system to learn meaningful and coherent representations of the input data, capturing the underlying structure and relationships.

Moreover, the proximity-based similarity of latent space vectors opens up possibilities for various applications and use cases. For example, in the context of image generation, interpolating between latent vectors of different images can lead to the generation of smooth transitions or morphs between the corresponding visual contents. Similarly, in the domain of text generation, interpolating between latent vectors of different sentences or paragraphs can result in the generation of semantically coherent and gradually varying textual outputs. The continuous differentiability and proximity-based similarity of latent space vectors in the LCM system provide a powerful tool for exploring and manipulating the generated outputs. By navigating and interpolating within the latent space, users can discover novel and meaningful variations of the data, generate diverse and creative outputs, and gain insights into the underlying structure and relationships captured by the model.

In the Variational Autoencoder (VAE) Encoder and Decoder subsystems of the Latent Transformer Large Codeword Model (LCM) system, the shape of the tensors undergoes transformations as they are compressed and decompressed. The VAE Encoder Subsystem 150 is responsible for compressing the input data into a lower-dimensional latent space representation, while the VAE Decoder Subsystem 180 decompresses the latent representation back into the original data space. The specific shape and dimensionality of the tensors at each stage of the encoding and decoding process can be adjusted based on the goals and requirements of the system.

The VAE Encoder Subsystem 150 takes the preprocessed input data, which is typically in the form of a high-dimensional vector or tensor, and applies a series of transformations to reduce its dimensionality. The shape of the tensor at each layer of the VAE Encoder Subsystem 150 can be customized based on the desired level of compression and the complexity of the input data. For example, after passing through the first layer of the encoder, the expanded input vector may be reduced to a tensor with 1000 elements. This compression step aims to capture the most salient features and patterns in the input data while reducing its dimensionality. The subsequent layers of the encoder can further compress the tensor, reducing it to even lower dimensions, such as 50 or 10 elements, depending on the specific training parameters and the desired level of compression.

The choice of the target dimensionality for the latent space representation depends on various factors, such as the nature of the input data, the complexity of the patterns and relationships to be captured, and the available computational resources. A smaller latent space dimensionality can lead to higher compression rates and more efficient processing, but it may also result in a loss of information and reduced expressiveness. On the other hand, a larger latent space dimensionality allows for more detailed and nuanced representations but may require more computational resources and longer training times.

Once the input data is compressed into the latent space representation, it is passed through the Latent Transformer Subsystem 170, where the self-attention mechanisms and multi-head attention operate on the compressed representation. The Latent Transformer Subsystem 170 learns the underlying patterns, relationships, and dependencies within the latent space, enabling it to generate accurate and context-aware outputs. If the shape of the latent space representation is not large enough to be effectively processed by the Latent Transformer Subsystem 170, the latent space vectors may be processed by an expander 151, which increases the dimensionality of the vector allowing for a richer and more expressive representation.

The generated output from the Latent Transformer Subsystem 170 is then fed into the VAE Decoder Subsystem 180, which is responsible for decompressing the latent representation back into the original data space. The VAE Decoder Subsystem 180 applies a series of transformations to gradually increase the dimensionality of the tensor, eventually reconstructing it into the desired output shape. Similar to the encoding process, the shape of the tensor at each layer of the VAE Decoder Subsystem 180 can be customized based on the desired output characteristics and the requirements of the application.

The flexibility in tensor shapes throughout the encoding and decoding process allows the Latent Transformer LCM system to adapt to various data types, input sizes, and output requirements. By adjusting the compression and decompression parameters, the system can be optimized for different goals, such as achieving high compression rates, preserving important details, or generating outputs with specific dimensions or characteristics.

The ability to customize the tensor shapes in the VAE Encoder and Decoder subsystems enables the Latent Transformer LCM system to handle a wide range of data modalities and tasks, from time series forecasting and language modeling to image generation and beyond. It provides the flexibility to tailor the system to the specific needs of each application, balancing the trade-offs between compression, expressiveness, and computational efficiency.

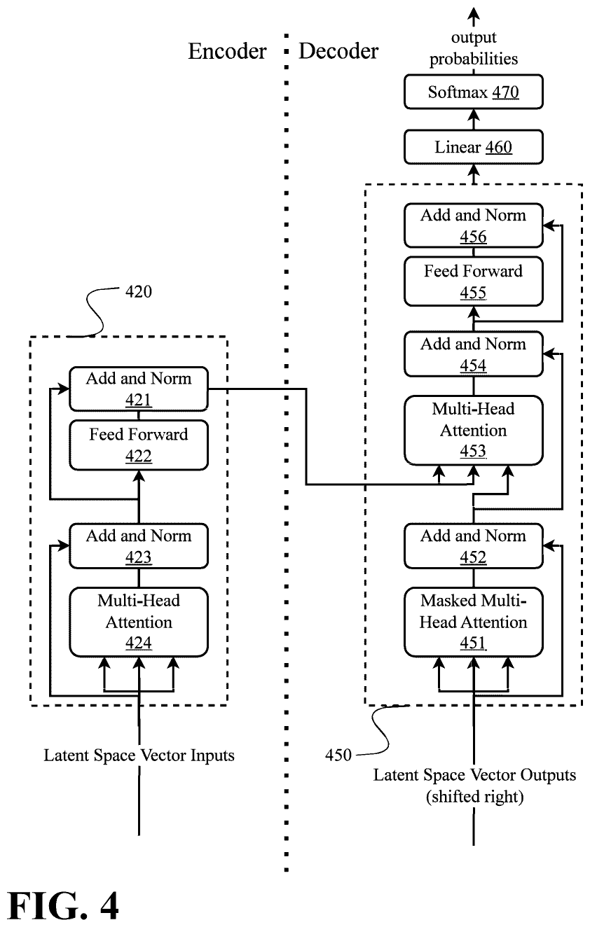

FIG. 4 is a block diagram illustrating a component of the system and method for a large codeword model for deep learning, a Latent Transformer. A Transformer generally comprises an Encoder (the components on the left side of the illustration) and a Decoder (the components on the right side of the illustration).

The illustrated Latent Transformer comprises an Encoder and a Decoder. The Encoder takes latent space vector inputs and processes them through a stack of layers (represented as dashed box 420). Each layer consists of: multi-head attention, which allows the model to attend to different parts of the input sequence; add and norm, which applies residual connection and layer normalization; feed forward, which is a fully connected feed-forward network; and add and norm which is another residual connection and layer normalization.

The power of the transformer model lies in the self-attention mechanism. This mechanism contributes to accelerated learning compared to traditional models such as long short-term memory models. Self-attention empowers the transformer model with the remarkable capability to meticulously scrutinize distinct segments of a given sequence or even encompass the entire contextual essence of a sentence. This profound contextual awareness enables the model to make predictions with an elevated degree of accuracy and relevance.

Contrary to a standard transformer architecture, in a Latent Transformer, an input embedding layer and a positional encoding layer are not necessary. This is because rather than processing data inputs, a Latent Transformer processes latent space vectors which have been processed by a Variational Autoencoder encoder.

This latent space representation captures the essential features and characteristics of the input data, including both the content and positional information. By encoding the input data into a compact latent vector, the VAE effectively combines the roles of the embedding layer and positional encoding layer. The latent vectors generated by the VAE encoder already contain the necessary information for the Transformer to process and learn from, without the need for explicit embedding or positional encoding. This streamlined approach simplifies the Transformer architecture and reduces the computational overhead associated with maintaining separate embedding and positional encoding layers. As a result, the Latent Transformer LCM system can efficiently process and generate data in the latent space, leveraging the power of the Transformer architecture while benefiting from the compressed representation learned by the VAE.

The Encoder utilizes a multi-head attention mechanism 424 which allows the Encoder to attend to different parts of the input sequence and capture dependencies between vectors. The attention mechanism computes three matrices: Query (Q), Key (K), and Value (V). The Query, Key, and Value matrices are obtained by linearly projecting the input embeddings using learned weight matrices. The attention scores are computed by taking the dot product of the Query matrix with the transpose of the Key matrix, followed by scaling and applying a softmax function. The attention scores determine the importance of each vector in the input sequence for a given position. The Value matrix is then multiplied with the attention scores to obtain the weighted sum of the values, which forms the output of the attention mechanism. Multi-Head Attention splits the Query, Key, and Value matrices into multiple heads, allowing the model to attend to different aspects of the input simultaneously. The outputs from each head are concatenated and linearly projected to obtain the final output of the Multi-Head Attention layer 424.

In the Latent Transformer LCM system, the number of attention heads used by the Encoder can be adjusted based on the complexity and nature of the relationships within the input data. The attention mechanism allows the Encoder to focus on different aspects of the input and capture dependencies between elements at various positions. When dealing with datasets where the relationships between elements are weaker or more subtle, increasing the number of attention heads can be beneficial. By having more attention heads, the Encoder can learn and capture a wider range of patterns and dependencies within the data. Each attention head can attend to different parts of the input sequence, allowing the model to capture fine-grained relationships and nuances that may be difficult to detect with fewer attention heads. This is particularly useful when working with complex or heterogeneous datasets, where the relationships between elements may not be immediately apparent. By increasing the number of attention heads, the Latent Transformer LCM system can more effectively learn and represent the underlying structure and dependencies in the data, leading to improved performance and generalization. However, it's important to strike a balance, as having an excessive number of attention heads can increase computational complexity and may lead to overfitting. Experimentation and evaluation on specific tasks can help determine the optimal number of attention heads for a given dataset and desired outcome.

After the Multi-Head Attention layer, a residual connection is applied, followed by Layer Normalization at add and norm 423. The residual connection adds the input embeddings to the output of the attention layer, helping the model learn faster and deeper. Layer Normalization normalizes the activations across the features, stabilizing the training process.

The Feed Forward layer 422 is a fully connected neural network applied to each position of the Encoder's hidden states. It consists of two linear transformations with a Rectified Linear Unit (ReLU) activation function in between. The purpose of the Feed Forward layer is to introduce non-linearity and increase the model's capacity to learn complex representations. The output of the Feed Forward layer has the same dimensionality as the input embeddings. A residual connection and Layer Normalization 421 are applied after the Feed Forward layer.

The Encoder layers 420 are stacked Nx times, where N is a hyperparameter that determines the depth of the Encoder. Each layer follows the same structure: Multi-Head Attention, Add & Norm, Feed Forward, and Add & Norm. By stacking multiple Encoder layers, the model can capture hierarchical and long-range dependencies in the input sequence. The output of the final Encoder layer represents the encoded input sequence, which is then passed to the Decoder for generating the output sequence.

The Decoder generates the output probabilities. It has a similar structure to the Encoder, with a few additions. The Decoder takes output embeddings and processes them through a stack of layers (represented as dashed box 450). The latent space vector output layer 430 takes the previous output vectors (shifted right by one position) and processes them through a plurality of layers.

The masked multi-head attention 451 mechanism prevents the model form attending to future vectors. This layer performs self-attention on the Decoder's input sequence. It allows the Decoder to attend to different parts of its own input sequence. The attention is “masked” to prevent the Decoder from attending to future vectors, ensuring that the predictions are based only on the previously generated vectors. Multi-head attention splits the input into multiple heads, allowing the model to attend different aspect of the input simultaneously.

After the masked multi-head attention, a residual connection is applied follows by layer normalization via add and norm 452. The residual connection adds the input to the output of the attention layer, helping the model learn faster and deeper. Layer normalization normalizes the activations across the features, stabilizing the training process.

The multi-head attention 453 layer performs attention between the Decoder's hidden states and the Encoder's output. It allows the Decoder to attend to relevant parts of the input sequence based on the Encoder's representations. The attention weights are computed based on the compatibility between the Decoder's hidden states and Encoder's outputs.

In the Latent Transformer LCM system, the number of attention heads used by the Decoder can be adjusted based on the complexity and nature of the relationships within the input data. The attention mechanism allows the Decoder to focus on different aspects of the input and capture dependencies between elements at various positions. When dealing with datasets where the relationships between elements are weaker or more subtle, increasing the number of attention heads can be beneficial. By having more attention heads, the Decoder can learn and capture a wider range of patterns and dependencies within the data. Each attention head can attend to different parts of the input sequence, allowing the model to capture fine-grained relationships and nuances that may be difficult to detect with fewer attention heads. This is particularly useful when working with complex or heterogeneous datasets, where the relationships between elements may not be immediately apparent. By increasing the number of attention heads, the Latent Transformer LCM system can more effectively learn and represent the underlying structure and dependencies in the data, leading to improved performance and generalization. However, it's important to strike a balance, as having an excessive number of attention heads can increase computational complexity and may lead to overfitting. Experimentation and evaluation on specific tasks can help determine the optimal number of attention heads for a given dataset and desired outcome.

Another add and norm 454 layer is then followed by feed forward network 455. This a fully connected feed-forward network applied to each position of the Decoder's hidden states. It consists of two linear transformations with a Rectified Linear Unit (ReLU) activation in between. The feed forward layer helps the model capture non-linear interactions and increases the model's capacity.

Another add and norm 456 layer is followed by linear 460 and softmax 470 layers. The final hidden states of the Decoder are passed through a linear transformation to project them into the vocabulary space. Vocabulary space refers to the set of all unique codewords or words that the model can generate or predict. In the context of language models, the vocabulary is a predefined set of codewords that the model is trained on and can output. When the Decoder's final hidden states are passed through a linear transformation, they are projected into a vector space with the same dimensionality as the size of the vocabulary. Each dimension in this space corresponds to a specific codeword in the vocabulary.

A softmax function is applied to the projected values (vectors) to generate output probabilities over the vocabulary. The softmax function normalizes the values so that they sum up to 1, representing a probability distribution over the vocabulary. Each probability indicates the likelihood of a specific vector being the next output vector. The vector with the highest probability is selected as the next output vector. During the model's training, the objective is to maximize the probability of the correct next vector given the input sequence and the previously generated vector. The model learns to assign higher probabilities to the vector that are more likely to appear based on the context. At inference time, the vector with the highest probability in the vocabulary space is selected as the next output vector. This process is repeated iteratively, with the generated vector being fed back into the Decoder as input for the next step, until a stopping criterion is met (e.g., reaching a maximum length or generating an end-of-sequence vector). The size and composition of the vocabulary can vary depending on the specific task and the data the model is trained on. It can include words, sub-words, or even characters, depending on the codeword strategy used.

The Decoder layers 450 can be stacked Nx times, allowing the model to capture complex dependencies and generate coherent output sequences.

This transformer architecture allows the model to process input sequences, capture long-range dependencies, and generate output sequence based on the encoded input and the previously generated codewords.

Another type of variation is the auto-regressive model which feature the use of only the decoder portion of the transformer architecture. In autoregressive architectures, the decoder portion of the transformer is retained and the encoder portion is not used after model pre-training. Auto-regressive models are a class of models that generate outputs by predicting the next element based on the previously generated elements. In the context of the Transformer architecture and language modeling, auto-regressive models are commonly used for tasks such as text generation, machine translation, and language understanding.

Auto-regressive models generate outputs sequentially, one element at a time. In the case of language modeling, the model predicts the next word or vector based on the previous words or vector in the sequence. The prediction of the next element is conditioned on the previously generated elements. The model learns the conditional probability distribution P(x_t|x_1, x_2, . . . , x_{t−1}), where x_t is the element at position t, and x_1, x_2, . . . , x_{t−1} are the previously generated elements. The Transformer architecture, particularly the Decoder component, is well-suited for auto-regressive modeling. The Decoder generates the output sequence one element at a time, conditioned on the previously generated elements and the encoded input sequence from the Encoder. In the Transformer Decoder, the self-attention mechanism is masked to prevent the model from attending to future positions during training. This masking ensures that the model relies only on the previously generated elements to make predictions, following the auto-regressive property. During training, the Transformer Decoder uses a technique called teacher forcing. Instead of feeding the model's own predictions as input for the next step, the ground truth target sequence is used. This helps the model learn to generate the correct output sequence based on the input sequence and the previous target vectors. During inference or generation, the Transformer Decoder generates the output sequence one element at a time. At each step, the model takes the previously generated elements as input and predicts the next element. This process continues until a stopping criterion is met, such as reaching a maximum sequence length or generating an end-of-sequence vector. Auto-regressive models, including the Transformer, have achieved state-of-the-art performance in language modeling tasks. They excel at capturing the statistical properties and dependencies in sequential data, making them effective for generating coherent and fluent text.

While text generation is the most suitable use case of auto-regressors, they perform exceptionally well on a wide variety of tasks. Most modern LLMs are auto-regressors including, for example, the popular GPT series of LLMs, BERT, and XLNet.

The third variation of the transformer model is the sequence-to-sequence model which utilizes both the encoder and decoder portions of the transformer and can be trained in multiple ways. One of the methods is span corruption and reconstruction. These models are, generally, best suited for language translation. The T5 and BART family of models are examples of sequence-to-sequence models.

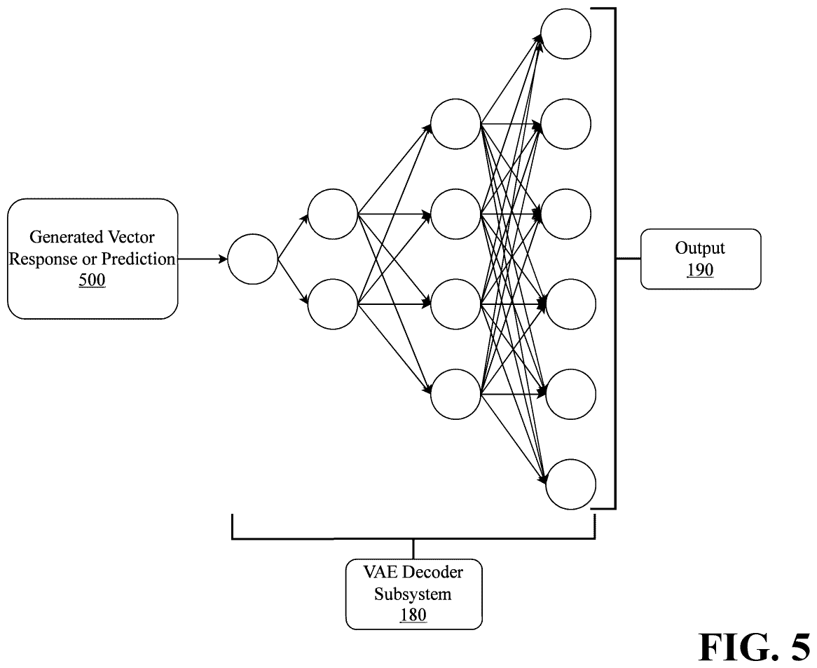

FIG. 5 is a block diagram illustrating a component of the system for a Latent Transformer core for a Large Codeword Model, a Variational Autoencoder Decoder Subsystem. The VAE Decoder Subsystem 180 is a component of the Latent Transformer LCM system, responsible for reconstructing or generating output data from the latent space vector representations. It works in conjunction with the Latent Transformer Subsystem 170 to provide meaningful and coherent outputs based on the learned relationships and patterns in the latent space. The input to the VAE Decoder Subsystem 180 is a Generated Vector Response or Prediction 500, which is produced by the Latent Transformer Subsystem 170. The Latent Transformer learns to model the dependencies and relationships between the latent space vectors generated by the VAE Encoder Subsystem 150. It processes the latent space vectors using self-attention mechanisms and captures the relevant information and context for generating the output.

The Generated Vector Response or Prediction 500 is a lower-dimensional representation that encodes the necessary information for reconstructing or generating the desired output. It contains the learned patterns, relationships, and variations that the Latent Transformer has captured from the input data. The VAE Decoder Subsystem 180 takes this generated vector as input and maps it back to the original data space, producing the final output 190. The decoder architecture typically comprises multiple layers of neural networks, such as fully connected layers or deconvolutional layers, depending on the nature of the output data.

The decoder starts by applying a linear transformation to the generated vector, projecting it into a higher-dimensional space. This transformation helps to expand the compressed representation and prepare it for the subsequent decoding steps. The output of this layer is then passed through a non-linear activation function, such as the rectified linear unit (ReLU), to introduce non-linearity and increase the expressiveness of the decoder. As the generated vector progresses through the subsequent layers of the decoder, the dimensionality of the representation is gradually increased. Each layer applies a linear transformation followed by a non-linear activation function, allowing the decoder to reconstruct the fine-grained details and structure of the output data. In the case of sequence-to-sequence tasks, such as time series prediction or language translation, the VAE Decoder Subsystem 180 may incorporate recurrent neural networks (RNNs) or attention mechanisms to generate the output sequence step by step. The decoder can attend to different parts of the generated vector and the previously generated outputs to produce coherent and contextually relevant results.

During the training process, the VAE Decoder Subsystem 180 learns to minimize the reconstruction loss between the generated output and the target output. It aims to produce outputs that closely match the desired or expected results based on the learned latent space representations. The Decoder Training System 181 is responsible for updating the decoder's parameters using techniques like gradient descent and backpropagation, optimizing the decoder's ability to generate accurate and meaningful outputs. Once the VAE Decoder Subsystem 180 is trained, it can map the Generated Vector Response or Prediction 500 back to the original data space, producing the final output 190. The output can be in various forms, such as reconstructed input data, predicted future sequences, or generated samples, depending on the specific task and application. The flexibility of the VAE Decoder Subsystem 180 allows it to handle various types of output data, such as time series, images, or text. By adapting the decoder architecture and training process to the specific requirements of the task, the Latent Transformer LCM system can generate high-quality outputs that capture the essential characteristics and variations of the target data.

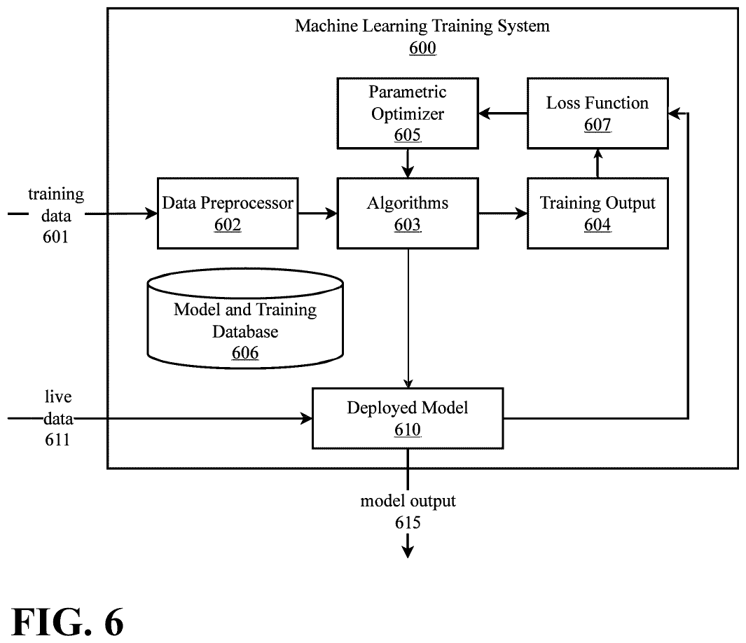

FIG. 6 is a block diagram illustrating an aspect of system and method for a Latent Transformer core for a Large Codeword Model, a machine learning training system. According to the embodiment, the machine learning training system 600 may comprise a model training stage comprising a data preprocessor 602, one or more machine and/or deep learning algorithms 603, training output 604, and a parametric optimizer 605, and a model deployment stage comprising a deployed and fully trained model 610 configured to perform tasks described herein such as processing codewords through a large codeword model. The machine learning training system 600 may be used to train and deploy a plurality of machine learning architectures in order to support the services provided by the large codeword model for deep learning. In one embodiment, machine learning training system 600 may be used to train the VAE Encoder Subsystem 150, the Latent Transformer Subsystem 170, and the VAE Decoder Subsystem 180. The machine learning training system 600 may train each of the proceeding systems separately or together as a single system.

At the model training stage, a plurality of training data 601 may be received by the generative AI training system 650. Data preprocessor 602 may receive the input data (e.g., codeword vector inputs, latent space vector representations) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 602 may also be configured to create training dataset, a validation dataset, and a test set from the plurality of input data 601. For example, a training dataset may comprise 80% of the preprocessed input data, the validation set 10%, and the test dataset may comprise the remaining 10% of the data. The preprocessed training dataset may be fed as input into one or more machine and/or deep learning algorithms 603 to train a predictive model for object monitoring and detection.

During model training, training output 604 is produced and used to measure the accuracy and usefulness of the predictive outputs. During this process a parametric optimizer 605 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning training system 600 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 607 to measure the system's performance. The loss function 607 compares the training outputs with an expected output and determined how the algorithm needs to be changed in order to improve the quality of the model output. During the training stage, all outputs may be passed through the loss function 607 on a continuous loop until the algorithms 603 are in a position where they can effectively be incorporated into a deployed model 615.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 610 in a production environment making predictions based on live input data 611 (e.g., codeword vector inputs, latent space vector representations). Further, model correlations and restorations made by deployed model can be used as feedback and applied to model training in the training stage, wherein the model is continuously learning over time using both training data and live data and predictions. A model and training database 606 is present and configured to store training/test datasets and developed models. Database 606 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 603 may comprise a deep learning algorithm such as neural networks (e.g., recurrent, convolutional, long short-term memory networks, etc.).

In some implementations, the machine learning training system 600 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 606.

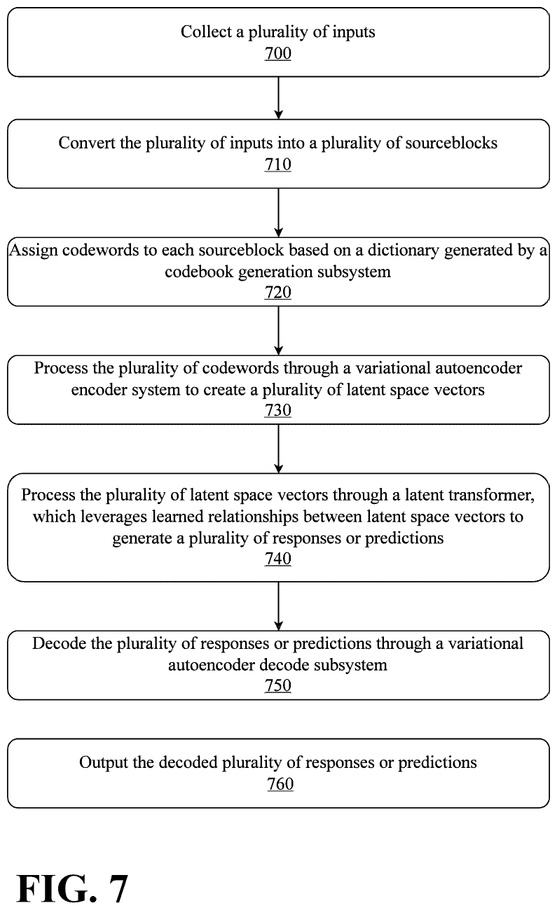

FIG. 7 is a flow diagram illustrating an exemplary method for a Latent Transformer core for a Large Codeword Model. In a first step 700, collect a plurality of inputs. These inputs can include structured or unstructured data, such as time series, text, images, or any other relevant data types. The data collection process involves gathering a substantial amount of information to ensure a representative and comprehensive dataset for training and inference purposes.

In a step 710, convert the plurality of inputs into a plurality of sourceblocks. Once the inputs are collected, they are converted into a plurality of sourceblocks. Sourceblocks are discrete units of information that capture the essential characteristics and patterns within the input data. The conversion process may involve techniques such as segmentation, tokenization, or feature extraction, depending on the nature of the input data. For example, in the case of text data, the inputs can be converted into sourceblocks by breaking them down into individual words, subwords, or phrases. For time series data, sourceblocks can be created by dividing the input into fixed-length windows or using techniques like sliding windows or overlapping segments.

In a step 720, assign codewords to each sourceblock based on a dictionary generated by a codebook generation subsystem. After converting the inputs into sourceblocks, each sourceblock is assigned a unique codeword based on a dictionary generated by a codebook generation subsystem. The codebook is a component of the Latent Transformer LCM system that maps the sourceblocks to their corresponding codewords. The codebook generation subsystem employs techniques such as clustering, vector quantization, or learned embedding spaces to create a compact and efficient representation of the sourceblocks. Each codeword serves as a discrete and compressed representation of the associated sourceblock, capturing its essential information and characteristics.

In a step 730, process the plurality of codewords through a variational autoencoder encoder system to create a plurality of latent space vectors. Once the codewords are assigned, they are processed through a variational autoencoder (VAE) encoder system. The VAE encoder takes the codewords as input and maps them into a lower-dimensional latent space representation. The encoder consists of multiple layers of neural networks that learn to compress the codewords into compact and informative latent space vectors. The latent space vectors capture the underlying structure, patterns, and variations present in the input data, while reducing the dimensionality and noise. The VAE encoder learns to generate a probabilistic distribution over the latent space, allowing for the sampling of new latent vectors during the generation process.

In a step 740, process the plurality of latent space vectors through a latent transformer, which leverages learned relationships between latent space vectors to generate a plurality of responses or predictions. The latent space vectors generated by the VAE encoder are then processed through a latent transformer. The latent transformer is a specialized neural network architecture that learns the relationships and dependencies between the latent space vectors. It employs self-attention mechanisms to capture the contextual information and long-range dependencies within the latent space. The latent transformer leverages these learned relationships to generate a plurality of responses or predictions based on the input latent vectors. It can perform tasks such as sequence-to-sequence prediction, data generation, or anomaly detection, depending on the specific application and training objectives.

In a step 750, decode the plurality of responses or predictions through a variational autoencoder decode subsystem. The generated responses or predictions from the latent transformer are in the form of latent space vectors. To obtain the final output, these latent vectors are passed through a variational autoencoder (VAE) decode subsystem. The VAE decoder takes the latent vectors as input and maps them back to the original data space. It consists of multiple layers of neural networks that learn to reconstruct the sourceblocks or generate new data based on the latent representations. The decoder aims to produce outputs that closely resemble the desired or expected results, utilizing the information captured in the latent space.

In a step 760, output the decoded plurality of responses or predictions. The decoded responses or predictions are outputted as the final result of the Latent Transformer LCM system. These outputs can take various forms, such as reconstructed input data, predicted future sequences, or generated samples, depending on the specific task and application. The outputted responses or predictions leverage the learned relationships and patterns captured by the latent transformer and the VAE decoder, providing meaningful and coherent results.

Throughout the method, the Latent Transformer LCM system learns to compress the input data into a compact latent space representation, capture the underlying relationships and dependencies, and generate accurate and contextually relevant responses or predictions. The combination of the VAE encoder, latent transformer, and VAE decoder enables the system to handle a wide range of data types and perform various tasks, such as data compression, anomaly detection, sequence prediction, and data generation. The training process involves optimizing the parameters of the VAE encoder, latent transformer, and VAE decoder using techniques such as gradient descent and backpropagation. The system learns to minimize the reconstruction loss between the input data and the decoded outputs, while also capturing the relevant patterns and relationships in the latent space.

### Detailed Description of Exemplary Aspects

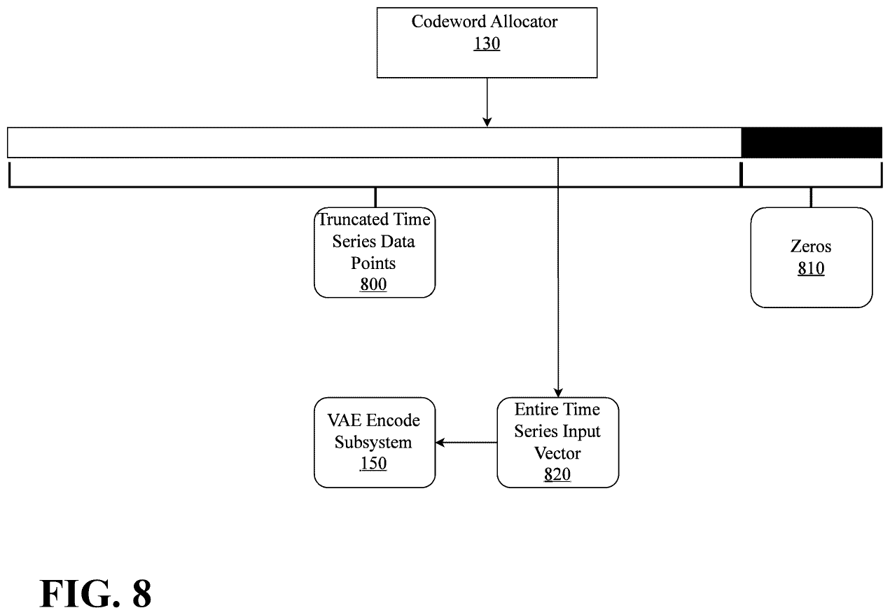

FIG. 8 is a block diagram illustrating an exemplary embodiment of a codeword allocator where the allocator appends zeros onto a vector of truncated data points. In one embodiment of the Latent Transformer LCM system, the Codeword Allocator 113 processes time series data and prepares it for input into the Variational Autoencoder (VAE) Encoder Subsystem 150. This specific embodiment focuses on handling time series data and leveraging the system's capabilities for time series prediction and forecasting. The codeword allocator 113 receives a plurality of time series data points 800 as input. These data points represent a sequence of observations or measurements recorded over time. The time series data can be from various domains, such as financial markets, sensor readings, weather patterns, or any other field where temporal data is collected.

To prepare the time series data for processing by the VAE Encode Subsystem 150, the codeword allocator 113 performs a specific data arrangement. It creates a time series input vector 820 by combining a portion of the original time series data points with a set of truncated data points and a sequence of zeros. Let's consider an example where the time series input vector 820 consists of 1000 elements. In this case, the codeword allocator 113 takes the original time series data and selects the most recent 950 data points. These 950 data points form the truncated time series data points 800 and represent the known or observed values up to a certain point in time.

The codeword allocator 113 then appends a sequence of 50 zeros 810 to the truncated time series data points 800. These zeros serve as placeholders for the future or unknown values that the system aims to predict. By combining the truncated data points and the zeros, the codeword allocator 113 creates the entire time series input vector 820 with a total of 1000 elements. The time series input vector 820 is then fed into the VAE Encode Subsystem 150. The VAE Encode Subsystem 150 takes the input vector and maps it into a lower-dimensional latent space representation. It learns to compress the time series data into a compact and informative latent space vector while capturing the underlying patterns, trends, and dependencies present in the data.

The latent space vector generated by the VAE Encode Subsystem 150 is subsequently processed by the Latent Transformer Subsystem 170. The Latent Transformer leverages its self-attention mechanisms and learned relationships between latent space vectors to make predictions or generate responses based on the input data. In the context of time series prediction, the Latent Transformer focuses on predicting the values corresponding to the 50 zeros appended to the time series input vector. By analyzing the patterns and dependencies in the truncated time series data points, the Latent Transformer generates a prediction or forecast for the future values.

The predicted values are then passed through the VAE Decode Subsystem 180, which maps the latent space predictions back to the original data space. The VAE Decode Subsystem reconstructs the complete time series, including the predicted values for the 50 zeros. The reconstructed time series, along with the predicted future values, is outputted as the final result. This output provides valuable insights and forecasts for the time series data, enabling users to make informed decisions and take appropriate actions based on the predicted future trends.

The specific number of truncated data points and zeros in the time series input vector can be adjusted based on the specific requirements and characteristics of the time series data. The choice of these values depends on factors such as the desired forecast horizon, the temporal resolution of the data, and the available historical data.

By leveraging the Codeword Allocator 113 to create the time series input vector and combining it with the power of the VAE Encode Subsystem 150 and the Latent Transformer Subsystem 170, the Latent Transformer LCM system enables effective time series prediction and forecasting. It learns to capture the complex patterns, trends, and dependencies in the time series data and generates accurate predictions for future values, providing valuable insights and supporting decision-making processes.

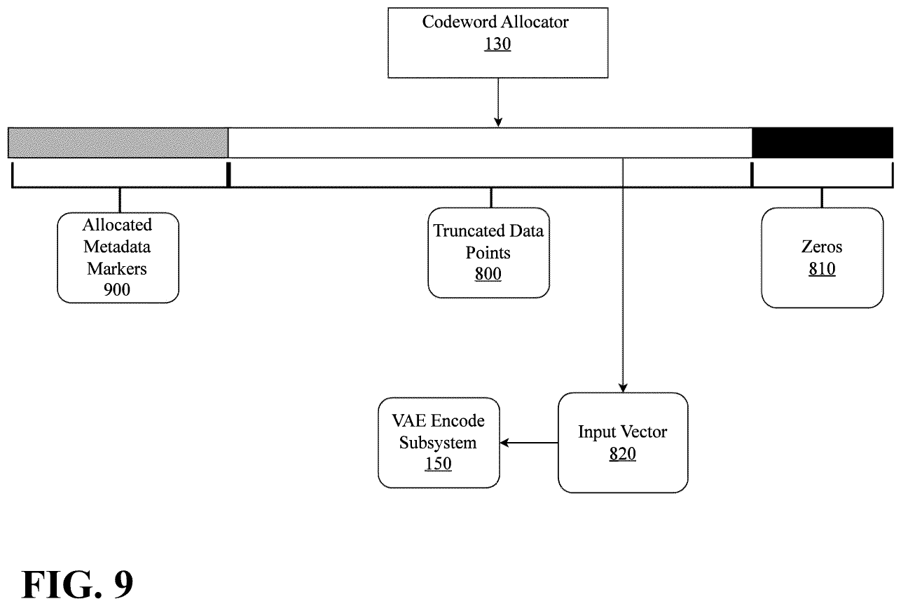

FIG. 9 is a block diagram illustrating an exemplary embodiment of a codeword allocator where the allocator appends metadata to the incoming data stream. In another embodiment of the Latent Transformer LCM system, the codeword allocator 113 takes on an expanded role in processing and preparing data for input into the Variational Autoencoder (VAE) Encode Subsystem 150. Beyond arranging data points, the codeword allocator 113 incorporates metadata information to provide additional context and enable more robust learning by the Latent Transformer.

The codeword allocator 130 receives a plurality of data points 800 as input, which can represent various types of information such as time series data, text, images, or any other structured or unstructured data. It processes the input data and creates an input vector 820 that combines a portion of the original data points with truncated data points and a sequence of zeros.

In the embodiment, the codeword allocator 113 has the ability to append metadata markers 900 to the input vector 820. These metadata markers provide valuable information about the data being processed, allowing the Latent Transformer to learn more comprehensive and context-aware relationships between the latent space vectors.

The metadata markers 900 can include a wide range of information, such as data type, temporal information, data source, data characteristics, and domain-specific metadata. For instance, the metadata markers can specify whether the input data is time series, text, images, or any other relevant data type. In the case of time series data, the metadata markers can include timestamps or temporal indicators associated with each data point, enabling the Latent Transformer to capture sequential dependencies and temporal patterns more effectively.

Additionally, the metadata markers can indicate the source or origin of the data, such as the specific sensor, device, or database from which the data was collected, allowing the Latent Transformer to learn source-specific patterns and characteristics. Furthermore, the metadata markers can provide information about the statistical properties or characteristics of the data, such as the mean, variance, or distribution type, assisting the Latent Transformer in understanding the underlying data distribution and making more informed predictions.

The codeword allocator 113 appends these metadata markers 900 to the input vector 820 alongside the truncated data points 800 and zeros 810, resulting in a rich combination of data points, truncated values, zeros, and metadata information. This input vector 820 is then fed into the VAE Encode Subsystem 150, which maps it into a lower-dimensional latent space representation, capturing the underlying patterns, dependencies, and metadata information in the latent space vector.

The Latent Transformer Subsystem 170 then processes the latent space vector, leveraging its self-attention mechanisms and learned relationships to make predictions or generate responses based on the input data. By incorporating metadata markers 900 into the input vector 820, the Latent Transformer can learn more robust and context-aware relationships between the latent space vectors. The metadata information provides additional guidance and context to the Latent Transformer, enabling it to capture complex patterns, dependencies, and domain-specific characteristics more effectively. For example, in a financial forecasting task, the metadata markers may include information about the company, industry, or economic indicators, allowing the Latent Transformer to incorporate this contextual information into its predictions. Similarly, in a text generation task, the metadata markers may include information about the genre, topic, or sentiment of the text, enabling the Latent Transformer to generate more coherent and contextually relevant responses.

The inclusion of metadata markers 900 enhances the expressiveness and adaptability of the Latent Transformer LCM system, allowing it to process and learn from a wide range of data types and incorporate relevant metadata information to improve the accuracy and contextual understanding of the generated predictions or responses. The specific types and formats of the metadata markers 900 can be tailored to the requirements and characteristics of the data being processed, with the codeword allocator 113 designed to extract and append the most relevant and informative metadata based on domain knowledge and the specific task at hand.

By leveraging the power of metadata markers 900 in conjunction with data points, truncated values, and zeros, the Latent Transformer LCM system can learn more comprehensive and robust relationships between the latent space vectors, enabling it to generate more accurate and context-aware predictions or responses across a wide range of applications, including time series forecasting, text generation, image synthesis, and more.

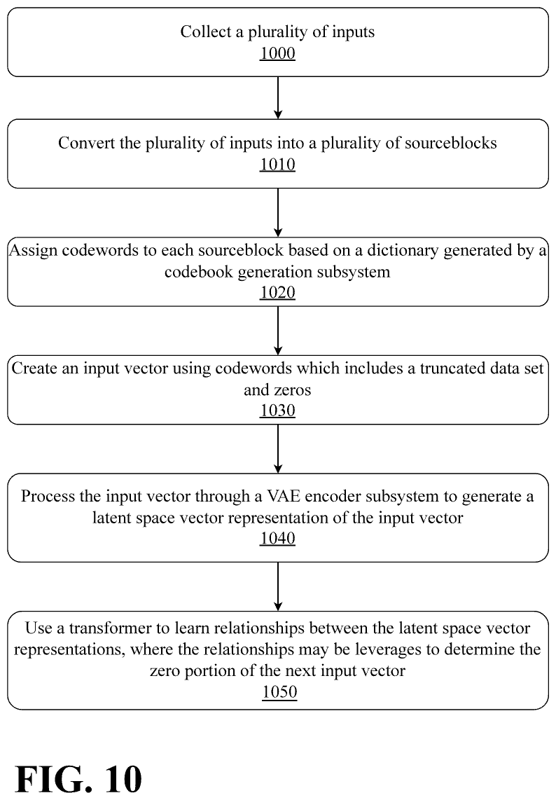

FIG. 10 is a flow diagram illustrating an exemplary method for the truncation of vectors for time series prediction. In a first step 1000, collect a plurality of inputs. These inputs can represent various types of data, such as time series data, text, images, or any other structured or unstructured data. The data collection process ensures that a sufficient amount of relevant and representative data is gathered for the subsequent steps.

In a step 1010, the collected inputs are converted into a plurality of sourceblocks. Sourceblocks are discrete units of information that capture the essential characteristics and patterns within the input data. The conversion process may involve techniques such as segmentation, tokenization, or feature extraction, depending on the nature of the input data. For example, in the case of text data, the inputs can be converted into sourceblocks by breaking them down into individual words, subwords, or phrases. For time series data, sourceblocks can be created by dividing the input into fixed-length windows or using techniques like sliding windows or overlapping segments.

In a step 1020, assign codewords to each sourceblock based on a dictionary generated by a codebook generation subsystem. The codebook is a component of the Latent Transformer LCM system that maps the sourceblocks to their corresponding codewords. The codebook generation subsystem employs techniques such as clustering, vector quantization, or learned embedding spaces to create a compact and efficient representation of the sourceblocks. Each codeword serves as a discrete and compressed representation of the associated sourceblock, capturing its essential information and characteristics.

In a step 1030, an input vector is created using the assigned codewords. This step is particularly relevant for tasks involving prediction or forecasting, such as time series prediction. The input vector includes a truncated data set, which represents the known or observed values up to a certain point in time. The truncated data set may be followed by a sequence of zeros, which serve as placeholders for the future or unknown values that the system aims to predict. The combination of the truncated data set and the zeros forms the complete input vector.

In a step 1040, process the input vector through a VAE encoder subsystem to generate a latent space vector representation of the input vector. The VAE encoder subsystem is a component of the Latent Transformer LCM system, responsible for mapping the input vector into a lower-dimensional latent space. The VAE encoder learns to compress the input data while capturing the underlying patterns, dependencies, and essential features in the latent space vector. By encoding the input vector into a compact latent representation, the VAE encoder enables efficient processing and learning by the subsequent components of the system.

In a step 1050, a transformer is used to learn relationships between the latent space vector representations. The transformer architecture, with its self-attention mechanism, is well-suited for capturing long-range dependencies and complex interactions within the data. By learning the relationships between the latent space vectors, the transformer can uncover patterns, correlations, and dependencies that may not be apparent in the original input space. These learned relationships can be leveraged to determine the values of the zero portion in the next input vector, enabling the system to make predictions or generate future values based on the truncated data set.

The transformer learns to attend to relevant information from the latent space vectors and propagate that information through its layers to generate meaningful predictions. By iteratively processing the input vectors and learning from the relationships between the latent space representations, the transformer can capture the underlying dynamics and patterns in the data, enabling accurate predictions of the unknown values.

The combination of codeword assignment, VAE encoding, and transformer learning enables the Latent Transformer LCM system to effectively process and predict data across various domains. The method leverages the power of compressed representations, latent space learning, and self-attention to uncover complex patterns and generate accurate predictions.

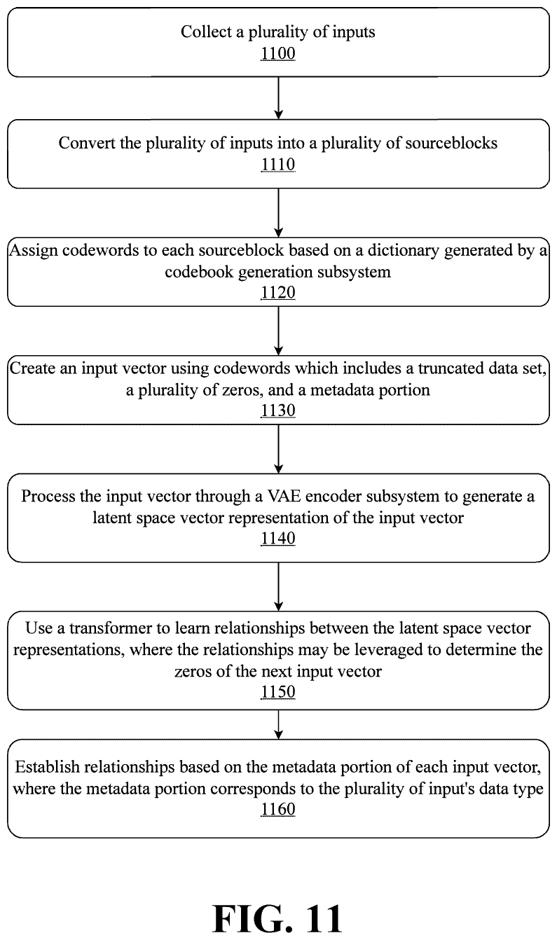

FIG. 11 is a flow diagram illustrating an exemplary method appending metadata to the incoming data stream using a codeword allocator. In a step 1100, collect a plurality of inputs. These inputs can represent various types of data, such as time series data, text, images, or any other structured or unstructured data. The data collection process ensures that a diverse and representative set of inputs is gathered for the subsequent steps.

In a step 1110, the collected inputs are converted into a plurality of sourceblocks. Sourceblocks are discrete units of information that capture the essential characteristics and patterns within the input data. The conversion process may involve techniques such as segmentation, tokenization, or feature extraction, depending on the nature of the input data. For example, in the case of text data, the inputs can be converted into sourceblocks by breaking them down into individual words, subwords, or phrases. For time series data, sourceblocks can be created by dividing the input into fixed-length windows or using techniques like sliding windows or overlapping segments.

In a step 1120, assign codewords to each sourceblock based on a dictionary generated by a codebook generation subsystem. The codebook is a component of the Latent Transformer LCM system, as it maps the sourceblocks to their corresponding codewords. The codebook generation subsystem employs techniques such as clustering, vector quantization, or learned embedding spaces to create a compact and efficient representation of the sourceblocks. Each codeword serves as a discrete and compressed representation of the associated sourceblock, capturing its essential information and characteristics.

In a step 1130, an input vector is created using the assigned codewords, along with additional components. The input vector includes a truncated data set, which represents the known or observed values up to a certain point in time. The truncated data set is followed by a sequence of zeros, which serve as placeholders for the future or unknown values that the system aims to predict. In addition to the truncated data set and zeros, the input vector also includes a metadata portion. The metadata portion contains relevant information about the input data, such as the data type, timestamp, source, or any other contextual details that can aid in the learning and prediction process.

In a step 1140, process the input vector through a VAE encoder subsystem to generate a latent space vector representation of the input vector. The VAE encoder subsystem is a critical component of the Latent Transformer LCM system, responsible for mapping the input vector into a lower-dimensional latent space. The VAE encoder learns to compress the input data while capturing the underlying patterns, dependencies, and essential features in the latent space vector. By encoding the input vector into a compact latent representation, the VAE encoder enables efficient processing and learning by the subsequent components of the system.

In a step 1150, a transformer is used to learn relationships between the latent space vector representations. The transformer architecture, with its self-attention mechanism, is well-suited for capturing long-range dependencies and complex interactions within the data. By learning the relationships between the latent space vectors, the transformer can uncover patterns, correlations, and dependencies that may not be apparent in the original input space. These learned relationships can be leveraged to determine the values of the zero portion in the next input vector, enabling the system to make predictions or generate future values based on the truncated data set.

In a step 1160, relationships established by the transformer are based on the metadata portion of each input vector. The metadata portion corresponds to the data type of the plurality of inputs, providing contextual information about the nature and characteristics of the data. By considering the metadata during the learning process, the transformer can establish more meaningful and targeted relationships between the latent space vectors. For example, if the metadata indicates that the input data is time series, the transformer can focus on capturing temporal dependencies and patterns specific to time series data. Similarly, if the metadata represents different categories or classes of data, the transformer can learn class-specific relationships and distinguish between different data types.

The incorporation of metadata in the learning process enhances the ability of the Latent Transformer LCM system to capture and leverage domain-specific knowledge and characteristics. By establishing relationships based on the metadata, the transformer can generate more accurate and context-aware predictions or outputs. The metadata acts as an additional guide, helping the transformer to focus on the most relevant aspects of the data and improve the quality of the learned representations.

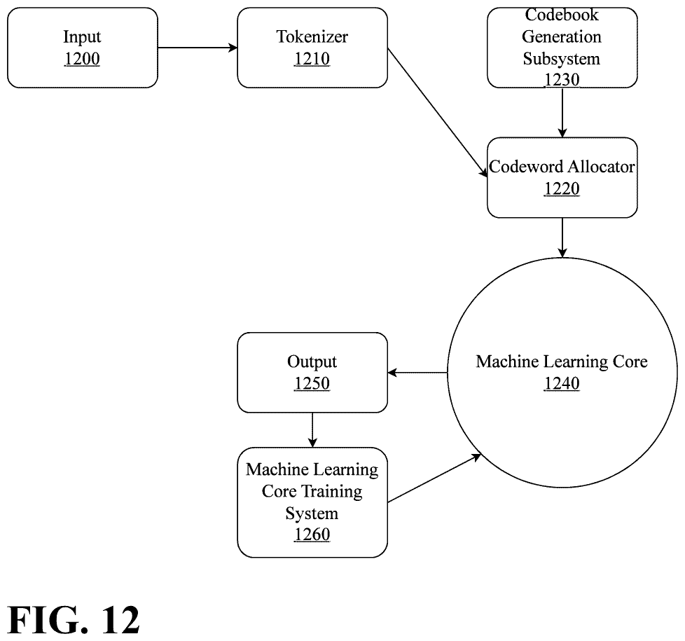

FIG. 12 is a block diagram illustrating an exemplary system architecture for a large codeword model for deep learning. An input 1200 represents the raw data that needs to be processed by the LCM. This data can be in various modalities, such as text, images, audio, time series, or any other structured or unstructured format. The input data is fed into the tokenizer 110 for further processing.

A tokenizer 1210 is responsible for splitting the input data into meaningful semantic units called sourceblocks. This process, known as semantic splitting, aims to capture the inherent structure and patterns in the data. The tokenizer can employ various techniques to identify the optimal sourceblocks, such as rule-based splitting, statistical methods, or machine learning approaches. For textual data, the tokenizer may use subword tokenization methods like Byte-Pair Encoding (BPE) or WordPiece, which break down words into smaller, more frequently occurring units. For images, the tokenizer may use approaches such as but not limited to a patch-approach, where the image is divided into fixed-size patches or regions. The specific tokenization method can be chosen based on the data modality and the characteristics of the domain. For example, the first paragraph of Leo Tolstoy's War and Peace which reads, “Well, Prince, so Genoa and Lucca are now just family estates of the Buonapartes,” may be tokenized into [′Well′, ‘,’, ‘Prince’, ‘,’ ‘so’, ‘Gen’, ‘oa’, ‘and’, ‘Luc’, ‘ca’, ‘are’, ‘now’, ‘just’, ‘family’, ‘estates’, ‘of’, ‘the’, ‘Buon’, ‘apar’, ‘tes’, ‘.’].

In one embodiment, the tokenizer may utilize Huffman coding to split the data into sourceblocks. The Huffman coding-based tokenizer enables efficient and semantically meaningful splitting of the input data into sourceblocks. Huffman coding is a well-known data compression algorithm that assigns variable-length codes to symbols based on their frequency of occurrence. In the context of the LCM, the Huffman coding-based tokenizer adapts this principle to perform semantic splitting of the input data.

With Huffman coding, the tokenizer starts by analyzing the input data and identifying the basic units of meaning, such as words, phrases, or subwords, depending on the specific data modality and the desired level of granularity. These basic units form the initial set of sourceblocks. The tokenizer then performs a frequency analysis of the sourceblocks, counting the occurrences of each sourceblock in the input data. Based on the frequency analysis, the tokenizer constructs a Huffman tree, which is a binary tree that represents the probability distribution of the sourceblocks. The Huffman tree is built by iteratively combining the two least frequent sourceblocks into a single node, assigning binary codes to the branches, and repeating the process until all sourceblocks are included in the tree. The resulting Huffman tree has the property that sourceblocks with higher frequencies are assigned shorter codes, while sourceblocks with lower frequencies are assigned longer codes.

The Huffman coding-based tokenizer then uses the constructed Huffman tree to perform semantic splitting of the input data. It traverses the input data and matches the sequences of symbols against the sourceblocks represented in the Huffman tree. When a sourceblock is identified, the tokenizer assigns the corresponding Huffman code to that sourceblock, effectively compressing the data while preserving its semantic structure. The use of Huffman coding for semantic splitting offers several advantages. It allows for variable-length sourceblocks, enabling the tokenizer to capture meaningful units of varying sizes. This is particularly useful for handling data with different levels of complexity and granularity, such as text with compound words or images with hierarchical structures.

A Huffman coding-based approach optimizes the representation of the sourceblocks based on their frequency of occurrence. By assigning shorter codes to more frequent sourceblocks and longer codes to less frequent ones, the tokenizer achieves data compression while still preserving the semantic information. This compression reduces the overall size of the data and improves the efficiency of subsequent processing stages. Additionally, the Huffman tree construction process inherently captures the statistical properties and patterns within the input data. The resulting sourceblocks and their assigned codes reflect the underlying structure and relationships present in the data. This semantic awareness enhances the ability of the LCM to learn and generate meaningful representations.

After the semantic splitting process, the resulting sourceblocks and their assigned Huffman codes are passed to the codeword allocator. The codeword allocator maps each sourceblock to a unique codeword, which is a compact representation used by the subsequent components of the LCM architecture. The codeword mapping can be based on various schemes, such as a fixed-length binary encoding or a learned embedding space.

Once the input data is tokenized into sourceblocks, the codeword allocator 120 assigns a unique codeword to each sourceblock. The codewords are discrete, compressed representations of the sourceblocks, designed to capture the essential information in a compact form. The codeword allocator can use various mapping schemes to assign codewords to sourceblocks, such as hash functions, lookup tables, or learned mappings. For example, a simple approach could be to use a hash function that maps each sourceblock to a fixed-length binary code. Alternatively, another approach may involve learning a mapping function that assigns codewords based on the semantic similarity of the sourceblocks.

The codebook generation subsystem 130 is responsible for creating and maintaining the codebook, which is a collection of all the unique codewords used by the LCM. The codebook can be generated offline, before the actual processing begins, or it can be updated dynamically as new sourceblocks are encountered during processing. The codebook generation subsystem can use various techniques to create a compact and efficient codebook, such as frequency-based pruning, clustering, or vector quantization. The size of the codebook can be adjusted based on the desired trade-off between compression and information preservation. Going back to the War and Peace example, the string of tokens [′Well′, ‘,’, ‘Prince’, ‘,’, ‘so’, ‘Gen’, ‘oa’, ‘and’, ‘Luc’, ‘ca’, ‘are’, ‘now’, ‘just’, ‘family’, ‘estates’, ‘of’, ‘the’, ‘Buon’, ‘apar’, ‘tes’, ‘.’] may be given codewords such as [12, 5, 78, 5, 21, 143, 92, 8, 201, 45, 17, 33, 49, 62, 87, 11, 2, 179, 301, 56, 4], where each token is assigned a unique codeword, which is represented as an integer. The mapping between tokens and codewords is determined by the codebook generated by the LCM system.

The machine learning core 1240 is the central component of the LCM architecture, where the actual learning and processing take place. The core operates on the codewords generated by the codeword allocator, learning to process, generate, and manipulate the compressed representations. The machine learning core can be implemented using various configurations, depending on the specific task and data modality. Some possible variations include:

In one embodiment, the machine learning core 1240 may be a Transformer-based core. The Transformer-based core consists of several key components. An embedding layer maps the codewords to dense vector representations, capturing their semantic and syntactic properties. Positional encoding is used to incorporate positional information into the codeword embeddings, enabling the Transformer to distinguish the relative positions of the codewords in the input sequence. The multi-head attention mechanism, which is the core building block of the Transformer, allows the model to attend to different parts of the input sequence simultaneously, capturing complex dependencies and relationships between codewords. Feed-forward networks are used to introduce non-linearity and increase the expressive power of the model. Residual connections and layer normalization are employed to facilitate the flow of information and stabilize the training process.

The Transformer-based core can be implemented using an encoder-decoder architecture. The encoder processes the input codewords and generates contextualized representations, while the decoder takes the encoder's output and generates the target codewords or the desired output sequence. The encoder and decoder are composed of multiple layers of multi-head attention and feed-forward networks, allowing for deep and expressive processing of the codeword representations.

One of the key advantages of the Transformer-based core in the LCM architecture is its ability to capture long-range dependencies between codewords. Unlike recurrent neural networks (RNNs), which process the input sequentially, the Transformer can attend to all codewords in parallel, enabling it to effectively capture relationships and dependencies that span across the entire input sequence. This is useful for processing long and complex data sequences, where capturing long-range dependencies is crucial for understanding the overall context. Another advantage of the Transformer-based core is its parallelization capability. The self-attention mechanism in the Transformer allows for efficient parallel processing of the codewords on hardware accelerators like GPUs. This parallelization enables faster training and inference times, making the LCM architecture suitable for processing large amounts of data in real-time applications.

The Transformer-based core also generates contextualized representations of the codewords, where each codeword's representation is influenced by the surrounding codewords in the input sequence. This contextualization allows the model to capture the semantic and syntactic roles of the codewords based on their context, enabling a deeper understanding of the relationships and meanings within the data. The scalability of the Transformer-based core is another significant advantage in the LCM architecture. By increasing the number of layers, attention heads, and hidden dimensions, the Transformer can learn more complex patterns and representations from large-scale datasets. This scalability has been demonstrated by models like GPT-3, which has billions of parameters and can perform a wide range of tasks with impressive performance.

In another embodiment, the machine learning core 1240 may utilize a Variational Autoencoder (VAE)-based core. A VAE-based core consists of two main components: an encoder and a decoder. The encoder takes the codewords as input and maps them to a lower-dimensional latent space representation. The encoder is typically implemented as a neural network, such as a multi-layer perceptron (MLP) or a convolutional neural network (CNN), depending on the nature of the codewords and the data modality. The encoder learns to compress the codewords into a compact latent representation while capturing the essential features and relationships within the data.

The decoder, on the other hand, takes the latent space representation and reconstructs the original codewords. The decoder is also implemented as a neural network, typically the inverse architecture of the encoder. The decoder learns to map the latent space representation back to the codeword space, generating codewords that closely resemble the original input. One of the key advantages of the VAE-based core in the LCM architecture is its ability to learn a continuous and structured latent space representation of the codewords. The latent space captures the underlying patterns and relationships within the data, allowing for smooth interpolation and generation of new codewords. By sampling from the latent space, the VAE-based core can generate novel and meaningful codewords that are similar to the original data distribution.

The VAE-based core also enables efficient compression of the codewords. By encoding the codewords into a lower-dimensional latent space, the VAE reduces the storage and computational requirements of the LCM. The compact latent representation can be used for various downstream tasks, such as data compression, similarity search, or data generation. The VAE-based core in the LCM architecture offers several advantages over traditional data processing techniques. It enables the learning of a compact and expressive latent representation of the codewords, capturing the essential features and relationships within the data. The continuous latent space allows for smooth interpolation and generation of new codewords, enabling tasks such as data augmentation, anomaly detection, and creative content generation.

The LCM architecture with the VAE-based core has a wide range of applications across various domains. In natural language processing, it can be used for tasks such as language modeling, text generation, and text compression. In computer vision, the VAE-based core can be applied to image compression, image generation, and unsupervised representation learning. The architecture can also be used for audio and speech processing, where the codewords represent audio features, enabling tasks such as audio compression, speech synthesis, and music generation.

In another embodiment, the machine learning core 1240 may be a Recurrent Neural Network (RNN)-based core. The RNN-based core consists of one or more recurrent layers, such as Long Short-Term Memory (LSTM) or Gated Recurrent Unit (GRU) layers. These recurrent layers maintain an internal state that allows them to remember and process information from previous time steps, enabling the capture of long-term dependencies and context within the codeword sequences.

The RNN-based core takes a sequence of codewords as input and processes them one at a time. At each time step, the RNN-based core updates its internal state based on the current input codeword and the previous state. This allows the core to learn and encode the temporal dependencies and patterns within the codeword sequences.

The RNN-based core can be used for various tasks, such as codeword sequence prediction, codeword generation, and sequence-to-sequence mapping. In codeword sequence prediction, the RNN-based core learns to predict the next codeword in a sequence given the previous codewords. This enables tasks such as language modeling, time series forecasting, and predictive maintenance.

In codeword generation, the RNN-based core can be trained to generate new codeword sequences based on a learned probability distribution. By sampling from this distribution, the core can generate novel and coherent codeword sequences that resemble the training data. This has applications in tasks such as text generation, music composition, and synthetic data generation. Sequence-to-sequence mapping involves using two RNN-based cores, an encoder and a decoder, to map an input codeword sequence to an output codeword sequence. The encoder RNN processes the input sequence and generates a fixed-length context vector that captures the essential information. The decoder RNN takes the context vector and generates the output codeword sequence step by step. This architecture has been successfully applied to tasks such as machine translation, speech recognition, and image captioning.

The RNN-based core in the LCM architecture offers several advantages over traditional data processing techniques. It enables the capture and modeling of temporal dependencies and sequential patterns within the codeword sequences, which is crucial for processing and generating sequential data. The RNN-based core can learn and adapt to the specific characteristics and patterns of the data, allowing for more accurate and contextually relevant processing and generation. Furthermore, the RNN-based core can handle variable-length sequences, making it suitable for processing data with different lengths and temporal resolutions. The recurrent nature of the RNN allows it to maintain and propagate information over long sequences, enabling the capture of long-term dependencies and context.

In another embodiment, the core can be implemented as a hybrid of multiple architectures, combining the strengths of different approaches. For example, a Transformer-VAE hybrid can be used, where the Transformer encoder generates contextualized representations of the codewords, and the VAE decoder generates new codewords based on the learned latent space. The specific choice of the machine learning core can be tailored to the requirements of the task and the characteristics of the data. The modular nature of the LCM architecture allows for easy experimentation and adaptation of different core configurations.

After processing the codewords, the machine learning core generates the output 150 in the desired format. The output can be in the form of codewords, which can be mapped back to the corresponding sourceblocks or tokens using the inverse mapping scheme. Alternatively, the output can be directly generated in the target modality, such as text, images, or audio, depending on the specific application.

The LCM architecture offers several advantages over traditional deep learning approaches. By operating on compressed codewords instead of raw tokens, the LCM can reduce the computational and memory requirements, making it more efficient and scalable. The semantic splitting and codeword representation also allow the LCM to capture the inherent structure and patterns in the data, enabling more effective learning and generalization. Moreover, the modular nature of the LCM architecture allows for easy adaptation to different data modalities and tasks, making it a versatile and flexible framework for various applications.

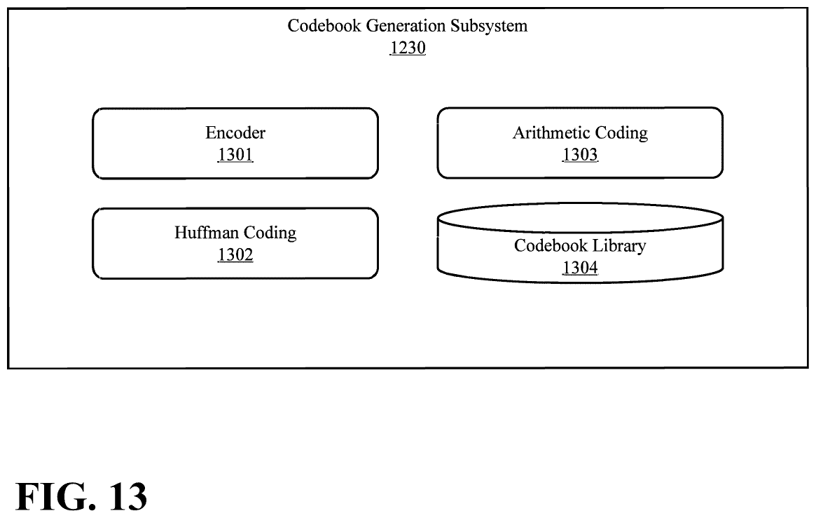

FIG. 13 is a block diagram illustrating an aspect of system and method for a large codeword model for deep learning, a codeword generation subsystem. According to the aspect, codebook generation subsystem 1230 is configured to generate one or more codebooks for a collection of input data using various techniques, such as Huffman coding or arithmetic coding.

The codebook is an important component of the codebook-based homomorphic compression system. According to the embodiment, it is a collection of codewords, where each codeword corresponds to a sourceblock in the tokenized input. The codebook may generated based on the frequency distribution of the tokenized inputs, assigning shorter codewords to more frequently occurring tokens and longer codewords to less frequent tokens. There are several techniques for generating the codebook, with the goal of minimizing the average codeword length while maintaining the uniqueness of the codewords. Two common techniques are Huffman coding 1302 and arithmetic coding 1303. Huffman coding 1302 is a variable-length coding technique that assigns codewords based on the frequency of occurrence of each symbol (sourceblock). It constructs a binary tree, known as the Huffman tree, where each leaf node represents a symbol and the path from the root to the leaf determines the codeword. More frequent symbols are assigned shorter codewords, while less frequent symbols receive longer codewords. Huffman coding guarantees an optimal prefix code, meaning no codeword is a prefix of any other codeword. For example, consider the quantized temperature data from the previous example. Let's say the frequency distribution of the intervals is as follows:
Sourceblock 0: 5%
Sourceblock 1: 10%
Sourceblock 2: 20%
Sourceblock 3: 15%
Sourceblock 4: 50%

Using Huffman coding, the codebook generation subsystem 1230 can generate the following codebook:
Sourceblock 0: 1100
Sourceblock 1: 101
Sourceblock 2: 00
Sourceblock 3: 01
Sourceblock 4: 11

The most frequent tokenized input (Sourceblock 4) receives the shortest codeword (11), while the least frequent tokenized input (Sourceblock 0) receives the longest codeword (1100).

Arithmetic coding 1303 is another entropy coding technique that assigns codewords to sourceblocks based on their probability distribution. Unlike Huffman coding, arithmetic coding does not assign fixed codewords to symbols. Instead, it represents the entire message as a single fractional number between 0 and 1. The interval [0, 1) is recursively divided based on the probabilities of the symbols, and the final codeword is a binary fraction that falls within the subinterval corresponding to the entire message. Arithmetic coding achieves near-optimal compression rates but requires more computational complexity compared to Huffman coding. For example, using the same quantized temperature data and frequency distribution as before, arithmetic coding would assign subintervals to each symbol based on their probabilities:
Sourceblock 0: [0.00, 0.05)
Sourceblock 1: [0.05, 0.15)
Sourceblock 2: [0.15, 0.35)
Sourceblock 3: [0.35, 0.50)
Sourceblock 4: [0.50, 1.00)

To encode a message sequence like [Sourceblock 4, Sourceblock 2, Sourceblock 1], arithmetic coding would recursively subdivide the interval [0, 1) based on the probabilities of the symbols, resulting in a final subinterval. The codeword would be a binary fraction that lies within this final subinterval.

According to an embodiment, an encoder component 1301 is present and configured to implement one or more deep learning techniques for generating codewords for quantized data. Deep learning techniques can be employed to generate effective codewords for the quantized data. One approach is to use deep learning-based autoencoder models to learn compact and meaningful representations of the quantized data. Autoencoders are neural network architectures that consist of an encoder and a decoder, where the encoder learns to compress the input data into a lower-dimensional latent space, and the decoder reconstructs the original data from the latent representation.

Here are a few exemplary deep learning encoding techniques that can be implemented for creating codewords of the quantized data, according to an embodiment. Convolutional autoencoders (CAEs) leverage convolutional neural networks (CNNs) in the encoder and decoder parts of the autoencoder. CNNs are particularly effective in capturing spatial dependencies and hierarchical features in data, making them well-suited for encoding structured data such as images or time series. In the context of the codebook-based homomorphic compression, a CAE can be trained on the quantized data. The encoder part of the CAE learns to compress the quantized data into a compact latent representation, which serves as the codeword.

The decoder part learns to reconstruct the quantized data from the codeword. As an example, consider an example of using a CAE for encoding quantized sensor data. The quantized data is represented as a 2D matrix, where each row corresponds to a sensor reading, and each column represents a time step. The CAE encoder consists of convolutional layers followed by pooling layers, which gradually reduce the spatial dimensions of the input and extract meaningful features. The output of the encoder is a compact latent representation, which serves as the codeword. The CAE decoder consists of upsampling layers and convolutional layers, which reconstruct the original quantized data from the codeword.

Another form of deep learning coding includes recurrent autoencoders (RAEs). Recurrent autoencoders utilize recurrent neural networks (RNNs) in the encoder and decoder parts of the autoencoder. RNNs are well-suited for processing sequential data, such as time series or natural language, as they can capture temporal dependencies and context. An RAE can be used to encode quantized sequential data. The encoder part of the RAE consists of recurrent layers, such as Long Short-Term Memory (LSTM) or Gated Recurrent Unit (GRU) layers, which process the input sequence and generate a fixed-length latent representation, serving as the codeword. The decoder part of the RAE takes the codeword and reconstructs the original quantized sequence. For example, consider an example of using an RAE for encoding quantized audio data. The quantized audio signal is represented as a sequence of amplitude values. The RAE encoder consists of LSTM layers that process the input sequence and generate a fixed-length latent representation, which serves as the codeword. The RAE decoder, also consisting of LSTM layers, takes the codeword and reconstructs the original quantized audio sequence.

Another form of deep learning coding includes variational autoencoders (VAEs). Variational autoencoders extend the concept of autoencoders by introducing a probabilistic framework. VAEs learn to encode the input data into a probability distribution in the latent space, rather than a single point. The encoder part of the VAE learns to map the input data to the parameters of a probability distribution (e.g., mean and variance of a Gaussian distribution), and the decoder part learns to reconstruct the original data from samples drawn from this distribution. A VAE can be used to generate codewords that capture the underlying probability distribution of the quantized data. The encoder part of the VAE learns to map the quantized data to the parameters of a probability distribution in the latent space. The codewords are then obtained by sampling from this distribution. The decoder part of the VAE learns to reconstruct the original quantized data from the sampled codewords. Consider an example of using a VAE for encoding quantized image data. The quantized images are fed into the VAE encoder, which learns to map each image to the parameters of a Gaussian distribution in the latent space. The codewords are obtained by sampling from this distribution. The VAE decoder takes the sampled codewords and reconstructs the original quantized images.

Another form of deep learning coding includes deep belief networks (DBNs). Deep Belief Networks are generative models that consist of multiple layers of restricted Boltzmann machines (RBMs). DBNs can learn hierarchical representations of the input data by training each layer in an unsupervised manner, followed by fine-tuning the entire network using supervised learning. DBNs can be used to generate codewords that capture the hierarchical structure of the quantized data. The DBN is trained on the quantized data, and the activations of the hidden layers serve as the codewords. The hierarchical nature of DBNs allows for capturing complex patterns and dependencies in the data. Consider an example of using a DBN for encoding quantized text data. The quantized text is represented as a binary vector, where each element corresponds to the presence or absence of a specific word. The DBN is trained on the quantized text data, and the activations of the hidden layers serve as the codewords. The DBN learns to capture the hierarchical structure and semantic relationships in the text data.

These are just a few examples of deep learning encoding techniques that can be explored for creating codewords of the quantized data in a LCM. The choice of the specific deep learning architecture depends on the nature of the data and the desired properties of the codewords. It's important to note that the deep learning encoding process should be designed to generate codewords that are suitable for homomorphic operations. The codewords should exhibit certain properties, such as being compatible with the homomorphic encryption scheme's plaintext space and allowing for efficient homomorphic computations.

During the training process of the deep learning models, the objective function should be designed to capture the desired properties of the codewords, such as minimizing the reconstruction error while ensuring the codewords are suitable for homomorphic operations. Additionally, regularization techniques can be employed to encourage sparsity or other desirable properties in the codewords. Once the deep learning models are trained, the encoder part can be used to generate codewords for new quantized data. The generated codewords can then be used in the codebook-based homomorphic compression scheme, enabling efficient and privacy-preserving computations on the compressed data.

Experimental evaluation and performance analysis can be conducted to assess the effectiveness of the deep learning encoding techniques in generating codewords that achieve good compression ratios, maintain low approximation errors, and enable efficient homomorphic operations. The choice of the deep learning architecture and hyperparameters can be fine-tuned based on the specific requirements and characteristics of the data.

According to the aspect, a codebook library 1304 is present and configured to store a plurality of codewords (i.e., a codebook) generated by one or more of the techniques described herein. When it comes to storing the codewords and codebook in the codebook-based homomorphic compression system, several database systems and data storage solutions can be considered. The choice of the storage system depends on factors such as the size of the codebook, the frequency of updates, the retrieval and query requirements, and the overall system architecture. In some implementations key-value stores may be used, Key-value stores are a type of NoSQL database that provide a simple and efficient way to store and retrieve data based on a unique key. Examples of key-value stores include Redis, Memcached, and Amazon DynamoDB. For storing the codewords and codebook, key-value stores can be used to store each codeword as a key-value pair, where the key represents the codeword, and the value represents the corresponding data or metadata associated with the codeword. The codebook can be stored as a collection of key-value pairs, allowing for fast retrieval of codewords based on their keys. Key-value stores offer high performance, low latency, and scalability, making them suitable for scenarios where fast retrieval of codewords is critical.

Document databases, such as MongoDB or Couchbase, store data as flexible, semi-structured documents in formats like JSON or BSON. They provide a schema-less design and allow for easy modification of the data structure. For storing the codewords and codebook, document databases can be used to store each codeword as a document, along with its associated data or metadata. The codebook can be stored as a collection of documents, where each document represents a codeword and its related information. Document databases offer flexibility in terms of data structure, allowing for easy addition or modification of codeword attributes. They also provide querying capabilities based on document fields, enabling efficient retrieval of codewords based on specific criteria.

Relational databases, such as MySQL, PostgreSQL, or Oracle, can also be used to store the codewords and codebook. In a relational database, the codewords can be stored in a table with columns representing the codeword and its associated data or metadata. The codebook can be stored in a separate table, with each row representing a codeword and its corresponding information. Relational databases provide structured querying capabilities using SQL, allowing for efficient retrieval and filtering of codewords based on specific conditions. Relational databases offer strong consistency, ACID properties, and support for complex queries, making them suitable for scenarios where data integrity and structured querying are important.

Graph databases, such as Neo4j or Amazon Neptune, store data as nodes and edges in a graph structure. They are designed to efficiently handle complex relationships and connections between data entities. For storing the codewords and codebook, graph databases can be used to represent the relationships between codewords and their associated data or metadata. Each codeword can be represented as a node in the graph, with edges connecting related codewords or linking codewords to their corresponding data. Graph databases provide efficient traversal and querying capabilities based on the graph structure, allowing for fast retrieval of connected codewords and exploration of relationships between codewords.

Distributed key-value stores, such as Apache Cassandra or Apache HBase, are designed to handle large-scale data and provide high scalability and fault tolerance. They distribute data across multiple nodes in a cluster, allowing for horizontal scaling. For storing the codewords and codebook, distributed key-value stores can be used to store codewords as key-value pairs, similar to regular key-value stores. The codebook can be partitioned and distributed across multiple nodes in the cluster, enabling high scalability and performance. Distributed key-value stores offer eventual consistency, high write throughput, and the ability to handle large volumes of data, making them suitable for scenarios where scalability and fault tolerance are critical.

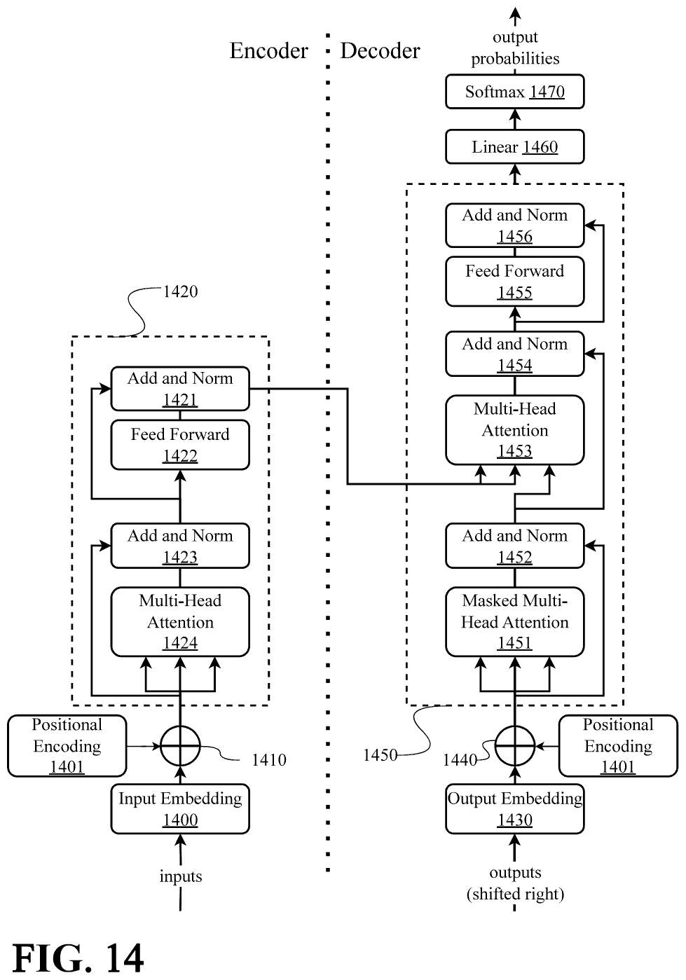

FIG. 14 is a block diagram illustrating an embodiment of the system and method for a large codeword model for deep learning, where the machine learning core is a Transformer-based core. A Transformer generally comprises an Encoder (the components on the left side of the illustration) and a Decoder (the components on the right side of the illustration).

The illustrated Transformer comprises an Encoder and a Decoder. The Encoder takes input embeddings and processes them through a stack of layers (represented as dashed box 1420). Each layer consists of: positional encoding, which adds position information to the input embeddings; multi-head attention, which allows the model to attend to different parts of the input sequence; add and norm, which applies residual connection and layer normalization; feed forward, which is a fully connected feed-forward network; and add and norm which is another residual connection and layer normalization.

The power of the transformer model lies in the self-attention mechanism. This mechanism contributes to accelerated learning compared to traditional models such as long short-term memory models. Self-attention empowers the transformer model with the remarkable capability to meticulously scrutinize distinct segments of a given sequence or even encompass the entire contextual essence of a sentence. This profound contextual awareness enables the model to make predictions with an elevated degree of accuracy and relevance.

The input embedding 1400 to the Encoder is a sequence of tokens, typically represented as integers. Each token is mapped to a learnable embedding vector of a fixed size. The embedding layer is a lookup table that converts each token into its corresponding dense vector representation. The embeddings are learned during training and capture semantic and syntactic relationships between tokens.

A dense vector representation, also known as a dense embedding or a continuous vector representation, is a way of representing data, particularly words or tokens, as dense vectors in a high-dimensional continuous space. In the context of natural language processing (NLP) and language models, dense vector representations are used to capture semantic and syntactic information about words or tokens. Each word or token is mapped to a fixed-size vector of real numbers, typically with hundreds or thousands of dimensions. Each word or token is represented by a vector of a fixed size, regardless of the length of the input sequence. The size of the vector is a hyperparameter that is determined during model design. The vectors exist in a continuous high-dimensional space, where each dimension represents a latent feature or aspect of the word or token. The continuous nature allows for capturing fine-grained relationships and similarities between words. Dense vector representations are learned during the training process of the model. The model learns to assign similar vectors to words that have similar meanings or occur in similar contexts. The dense vector representations aim to capture semantic and syntactic relationships between words. Words that have similar meanings or are used in similar contexts tend to have similar vector representations. Dense vector representations allow for performing algebraic operations on words, such as addition and subtraction. These operations can capture analogies and relationships between words, such as “prince”−“man”+“woman”≈“princess”. Dense vector representations serve as input features for various downstream NLP tasks, such as text classification, sentiment analysis, named entity recognition, and machine translation. The dense representations provide a rich and informative input to the models, enabling them to learn patterns and make predictions. Some popular examples of dense vector representations include, but are not limited to, Word2Vec, Global Vectors for Word Representations (GloVe), FastText, and BERT.

After the input embedding layer, positional encoding 1401 is added to the input embedding to provide position information to the model. The positional encoding 1401 and the input embedding 1400 may be added using a function 1410. Since the Transformer architecture doesn't have inherent recurrence or convolution, positional encodings help capture the order and relative positions of tokens. The positional encodings are typically sine and cosine functions of different frequencies, allowing the model to learn relative positions. The positional encodings have the same dimensionality as the input embeddings and are summed with them.

The Encoder utilizes a multi-head attention mechanism 1424 which is a key component of the Transformer architecture. It allows the Encoder to attend to different parts of the input sequence and capture dependencies between tokens. The attention mechanism computes three matrices: Query (Q), Key (K), and Value (V). The Query, Key, and Value matrices are obtained by linearly projecting the input embeddings using learned weight matrices. The attention scores are computed by taking the dot product of the Query matrix with the transpose of the Key matrix, followed by scaling and applying a softmax function. The attention scores determine the importance of each token in the input sequence for a given position. The Value matrix is then multiplied with the attention scores to obtain the weighted sum of the values, which forms the output of the attention mechanism. Multi-Head Attention splits the Query, Key, and Value matrices into multiple heads, allowing the model to attend to different aspects of the input simultaneously. The outputs from each head are concatenated and linearly projected to obtain the final output of the Multi-Head Attention layer 1424.

After the Multi-Head Attention layer, a residual connection is applied, followed by Layer Normalization at add and norm 1423. The residual connection adds the input embeddings to the output of the attention layer, helping the model learn faster and deeper. Layer Normalization normalizes the activations across the features, stabilizing the training process.

The Feed Forward layer 1422 is a fully connected neural network applied to each position of the Encoder's hidden states. It consists of two linear transformations with a Rectified Linear Unit (ReLU) activation function in between. The purpose of the Feed Forward layer is to introduce non-linearity and increase the model's capacity to learn complex representations. The output of the Feed Forward layer has the same dimensionality as the input embeddings. A residual connection and Layer Normalization 1421 are applied after the Feed Forward layer.

The Encoder layers 1420 are stacked Nx times, where N is a hyperparameter that determines the depth of the Encoder. Each layer follows the same structure: Multi-Head Attention, Add & Norm, Feed Forward, and Add & Norm. By stacking multiple Encoder layers, the model can capture hierarchical and long-range dependencies in the input sequence. The output of the final Encoder layer represents the encoded input sequence, which is then passed to the Decoder for generating the output sequence.

The Decoder generates the output probabilities. It has a similar structure to the Encoder, with a few additions. The Decoder takes output embeddings and processes them through a stack of layers (represented as dashed box 1450). The output embedding layer 1430 takes the previous output tokens (shifted right by one position) and converts them into dense vectors. Each token is mapped to a learnable embedding vector of a fixed size. The embedding vectors capture semantic and syntactic relationships between tokens.

Positional encoding 1401 is added to the output embedding 1430 to provide position information to the model. Positional encoding 1401 may be added to the output embedding 1430 through a function 1440. Since the Transformer architecture does not have inherent recurrence or convolution, positional encodings help capture the order and relative positions of tokens. The positional encodings are typically sine and cosine functions of different frequencies, allowing the model to learn relative positions.

The masked multi-head attention 1451 mechanism prevents the model form attending to future tokens. This layer performs self-attention on the Decoder's input sequence. It allows the Decoder to attend to different parts of its own input sequence. The attention is “masked” to prevent the Decoder from attending to future tokens, ensuring that the predictions are based only on the previously generated tokens. Multi-head attention splits the input into multiple heads, allowing the model to attend different aspect of the input simultaneously.

After the masked multi-head attention, a residual connection is applied follows by layer normalization via add and norm 1452. The residual connection adds the input to the output of the attention layer, helping the model learn faster and deeper. Layer normalization normalizes the activations across the features, stabilizing the training process.

The multi-head attention 1453 layer performs attention between the Decoder's hidden states and the Encoder's output. It allows the Decoder to attend to relevant parts of the input sequence based on the Encoder's representations. The attention weights are computed based on the compatibility between the Decoder's hidden states and Encoder's outputs.

Another add and norm 1454 layer is then followed by feed forward network 1455. This a fully connected feed-forward network applied to each position of the Decoder's hidden states. It consists of two linear transformations with a Rectified Linear Unit (ReLU) activation in between. The feed forward layer helps the model capture non-linear interactions and increases the model's capacity.

Another add and norm 1456 layer is followed by linear 1460 and softmax 1470 layers. The final hidden states of the Decoder are passed through a linear transformation to project them into the vocabulary space. Vocabulary space refers to the set of all unique tokens or words that the model can generate or predict. In the context of language models, the vocabulary is a predefined set of tokens that the model is trained on and can output. When the Decoder's final hidden states are passed through a linear transformation, they are projected into a vector space with the same dimensionality as the size of the vocabulary. Each dimension in this space corresponds to a specific token in the vocabulary. For example, the model has a vocabulary of 10,000 unique tokens. The linear transformation would project the Decoder's hidden states into a 10,000-dimensional vector space. Each element in this vector represents the model's predicted probability or score for the corresponding token in the vocabulary.

A softmax function is applied to the projected values (vectors) to generate output probabilities over the vocabulary. The softmax function normalizes the values so that they sum up to 1, representing a probability distribution over the vocabulary. Each probability indicates the likelihood of a specific token being the next output token. The token with the highest probability is selected as the next output token. During the model's training, the objective is to maximize the probability of the correct next token given the input sequence and the previously generated tokens. The model learns to assign higher probabilities to the tokens that are more likely to appear based on the context. At inference time, the token with the highest probability in the vocabulary space is selected as the next output token. This process is repeated iteratively, with the generated token being fed back into the Decoder as input for the next step, until a stopping criterion is met (e.g., reaching a maximum length or generating an end-of-sequence token). The size and composition of the vocabulary can vary depending on the specific task and the data the model is trained on. It can include words, sub-words, or even characters, depending on the tokenization strategy used.

The Decoder layers 1450 can be stacked Nx times, allowing the model to capture complex dependencies and generate coherent output sequences.

This transformer architecture allows the model to process input sequences, capture long-range dependencies, and generate output sequence based on the encoded input and the previously generated codewords.

There are at least three variations of transformer architecture that may enable an LCM. A first such variation comprises Auto-Encoding Models. In autoencoders, the decoder portion of the transformer is discarded after pre-training and only the encoder is used to generate the output. The popular BERT and RoBERTa models are examples of models based on this architecture and perform well on sentiment analysis and text classification. These types of models may be trained using a process called masked language modeling (MLM).

The primary goal of an autoencoder is to learn efficient representations of input data by encoding the data into a lower-dimensional space and then reconstructing the original data from the encoded representation. Autoencoders are trained in an unsupervised manner, meaning they don't require labeled data. They learn to capture the underlying structure and patterns in the input data without explicit guidance. An autoencoder consists of two main components: an encoder and a decoder. The encoder takes the input data and maps it to a lower-dimensional representation, often referred to as the latent space or bottleneck. The decoder takes the latent representation and tries to reconstruct the original input data. Autoencoders can be used for dimensionality reduction by learning a compressed representation of the input data in the latent space. The latent space has a lower dimensionality than the input data, capturing the most salient features or patterns. The training objective of an autoencoder is to minimize the reconstruction error between the original input and the reconstructed output. The model learns to encode and decode the data in a way that preserves the essential information needed for reconstruction. Variants and extensions of autoencoders can include denoising autoencoders, variational autoencoders (VAEs) which introduce a probabilistic approach to autoencoders wherein they learn a probabilistic encoder and decoder, allowing for generating new samples from the learned latent space, and conditional autoencoders which incorporate additional conditions or labels as input to the encoder and decoder, enabling the generation of samples conditioned on specific attributes.

Autoencoders can have various applications. Autoencoders can be used to detect anomalies by measuring the reconstruction error. Anomalous samples tend to have higher reconstruction errors compared to normal samples. Autoencoders can be used as a pre-training step to learn meaningful features from unlabeled data. The learned features can then be used for downstream tasks like classification or clustering. Additionally, or alternatively, autoencoders, particularly VAEs, can be used as generative models to generate new samples similar to the training data by sampling from the learned latent space. It's worth noting that while autoencoders can be effective for certain tasks, they have some limitations. They may struggle to capture complex dependencies and may generate blurry or less sharp reconstructions compared to other generative models like Generative Adversarial Networks (GANs).

Another type of variation is the auto-regressive model which feature the use of only the decoder portion of the transformer architecture. In autoregressive architectures, the decoder portion of the transformer is retained and the encoder portion is not used after model pre-training. Auto-regressive models are a class of models that generate outputs by predicting the next element based on the previously generated elements. In the context of the Transformer architecture and language modeling, auto-regressive models are commonly used for tasks such as text generation, machine translation, and language understanding.

Auto-regressive models generate outputs sequentially, one element at a time. In the case of language modeling, the model predicts the next word or token based on the previous words or tokens in the sequence. The prediction of the next element is conditioned on the previously generated elements. The model learns the conditional probability distribution P(x_t|x_1, x_2, . . . , x_{t−1}), where x_t is the element at position t, and x_1, x_2, . . . , x_{t−1} are the previously generated elements. The Transformer architecture, particularly the Decoder component, is well-suited for auto-regressive modeling. The Decoder generates the output sequence one element at a time, conditioned on the previously generated elements and the encoded input sequence from the Encoder. In the Transformer Decoder, the self-attention mechanism is masked to prevent the model from attending to future positions during training. This masking ensures that the model relies only on the previously generated elements to make predictions, following the auto-regressive property. During training, the Transformer Decoder uses a technique called teacher forcing. Instead of feeding the model's own predictions as input for the next step, the ground truth target sequence is used. This helps the model learn to generate the correct output sequence based on the input sequence and the previous target tokens. During inference or generation, the Transformer Decoder generates the output sequence one element at a time. At each step, the model takes the previously generated elements as input and predicts the next element. This process continues until a stopping criterion is met, such as reaching a maximum sequence length or generating an end-of-sequence token. Auto-regressive models, including the Transformer, have achieved state-of-the-art performance in language modeling tasks. They excel at capturing the statistical properties and dependencies in sequential data, making them effective for generating coherent and fluent text.

While text generation is the most suitable use case of auto-regressors, they perform exceptionally well on a wide variety of tasks. Most modern LLMs are auto-regressors including, for example, the popular GPT series of LLMs, BERT, and XLNet.

The third variation of the transformer model is the sequence-to-sequence model which utilizes both the encoder and decoder portions of the transformer and can be trained in multiple ways. One of the methods is span corruption and reconstruction. These models are, generally, best suited for language translation. The T5 and BART family of models are examples of sequence-to-sequence models.

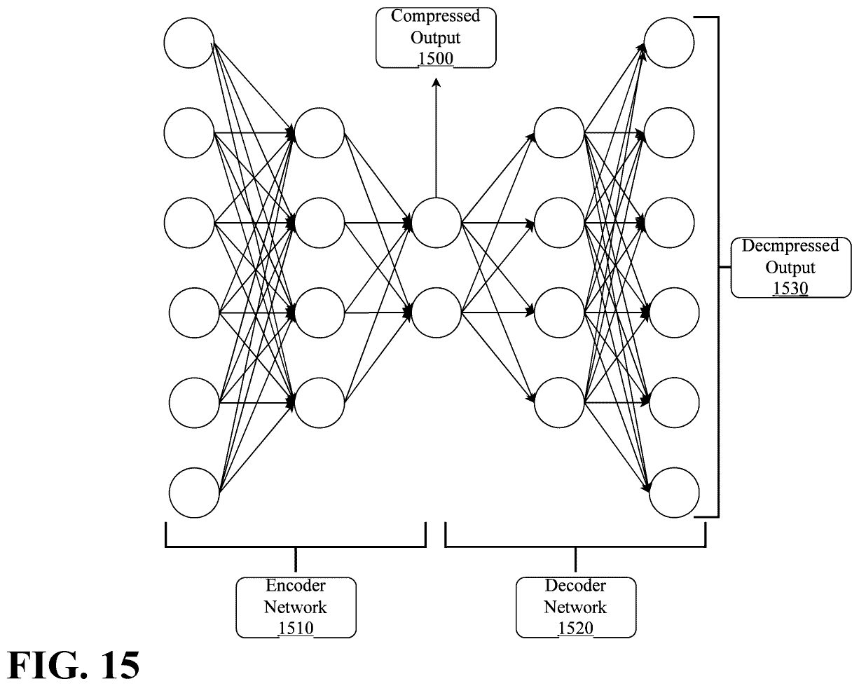

FIG. 15 is a block diagram illustrating an embodiment of the system and method for a large codeword model for deep learning, where the machine learning core is a VAE-based core. An autoencoder network comprises an encoder network 1510 or a decoder network 1520 that work together to encode and decode data effectively. The encoder network 1510 and decoder network 1520 within the autoencoder network is comprised of a plurality of layers that contribute to the encoding and decoding process. These layers include, but are not limited to, convolutional layers, pooling layers, and a bottleneck layer. Some embodiments also include functions that operate on information including but not limited to rectified linear unit functions, sigmoid functions, and skip connections.

The convolutional layers are responsible for extracting meaningful features from the input data. They apply convolutional operations using learnable filters to capture spatial patterns and hierarchical representations of the data. The convolutional layers can have different numbers of filters, kernel sizes, and strides to capture features at various scales and resolutions. Skip connections are employed to facilitate the flow of information across different layers of the autoencoder. Skip connections allow the output of a layer to be directly added to the output of a subsequent layer, enabling the network to learn residual mappings and mitigate the vanishing gradient problem. Skip connections help in preserving fine-grained details and improving the training stability of the autoencoder.

Pooling layers are used to downsample the feature maps generated by the convolutional layers. They reduce the spatial dimensions of the feature maps while retaining the most salient information. Common pooling operations include but are not limited to max pooling and average pooling. Pooling layers help in achieving translation invariance, reducing computational complexity, and controlling the receptive field of the autoencoder. Rectified Linear Unit (ReLU) functions introduce non-linearity into the autoencoder by applying a ReLU activation function element-wise to the output of the previous layer. ReLU functions help in capturing complex patterns and relationships in the data by allowing the network to learn non-linear transformations. They also promote sparsity and alleviate the vanishing gradient problem. The bottleneck layer represents the most compressed representation of the input data. The bottleneck layer has a significantly reduced dimensionality compared to the input and output layers of the autoencoder. It forces the network to learn a compact and meaningful encoding of the data, capturing the essential features and discarding redundant information. In one embodiment, the multi-layer autoencoder network is comprised of a plurality of the previously mentioned layers where the sequence and composition of the layers may vary depending on a user's preferences and goals. The bottleneck layer is where the compressed output 1500 is created. Each layer previous to the bottleneck layer creates a more and more compressed version of the original input. The layers after the bottleneck layer represent the decoder network 1530 where a plurality of layers operate on a compressed input to decompress a data set. Decompression results in a version of the original input which is largely similar but has some lost data from the transformations.

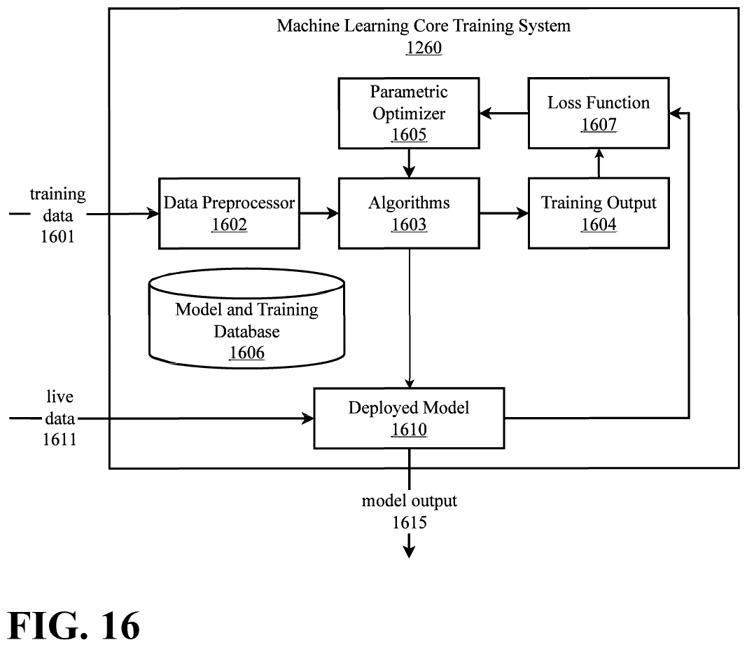

FIG. 16 is a block diagram illustrating an aspect of system and method for a large codeword model for deep learning, a machine learning core training system. According to the embodiment, the machine learning core training system 1260 may comprise a model training stage comprising a data preprocessor 1602, one or more machine and/or deep learning algorithms 1603, training output 1604, and a parametric optimizer 1605, and a model deployment stage comprising a deployed and fully trained model 1610 configured to perform tasks described herein such as processing codewords through a large codeword model. The machine learning core training system 1260 may be used to train and deploy a plurality of machine learning architectures in order to support the services provided by the large codeword model for deep learning.

At the model training stage, a plurality of training data 1601 may be received by the generative AI training system 1650. Data preprocessor 1602 may receive the input data (e.g., codewords, sourceblocks) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 1602 may also be configured to create training dataset, a validation dataset, and a test set from the plurality of input data 1601. For example, a training dataset may comprise 80% of the preprocessed input data, the validation set 10%, and the test dataset may comprise the remaining 10% of the data. The preprocessed training dataset may be fed as input into one or more machine and/or deep learning algorithms 1603 to train a predictive model for object monitoring and detection.

During model training, training output 1604 is produced and used to measure the accuracy and usefulness of the predictive outputs. During this process a parametric optimizer 1605 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning core training system 1260 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 1607 to measure the system's performance. The loss function 1607 compares the training outputs with an expected output and determined how the algorithm needs to be changed in order to improve the quality of the model output. During the training stage, all outputs may be passed through the loss function 1607 on a continuous loop until the algorithms 1603 are in a position where they can effectively be incorporated into a deployed model 1615.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 1610 in a production environment making predictions based on live input data 1611 (e.g., interest factor data, incentive data). Further, model correlations and restorations made by deployed model can be used as feedback and applied to model training in the training stage, wherein the model is continuously learning over time using both training data and live data and predictions. A model and training database 1606 is present and configured to store training/test datasets and developed models. Database 1606 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 1603 may comprise a deep learning algorithm such as neural networks (e.g., recurrent, convolutional, long short-term memory networks, etc.).

In some implementations, the machine learning core training system 1260 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 1606.

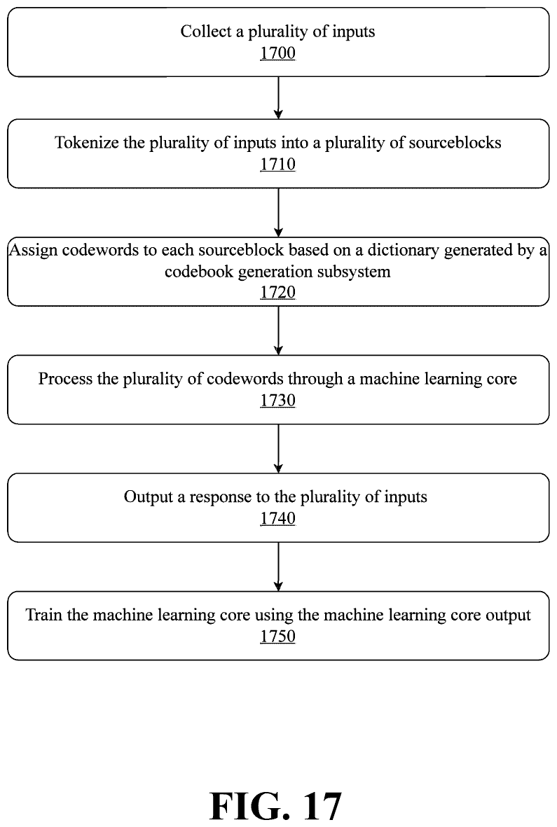

FIG. 17 is a flow diagram illustrating an exemplary method for a large codeword model for deep learning. In a first step 1700, collect a plurality of inputs from various sources, such as user input, sensor data, or existing datasets. These inputs can be in different modalities, including text, images, audio, time series, or any other structured or unstructured format.

In a step 1710, the collected inputs are tokenized into a plurality of sourceblocks. Tokenization is performed by the tokenizer component of the LCM architecture, which splits the input data into meaningful semantic units called sourceblocks. The tokenizer employs techniques like syntactic splitting or semantic splitting to capture the inherent structure and patterns in the data. For textual data, the tokenizer may use subword tokenization methods like Byte-Pair Encoding (BPE) or WordPiece. For other modalities, such as images or audio, the tokenizer may use domain-specific techniques to identify and extract relevant sourceblocks.

In a step 1720, each sourceblock is assigned a unique codeword based on a dictionary generated by the codebook generation subsystem. The codebook generation subsystem creates and maintains a dictionary that maps sourceblocks to their corresponding codewords. Codewords are discrete, compressed representations of the sourceblocks, designed to capture the essential information in a compact form. The codeword assignment can be based on various techniques, such as frequency-based coding, hash functions, or learned mappings.

In a step 1730, the assigned codewords are then processed through the machine learning core of the LCM. The machine learning core is the central component of the LCM architecture, responsible for learning and generating responses based on the input codewords. It can be implemented using various configurations, such as a Transformer-based core, a Variational Autoencoder (VAE)-based core, or a combination of different architectures. The machine learning core learns to map input codeword sequences to output codeword sequences, capturing the patterns, relationships, and semantics within the data.

In a step 1740, the machine learning core generates an output response. The output response can be in the form of codewords, which are then mapped back to the corresponding sourceblocks or tokens using the inverse mapping scheme defined in the codebook. Alternatively, the output response can be directly generated in the target modality, such as text, images, or audio, depending on the specific application.

In a step 1750, to improve the performance and adaptability of the LCM, the machine learning core is trained using the generated output. The training process involves comparing the generated output with the expected or desired output, and adjusting the parameters of the machine learning core accordingly. This can be done using techniques like backpropagation, gradient descent, or reinforcement learning, depending on the specific architecture and objective of the LCM. The training process allows the LCM to learn from its own outputs and continuously improve its performance over time.

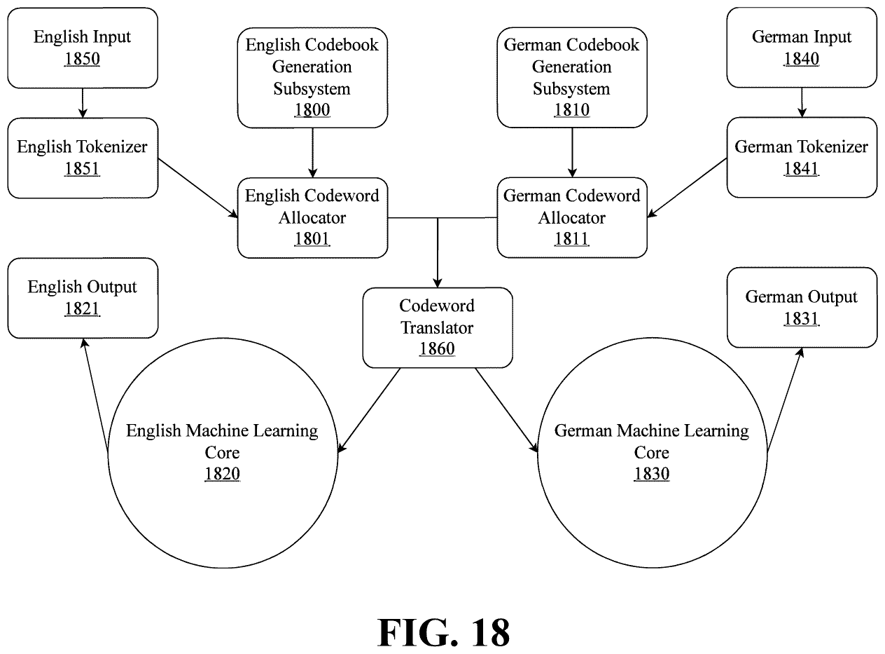

FIG. 18 is a block diagram illustrating an exemplary embodiment of a large codeword model where the model is configured to translate various language inputs. The system consists of several key components that work together to enable translation between two languages, in this case, English and German. The system includes separate codebook generation subsystems, codeword allocators, and machine learning cores for each language, as well as a codeword translator that facilitates the translation process.

An English input 1850 represents the source text or data that needs to be translated from English to German. This input is fed into an English tokenizer 1851, which is responsible for tokenizing the English input into a plurality of sourceblocks. The English tokenizer 1851 employs language-specific techniques, such as subword tokenization methods like Byte-Pair Encoding (BPE) or WordPiece, to split the input into meaningful semantic units that capture the linguistic structure and patterns of the English language.

The tokenized English sourceblocks are then processed by an English codebook generation subsystem 1800. This subsystem generates and maintains a codebook specifically for the English language. The English codebook is a dictionary that maps each English sourceblock to a corresponding codeword. Codewords are discrete, compressed representations of the sourceblocks, designed to capture the essential linguistic information in a compact form. The codebook generation subsystem uses techniques like frequency-based coding, hash functions, or learned mappings to assign codewords to the sourceblocks. An English codeword allocator 1801 takes the tokenized English sourceblocks and assigns the corresponding codewords from the English codebook. This process converts the English sourceblocks into a sequence of codewords that represent the English input in a compressed and efficient format.

The sequence of English codewords is then processed by an English machine learning core 720. This core is a specialized component of the LCM architecture that is trained specifically on the English language. It learns to map input codeword sequences to output codeword sequences, capturing the linguistic patterns, relationships, and semantics of the English language. The English machine learning core 1820 may be implemented using various configurations, such as a Transformer-based core, a Variational Autoencoder (VAE)-based core, or a combination of different architectures, tailored to the characteristics of the English language.

The English machine learning core 1820 generates an English output 1821 in the form of a sequence of codewords. These codewords represent the translated content in the English language, encoded in the compressed codeword format.

To perform the translation from English to German, the system utilizes a codeword translator 1860. The codeword translator 1860 maps the English codewords to their corresponding German codewords. It learns the mappings between the codewords of the two languages, enabling cross-lingual translation. The codeword translator 1860 can be implemented using various techniques, such as neural machine translation models, cross-lingual word embeddings, or learned mapping functions.

In the depicted case, the codeword translator 1860 takes the English codeword output 1821 and translates it into a sequence of German codewords. These German codewords represent the translated content in the German language, encoded in the compressed codeword format.

The translated German codewords are then processed by a German machine learning core 1830. Similar to the English machine learning core 1820, the German Machine Learning Core is a specialized component trained specifically on the German language. It learns to map input German codeword sequences to output sequences in the German language, capturing the linguistic patterns and semantics of German. The German machine learning core 1830 generates a German output 1831 based on the translated German codewords. This output represents the final translated content in the German language.

The system also includes a German codebook generation subsystem 1810 and a German codeword allocator 1811, which serve similar purposes as their English counterparts but are specific to the German language. These components handle the generation and allocation of German codewords based on a German input 1840 and a German tokenizer 1841. This system may be configured to handle any plurality of languages. The English and German codebooks and machine learning cores are simply examples. Likewise, a machine learning core may be trained to process any given language, depending on needs. The modular architecture of the system allows for flexibility and scalability in handling multiple languages. The system can be extended to support additional language pairs by incorporating language-specific codebook generation subsystems, codeword allocators, and machine learning cores, along with corresponding codeword translators.

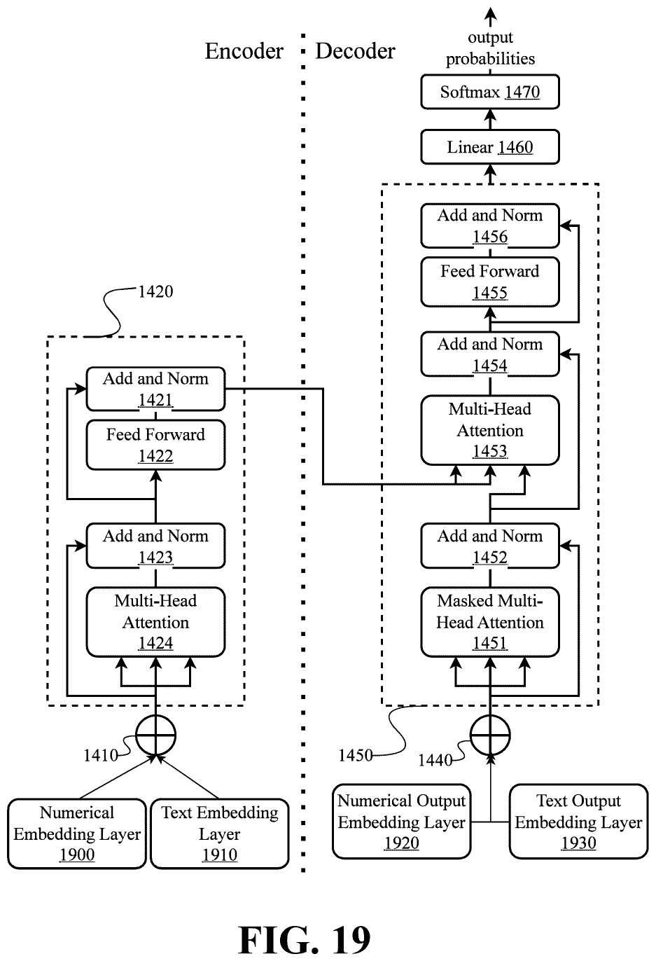

FIG. 19 is a block diagram illustrating an exemplary embodiment of a large codeword model with a dual embedding layer. The LCM may be configured to process inputs through a plurality of embedding layers. In one example, inputs of different modalities may be processed through a numerical embedding layer 1900 and a text embedding layer 1910. The numerical embedding layer 1900 is responsible for processing numerical input data, mapping it into a dense vector representation. It learns to capture the relevant patterns and relationships within the numerical data. Similarly, the text embedding layer 1910 handles the processing of textual input data, mapping each token to a dense vector representation and capturing the semantic and syntactic information present in the text.

The embedded vectors from each embedding layer may be concatenated to form a single input stream. To concatenate the numerical and text embeddings along the feature dimension, they have the same sequence length. This can be achieved by padding the shorter sequence or truncating the longer sequence to match the lengths. The numerical embeddings and text embeddings are then concatenated along the feature dimension. The feature dimensionality of the combined sequence is the sum of the embedding dimensions of the individual modalities. The combined input sequence contains information from both the numerical and text input data, with each position in the sequence representing a concatenation of the corresponding numerical and text embeddings.

The combined input sequence may then be passed through an encoder within a transformer. Inside the encoder, a multi-head attention 1924 sub-layer performs self-attention on the combined input sequence. It allows the model to attend to different positions within the sequence and capture dependencies between the numerical and text features. The self-attention mechanism computes attention weights based on the similarity between different positions in the sequence, enabling the model to focus on relevant information. Feed forward layers within the transformer may learn to combine and transform features from all types of codewords, non-dependent on their original modality.

The single input stream is processed through the remainder of the transformer architecture, which is explained more in depth in FIG. 15. By concatenating the embeddings from different modalities and processing them through the Transformer architecture, the system can effectively learn and utilize the cross-modal interactions and dependencies. The self-attention mechanism in the Transformer allows the model to capture relationships between the numerical and text features at different positions in the sequence, enabling it to generate coherent and contextually relevant outputs.

The concatenation of embeddings along the feature dimension provides a flexible and extensible approach to integrating multiple input modalities. It allows the system to handle various data types and learn joint representations that leverage information from different sources. This approach can be extended to incorporate additional modalities by adding corresponding embedding layers and concatenating their outputs to the combined input sequence.

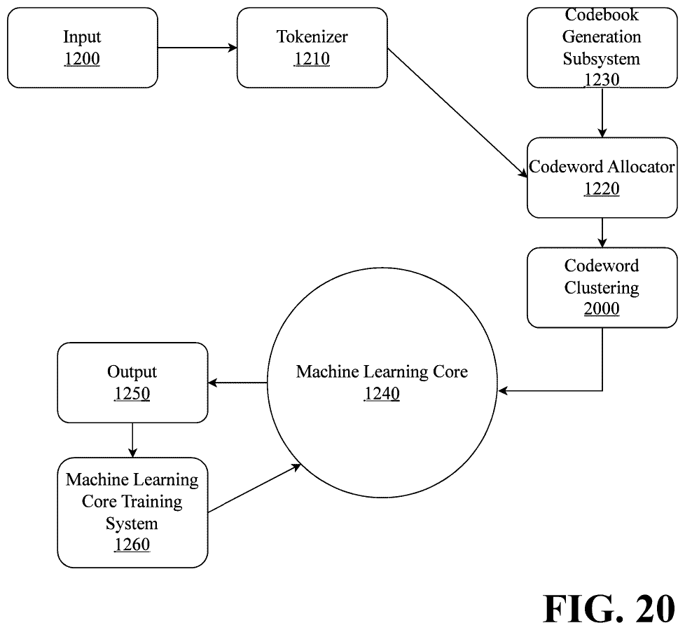

FIG. 20 is a block diagram illustrating an exemplary embodiment of a large codeword model which uses codeword clustering. This approach aims to capture semantic similarities and relationships among codewords, enabling more efficient and meaningful representations for downstream processing.

The system starts with an input 1200, which receives the raw data that needs to be processed. This data can be in various formats, such as text, images, audio, or any other structured or unstructured data. The input data is then passed to a tokenizer 1210, which is responsible for tokenizing the raw data into a sequence of smaller units called sourceblocks. The tokenization process depends on the specific data type and can involve techniques like subword tokenization, byte-pair encoding, or domain-specific tokenization methods.

After tokenization, the sourceblocks are sent to a codeword allocator 1220. The codeword allocator 1220 assigns a unique codeword to each sourceblock based on a predefined codebook generated by a codebook generation subsystem 1230. The codebook is a mapping between sourceblocks and their corresponding codewords, which are compact and discrete representations of the sourceblocks. The codebook generation subsystem 1230 uses techniques like frequency-based coding, hash functions, or learned mappings to generate the codebook.

The assigned codewords are then passed to the codeword clustering 2000 component, which groups semantically similar or related codewords together based on their co-occurrence patterns or semantic proximity in the training data. This clustering process aims to capture the underlying semantic structure and relationships among the codewords. Various clustering algorithms can be employed in the codeword clustering 2000 component, such as k-means clustering, hierarchical clustering, or density-based clustering. The choice of the clustering algorithm depends on the specific characteristics of the data and the desired granularity of the clusters. The clustering process takes into account the semantic similarity between codewords, which can be measured using techniques like cosine similarity, Euclidean distance, or other similarity metrics.

Once the codewords are clustered, the system learns individual vector embeddings for each cluster of codewords, rather than learning embeddings for individual codewords. This approach reduces the dimensionality of the embedding space and allows for more efficient representation learning. The clustered codewords are mapped to dense vector representations in a continuous vector space, capturing the semantic and syntactic information of the codewords within each cluster.

The vector embeddings of the clustered codewords may then processed by the machine learning core 1240. The machine learning core 1240 is responsible for learning and generating meaningful representations and outputs based on the input codeword embeddings. It can consist of various architectures, such as Transformer models, recurrent neural networks, or convolutional neural networks, depending on the specific task and data type. An output 150 is generated by the machine learning core 1240 and is based on the processed codeword embeddings from the machine learning core 1240. The output can be in various formats, such as text, images, or any other desired representation, depending on the specific application.

The incorporation of codeword clustering before vector embedding in the LCM architecture brings several benefits. By grouping semantically similar codewords together, the system can learn more meaningful and compact representations, reducing the dimensionality of the embedding space. This can lead to improved efficiency in terms of memory and computational resources. Moreover, the clustered codeword embeddings can capture higher-level semantic concepts and relationships, enabling the system to generalize better to unseen or rare codewords. The clustering process helps in handling data sparsity and can improve the robustness and interpretability of the learned representations.

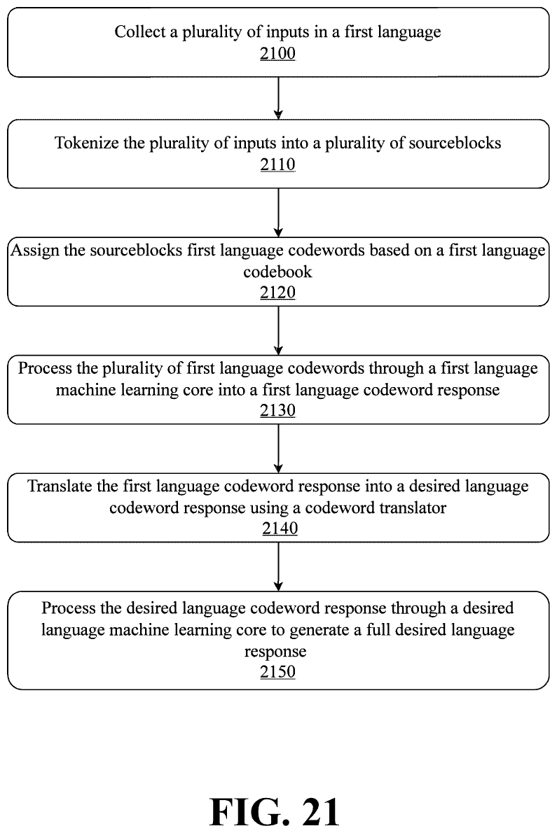

FIG. 21 is a flow diagram illustrating an exemplary method for language translation using a large codeword model for deep learning. In a first step 2100, collect a plurality of inputs in a first language. These inputs can be in various forms, such as text, speech, or any other language-based data. The first language represents the source language from which the translation will be performed.

In a step 2110, the collected inputs in the first language are tokenized into a plurality of sourceblocks. Tokenization is performed by the tokenizer component of the LCM architecture, which splits the input data into meaningful semantic units called sourceblocks. The tokenizer employs language-specific techniques to capture the linguistic structure and patterns of the first language. This may involve using subword tokenization methods like Byte-Pair Encoding (BPE) or WordPiece, or language-specific tokenization rules based on the grammatical and morphological properties of the first language.

In a step 2120, each sourceblock in the first language is assigned a codeword based on a first language codebook. The LCM architecture maintains a plurality of codebooks, each configured for a specific language. The first language codebook is a dictionary that maps sourceblocks in the first language to their corresponding codewords. Codewords are discrete, compressed representations of the sourceblocks, designed to capture the essential linguistic information in a compact form. The codeword assignment can be based on various techniques, such as frequency-based coding, hash functions, or learned mappings specific to the first language.

In a step 2130, the assigned first language codewords are then processed through a first language machine learning core. The first language machine learning core is a specialized component of the LCM architecture that is trained specifically on the first language. It learns to map input codeword sequences in the first language to output codeword sequences, capturing the linguistic patterns, relationships, and semantics of the first language. The first language machine learning core can be implemented using various configurations, such as a Transformer-based core, a Variational Autoencoder (VAE)-based core, or a combination of different architectures, tailored to the characteristics of the first language.

The first language machine learning core generates a first language codeword response. This response represents the output of the LCM in the first language, encoded as a sequence of codewords.

In a step 2140, a codeword translated is used to translate the first language codeword response into the desired language. The codeword translator is a component of the LCM architecture that maps codewords from the first language codebook to codewords in the desired language codebook. It learns the mappings between codewords across different languages, enabling cross-lingual translation. The codeword translator can be implemented using various techniques, such as neural machine translation models, cross-lingual word embeddings, or learned mapping functions.

The codeword translator converts the first language codeword response into a desired language codeword response. This response represents the translated output in the desired language, encoded as a sequence of codewords from the desired language codebook.

In a step 2150, the desired language codeword response is processed through a desired language machine learning core. The desired language machine learning core is another specialized component of the LCM architecture, trained specifically on the desired language. It learns to map input codeword sequences in the desired language to output sequences in the same language, capturing the linguistic patterns and semantics of the desired language. The desired language machine learning core generates a full desired language response which represents the final translated output in the desired language.

The method described provides a framework for using LCMs as translators between different languages. By maintaining language-specific codebooks and machine learning cores, the LCM can effectively capture the linguistic properties and nuances of each language. The codeword translator acts as a bridge between the different language representations, enabling cross-lingual translation. The modular nature of the LCM architecture allows for flexibility and scalability in handling multiple languages. New languages can be added by creating language-specific codebooks and training corresponding machine learning cores. The codeword translator can be extended to support translation between multiple language pairs, enabling a versatile and efficient translation system.

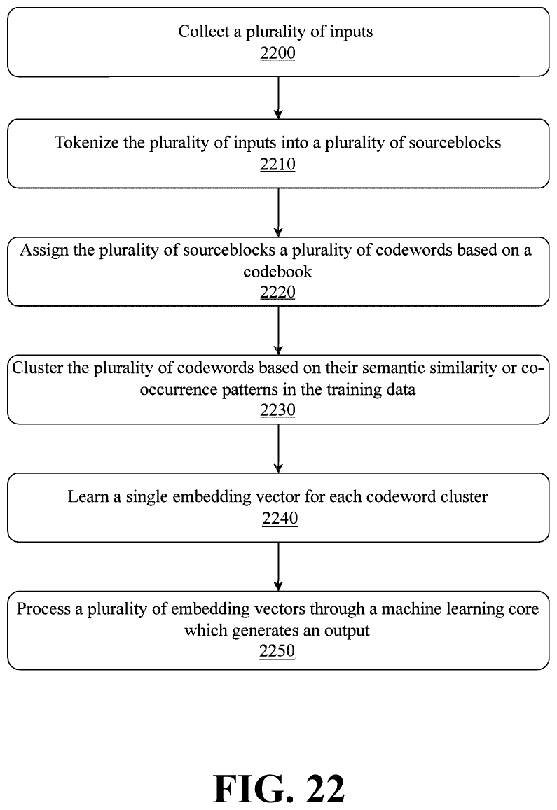

FIG. 22 is a flow diagram illustrating an exemplary method for codeword clustering using a large codeword model. In a step 2200, collect a plurality of inputs. These inputs can be from various sources and modalities, such as text, images, audio, time series, or any other structured or unstructured data. The inputs represent the data that needs to be processed by the LCM.

In a step 2210, the collected inputs are tokenized into a plurality of sourceblocks. Tokenization is performed by the tokenizer component of the LCM architecture, which splits the input data into meaningful semantic units called sourceblocks. The tokenizer employs techniques specific to each input modality to capture the relevant patterns and structures. For textual data, this may involve using subword tokenization methods like Byte-Pair Encoding (BPE) or WordPiece. For other modalities, such as images or audio, the tokenizer may use domain-specific techniques to extract relevant features or segments.

In a step 2220, each sourceblock is assigned a codeword based on a codebook. The codebook is a dictionary that maps sourceblocks to their corresponding codewords. Codewords are discrete, compressed representations of the sourceblocks, designed to capture the essential information in a compact form. The codeword assignment can be based on various techniques, such as frequency-based coding, hash functions, or learned mappings.

In a step 2230, the assigned codewords are then clustered based on their semantic similarity or co-occurrence patterns in the training data. Codeword clustering is a technique that groups semantically related or frequently co-occurring codewords together. This clustering process aims to capture the underlying semantic structure and relationships among the codewords. Various clustering algorithms can be employed, such as but not limited to k-means clustering, hierarchical clustering, or topic modeling techniques like Latent Dirichlet Allocation (LDA). The clustering algorithm takes into account the semantic similarity between codewords, which can be determined using measures like cosine similarity or semantic embeddings learned from the training data.

In a step 2240, a single embedding vector is learned for each codeword cluster. The embedding vector represents the shared semantic representation of the codewords within a cluster. By learning embeddings at the cluster level, the LCM can capture the high-level semantic concepts and relationships among the codewords. The embedding vectors are typically learned using techniques like word2vec, GloVe, or other embedding learning algorithms. These algorithms leverage the co-occurrence patterns and semantic similarities of the codewords within the clusters to learn dense, continuous vector representations.

In a step 2250, the learned embedding vectors for the codeword clusters are then processed through the machine learning core of the LCM. The machine learning core can be implemented using various architectures, such as a Transformer-based core, a Variational Autoencoder (VAE)-based core, or a combination of different models. The machine learning core takes the embedding vectors as input and learns to map them to the desired output. It captures the patterns, relationships, and semantics encoded in the embedding vectors to generate meaningful and coherent outputs. The machine learning core generates an output based on the processed embedding vectors. The output can be in the form of codewords, which are then mapped back to the corresponding sourceblocks or tokens using the codebook. Alternatively, the output can be directly generated in the target modality, such as text, images, or any other desired format, depending on the specific application.

The method described provides a framework for using an LCM with codeword clustering and learned embedding vectors. By clustering semantically similar or co-occurring codewords together and learning a single embedding vector for each cluster, the LCM can capture high-level semantic concepts and relationships among the codewords. This approach reduces the dimensionality of the embedding space and allows for more efficient processing and storage of the learned representations. Codeword clustering and embedding learning offer several advantages. It enables the LCM to capture semantic similarities and relationships among codewords, leading to more meaningful and coherent outputs. By learning embeddings at the cluster level, the LCM can generalize better to unseen or rare codewords, as they can be associated with the nearest cluster embedding. Additionally, the reduced dimensionality of the embedding space can lead to faster training and inference times, as well as lower memory requirements.

The specific implementation details, such as the choice of clustering algorithm, embedding learning technique, and machine learning core architecture, can be adapted based on the characteristics of the data and the desired output. The modular nature of the LCM architecture allows for flexibility in incorporating different clustering and embedding learning approaches. By leveraging codeword clustering and learned embedding vectors, the LCM can capture semantic relationships and generate more meaningful and coherent outputs. This approach has potential applications in various domains, such as natural language processing, information retrieval, and content generation, among others. It can lead to improved performance, generalization, and efficiency in processing and generating data using LCMs.

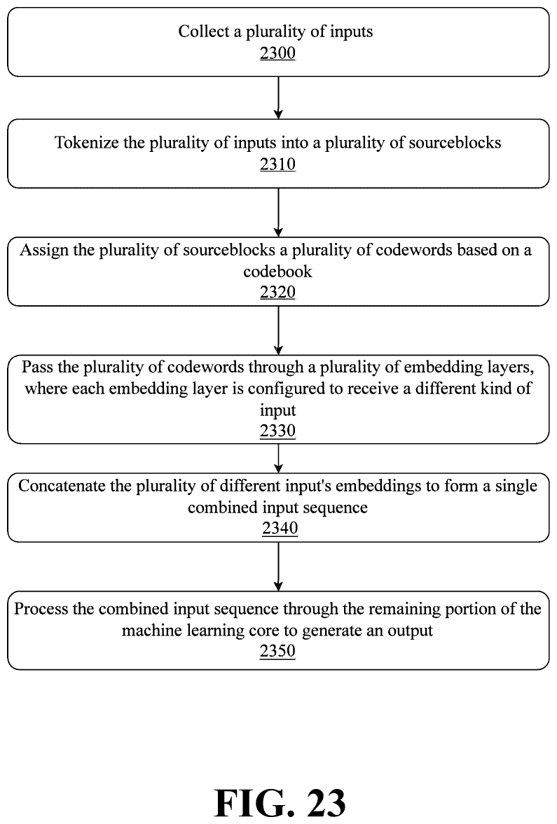

FIG. 23 is a flow diagram illustrating an exemplary method for a large codeword model for deep learning using a dual embedding layer. In a first step 2300, collect a plurality of inputs. These inputs can be from various sources and modalities, such as text, images, audio, time series, or any other structured or unstructured data. The inputs represent the data that needs to be processed by the LCM.

In a step 2310, the collected inputs are tokenized into a plurality of sourceblocks. Tokenization is performed by the tokenizer component of the LCM architecture, which splits the input data into meaningful semantic units called sourceblocks. The tokenizer employs techniques specific to each input modality to capture the relevant patterns and structures. For textual data, this may involve using subword tokenization methods like Byte-Pair Encoding (BPE) or WordPiece. For other modalities, such as images or audio, the tokenizer may use domain-specific techniques to extract relevant features or segments.

In a step 2320, each sourceblock is assigned a codeword based on a codebook. The codebook is a dictionary that maps sourceblocks to their corresponding codewords. Codewords are discrete, compressed representations of the sourceblocks, designed to capture the essential information in a compact form. The codeword assignment can be based on various techniques, such as frequency-based coding, hash functions, or learned mappings.

In a step 2330, the assigned codewords are then passed through a plurality of embedding layers. Unlike traditional transformer architectures that use a single embedding layer, this modified LCM architecture employs multiple embedding layers, each configured to receive a different kind of input. Each embedding layer learns a dense vector representation specific to its corresponding input modality. For example, there can be separate embedding layers for text, images, audio, and other input types. The embedding layers capture the semantic and structural information of the input codewords in a continuous vector space.

In a step 2340, the embeddings from the different input modalities are then concatenated to form a single combined input sequence. This concatenation process brings together the learned representations from each embedding layer, creating a unified representation that captures the information from all input modalities. The combined input sequence represents a multi-modal representation of the input data.

In a step 2350, the combined input sequence is then processed through the remaining portion of the machine learning core. This remaining portion can include various components, such as self-attention mechanisms, feedforward layers, and output layers, depending on the specific architecture of the LCM. The machine learning core learns to map the combined input sequence to the desired output, capturing the relationships and interactions between the different input modalities.

In a step 2350, the machine learning core generates an output based on the processed combined input sequence. The output can be in the form of codewords, which are then mapped back to the corresponding sourceblocks or tokens using the codebook. Alternatively, the output can be directly generated in the target modality, such as text, images, or any other desired format, depending on the specific application.

The method provides a framework for using a modified LCM architecture with multiple embedding layers to handle diverse input modalities. By employing separate embedding layers for each input type, the LCM can learn specialized representations that capture the unique characteristics and patterns of each modality. The concatenation of these embeddings allows for a unified processing of the multi-modal input, enabling the LCM to learn and generate outputs that leverage the combined information from all input sources.

The specific implementation details of the embedding layers and the remaining portion of the machine learning core can be adapted based on the requirements of the application and the characteristics of the input data. The modular nature of this modified LCM architecture allows for customization and extension to incorporate additional input modalities or processing components as needed.

By leveraging the power of multiple embedding layers and the combined processing of multi-modal inputs, this modified LCM architecture opens up new possibilities for building deep learning models that can handle diverse data types and generate rich, multi-modal outputs. It has potential applications in various domains, such as multimedia content generation, cross-modal retrieval, and multi-modal reasoning, among others.

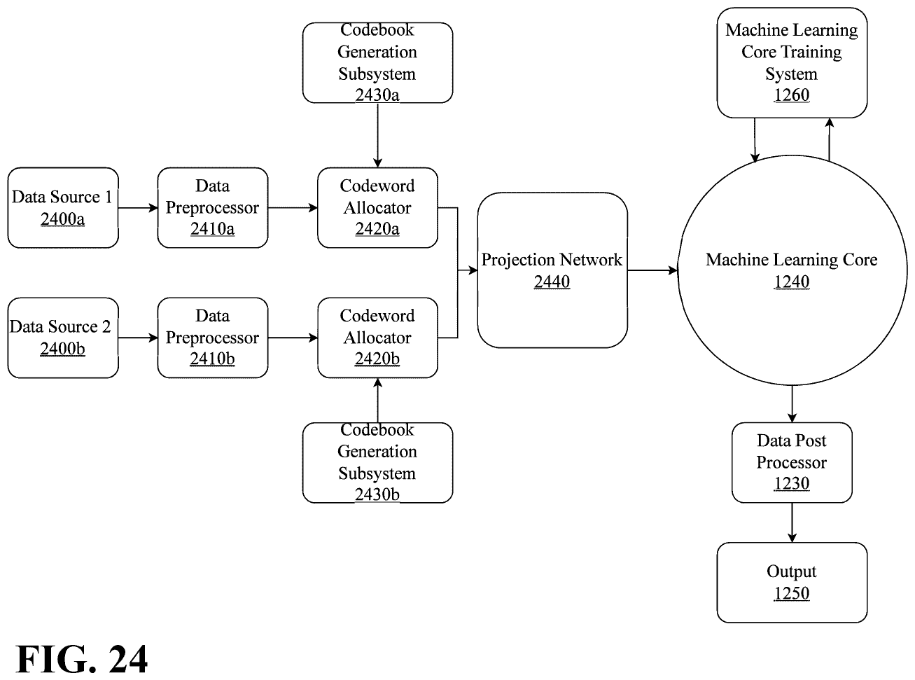

FIG. 24 is a block diagram illustrating an exemplary system architecture for a compound large codeword model. The system begins with a plurality of data sources. In the illustrated example, data source 1 2400a and data source 2 2400b, may represent different types of financial information. Each data source feeds into its own data preprocessor (2410a and 2410b respectively), where the raw data is cleaned, normalized, and prepared for further processing. This preprocessing stage important for handling the diverse nature of financial data, ensuring that both textual news data and numerical trading data are appropriately formatted for the subsequent stages.

Following preprocessing, the data from each source is passed through separate codebook generation subsystems (2430a and 2430b). These subsystems are responsible for creating and maintaining codebooks that map the preprocessed data to unique codewords. The codebook generation process may be adaptive, where codebooks are continuously updating to reflect changing market conditions and emerging patterns in the financial data. This adaptive nature allows the system to remain responsive to new trends and shifts in the market, ensuring that the codewords used are always relevant and informative.

The preprocessed data, along with the generated codebooks, is then fed into codeword allocators (2420a and 2420b). These allocators assign appropriate codewords to the incoming data based on the current codebooks. This effectively compresses the complex financial information into discrete, efficient representations that capture the essential characteristics of the data.

A key component of this compound LCM is a projection network 2440, which serves as a fusion mechanism for the different types of codewords. Projection network 2440 is designed to process and combine codewords from both textual and numerical data, creating a unified representation that captures the interrelationships between these different data types. Projection network 2440 allows the system to leverage both the sentiment and factual information from news alongside the quantitative data from trading, providing a more comprehensive view of the financial landscape.

The fused data from the projection network is then processed by machine learning core 1240. It's important to note that this core can be implemented as a latent transformer core, as described in FIG. 1C. The latent transformer architecture is particularly well-suited for this task as it can efficiently handle the compressed codeword representations without the need for embedding or positional encoding layers. Machine learning core 1240 is responsible for learning complex patterns and relationships within the fused data, enabling the system to make accurate predictions and insights about future market behavior.

The system also includes a machine learning core training system 1260, which continuously optimizes the performance of machine learning core 1240. Machine learning core training system 1260 allows the model to adapt to changing market dynamics and improve its predictive capabilities over time. It may employ techniques such as multi-horizon prediction to forecast prices over various time frames simultaneously.

After processing by the machine learning core, the data passes through a data post processor 1230. This component is responsible for interpreting the output of the machine learning core, potentially incorporating uncertainty quantification to provide confidence intervals for predictions. It may also implement explainable AI features to provide insights into the model's decision-making process.

The system produces an output 1250, which could include short-term price predictions for relevant securities, along with associated confidence levels. This output is designed to be actionable for financial decision-makers, providing them with comprehensive, data-driven insights that combine information from both news and trading data sources. Financial information is just one example of the kind of data a compound large codeword model can synthesize into accurate, real-time time series predictions. Through the use of projection network 2440, various data types can be synthesized together allowing machine learning core 1240 to make more accurate insights.

Throughout the entire process, the system maintains the ability to handle cross-asset interactions, capturing relationships between different securities or asset classes. It also employs dynamic feature importance, adjusting the weighting of news versus trading data based on current market conditions. This compound LCM system represents a sophisticated approach to financial data analysis, capable of processing diverse data types and producing nuanced, context-aware predictions in real-time.

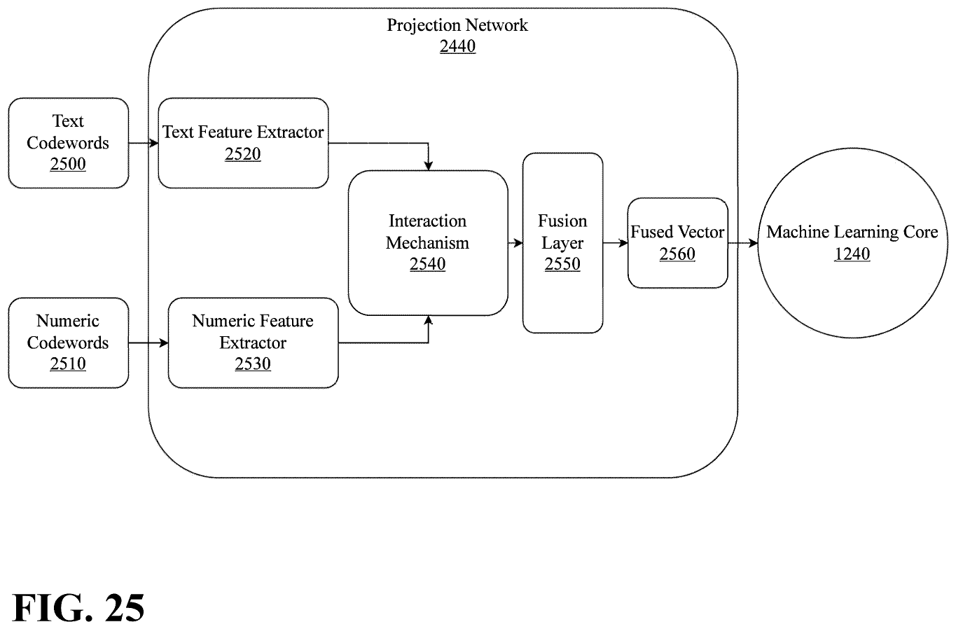

FIG. 25 is a block diagram illustrating an exemplary component of a system for real-time time series forecasting using a compound large codeword model, a projection network. Projection network 2440 serves as the bridge between the codeword allocators and machine learning core 1240, which may be implemented as a latent transformer core as described in FIG. 1C. Projection network 2440 is specifically designed to handle and fuse multiple different types of data inputs, for example, text inputs and numeric inputs.

Text codewords 2500 enter the network and are first processed by a text feature extractor 2520. Text feature extractor 2520 may be tailored to extract relevant features from the compressed representations of textual data, capturing semantic and sentiment information from the data source. Concurrently, numeric codewords 2510 are fed into a numeric feature extractor 2530, which is optimized to identify patterns and trends from numerical data sources. These feature extractors operate directly on the codeword representations, maintaining the efficiency and compactness of the LCM approach without reverting to deep embeddings.

An interaction mechanism 2540 allows for direct interplay between the text and numeric features. This mechanism enables the system to capture complex relationships between text and numeric data, a crucial capability in areas such as, but not limited to financial forecasting. For instance, interaction mechanism 2540 may learn how specific types of news events correlate with particular trading patterns across various assets or sectors.

The outputs from both feature extractors and the interaction mechanism are then combined in the fusion layer 2550. Fusion layer 2550 is responsible for synthesizing all the extracted information into a unified representation. The fusion process is adaptive, potentially giving different weights to news and trading data based on current market conditions or the specific prediction task at hand. The result of this multi-step process is a fused vector 2560, which serves as the input to machine learning core 1240. This fused vector 2560 is a rich, compact representation that encapsulates both the textual and numerical aspects of the various input data types, along with their interactions. By providing this comprehensive input to the machine learning core 1240, the projection network enables the system to make nuanced, context-aware predictions.

The utilization of projection network 2440 offers a variety of enhanced real world applications. For example, projection network 2440 effectively handles the synchronization of news snippets and trading data, ensuring that relevant information from both sources is correctly aligned and integrated. The network's ability to process both text and numeric codewords simultaneously allows for efficient multi-modal learning, capturing the full spectrum of available financial information. Additionally, projection network's 2440 architecture supports the system's ability to predict future prices for all securities included in the training dataset within a short-term time window. During inference, as new financial news and trading data feed into the system, they are processed through this projection network, allowing the trained latent transformer model to generate near-term price action predictions for all relevant securities.

In another example, interaction mechanism 2540 could be extended to incorporate attention visualization, providing insights into which news snippets and trading data points are most influential for each prediction. The fusion layer could be designed to support multi-horizon prediction, enabling the system to forecast prices over multiple time frames simultaneously.

By serving as an intelligent intermediary between the raw codeword inputs and the sophisticated machine learning core, projection network 2440 plays a role in the compound LCM's ability to process and analyze complex financial data. It enables the system to leverage the strengths of both textual and numerical data, creating a unified representation that captures the intricate dynamics of financial markets. This approach positions the compound LCM as a powerful tool for real-time financial analysis and prediction, capable of adapting to the ever-changing landscape of global markets.

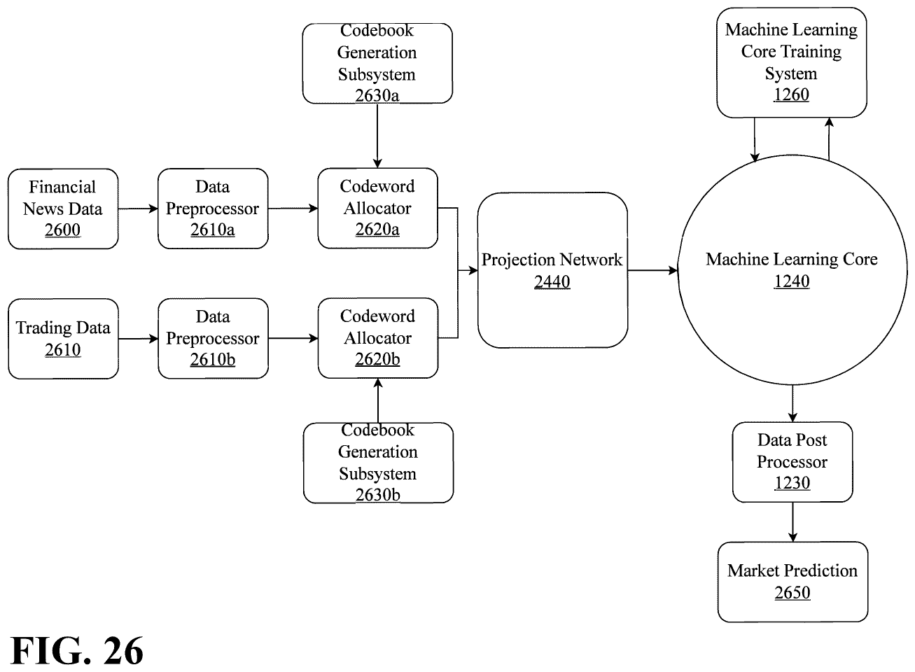

FIG. 26 is a block diagram illustrating an exemplary system architecture for a compound large codeword model that processes financial data. The system may ingest a plurality of various data types, including but not limited to financial news data 2600 and trading data 2610, representing the dual nature of information that influences financial markets.

Financial news data 2600 encompasses a wide range of textual information, including real-time news snippets, financial reports, and social media sentiment related to markets and specific securities. This data first passes through data preprocessor 2610a which cleanses the text, performs sentiment analysis, and extracts key financial entities and events. Simultaneously, the trading data 2610, which includes time series of price movements, volume information, and other quantitative market indicators, is processed through its own data preprocessor 2610b. This preprocessing stage normalizes the numerical data, handles missing values, and potentially creates derived features such as moving averages or volatility measures.

Both preprocessed data streams then flow into their respective codebook generation subsystems (2630a and 2630b). For the news data 2600, the codebook might encode common financial phrases, sentiment indicators, or event types. The trading data codebook could represent different market patterns, trend indicators, or volatility regimes. These codebooks may be continuously updated to reflect emerging market trends, new financial products, or shifts in trading behavior.

Codeword allocators (2620a and 2620b) then assign appropriate codewords to the incoming preprocessed data. This step effectively compresses the complex financial information into discrete, efficient representations. For instance, a series of positive news articles about a company's earnings might be encoded into a single codeword representing “strong positive earnings sentiment,” while a particular pattern in a stock's price movement could be encoded as “bullish breakout pattern.”

Projection network 2440 serves as a fusion mechanism, combining the codewords from both news and trading data. This network is designed to capture the intricate relationships between market sentiment derived from news and actual market behaviors observed in trading data. For example, it might learn how certain types of news events typically precede specific market movements, or how the impact of news varies depending on the current market regime.

The fused data from the projection network is then processed by machine learning core 1240, which can be implemented as a latent transformer core. This core is specially trained to identify complex patterns in financial data and make predictions about future market behavior. It might recognize, for instance, how a combination of positive sentiment in news, increased trading volume, and a particular price pattern often precedes a market rally. Machine learning core training system 1260 continuously optimizes the core's performance using historical market data and the outcomes of past predictions. This allows the system to adapt to changing market dynamics, such as shifts in the relationships between news sentiment and price movements during different economic cycles.

After processing by the machine learning core, the data passes through a data post processor 1230. In the context of financial predictions, this component might apply risk adjustments, incorporate market-specific constraints (such as trading hours or circuit breakers), or align the predictions with specific trading strategies. The system produces market predictions 2650. These could include short-term price forecasts for individual securities, predictions of market-wide movements, or alerts for potential significant events. The predictions might also include confidence intervals, providing traders or investors with a sense of the forecast's reliability.

Throughout this process, the system leverages its ability to handle cross-asset interactions, capturing how events in one market sector might influence others. For instance, it could recognize how currency fluctuations might impact export-oriented stocks, or how commodity price changes could affect related industries.

The compound LCM's architecture allows it to process vast amounts of financial data in real-time, continuously updating its predictions as new information becomes available. This makes it particularly suited for high-frequency trading environments or for providing real-time market insights to financial analysts. The system's use of codewords and the latent transformer architecture enables it to efficiently handle the high dimensionality and complexity of financial data. It can capture subtle patterns and relationships that might be overlooked by traditional analysis methods, potentially identifying novel predictive signals in the market. By fusing textual and numerical financial data in this sophisticated manner, the compound LCM system aims to provide a more comprehensive and nuanced view of market dynamics, enabling more accurate and timely market predictions. This approach positions the system as a powerful tool for financial decision-making in the fast-paced and complex world of modern financial markets.

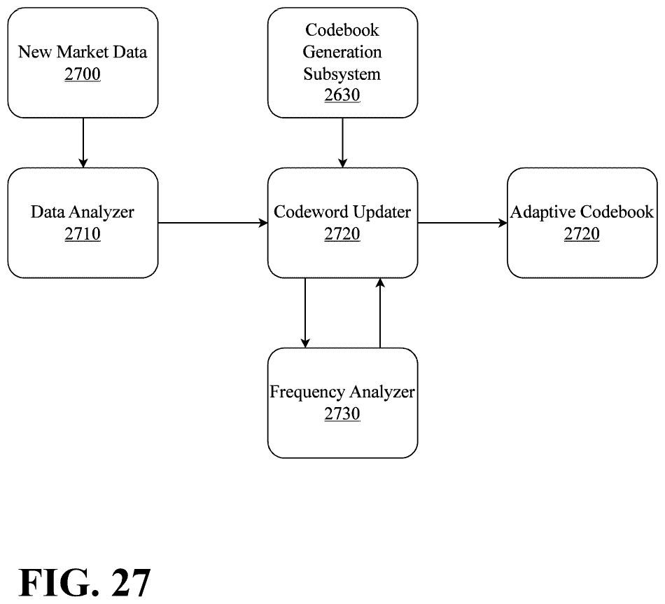

FIG. 27 is a block diagram illustrating an exemplary system architecture for a compound large codeword model with adaptive codeword generation. In one embodiment, an adaptive codebook generation system improves the model's ability to maintain relevance and accuracy in the fast-paced and ever-evolving financial markets. The system receives new market data 2700, which could encompass a wide range of financial information including real-time trading data, breaking news, economic indicators, and social media sentiment related to financial markets. This continuous stream of data is essential for keeping the model attuned to the latest market trends and events.

The new market data is first processed by the data analyzer 2710. This component is responsible for identifying significant changes or emerging patterns in the incoming data. For financial markets, this could involve detecting new trading patterns, recognizing shifts in market sentiment, or identifying the emergence of new financial instruments or market sectors. The data analyzer employs sophisticated algorithms to distinguish between noise and meaningful market signals, ensuring that only relevant information influences the codebook. Concurrently, a frequency analyzer 2730 monitors the usage patterns of existing codewords within the system. In the context of financial data, this component tracks how often certain market patterns, news topics, or trading signals are being represented by the current set of codewords. This analysis is crucial for identifying which codewords are most relevant to current market conditions and which may have become obsolete.

The outputs from both the data analyzer and the frequency analyzer feed into the codeword updater 2720. This is where the adaptive nature of the system truly comes into play. The codeword updater performs a plurality of functions. It generates new codewords to represent emerging market patterns or financial events that are not adequately captured by the existing codebook. For instance, if a new type of cryptocurrency gains prominence, or if a novel trading strategy becomes popular, new codewords would be created to represent these phenomena.

Codeword updater 2720 modifies existing codewords to better reflect evolving market dynamics. This could involve adjusting the parameters of a codeword representing a particular market trend to account for changes in its typical duration or intensity. Additionally, the codeword updated 2720 prunes outdated or rarely used codewords from the codebook. In rapidly changing financial markets, certain patterns or indicators may lose their relevance over time. Removing these obsolete codewords helps maintain the efficiency and relevance of the codebook.

The result of this process is an adaptive codebook 2720 that evolves in real-time to reflect the current state of financial markets. This adaptive codebook 2720 is then used by the broader compound LCM system to encode incoming financial data, ensuring that the machine learning core always works with the most up-to-date and relevant representations of market conditions.

The adaptive nature of this codebook generation subsystem is particularly valuable in financial contexts where new factors can quickly become significant market drivers. For example, during a financial crisis, the system could rapidly develop new codewords to represent emergency policy measures or unusual market behaviors. Similarly, it could quickly adapt to represent the market impact of global events, emerging technologies, or shifts in investor behavior. By continuously updating the codebook based on new market data, this subsystem enables the compound LCM to maintain high predictive accuracy even as market conditions change. It allows the model to capture nuanced and evolving relationships between various financial indicators and market outcomes, potentially identifying predictive signals that might be missed by more static analysis methods.

Moreover, adaptive codebook 2720 serves as a form of dimensionality reduction, compressing the vast and complex world of financial data into a more manageable set of codewords. This not only makes the subsequent machine learning processes more efficient but also potentially more interpretable, as each codeword represents a meaningful financial concept or pattern. In the context of the broader compound LCM system, this adaptive codebook generation subsystem ensures that the model remains responsive to the dynamic nature of financial markets. It enables the system to continuously refine its understanding of market dynamics, potentially leading to more accurate and timely financial predictions. This adaptive capability is crucial for any system aiming to provide reliable insights in the complex and rapidly changing landscape of global financial markets.

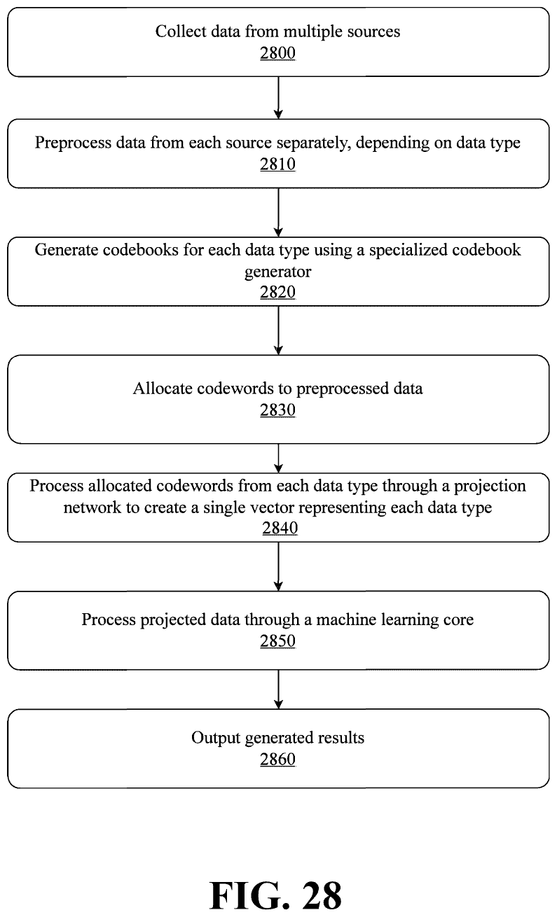

FIG. 28 is a flow diagram illustrating an exemplary method for a compound large codeword model. In a first step 2800, the system collects data from multiple sources. This step is crucial for gathering a diverse range of financial information, including real-time financial news snippets and trading data. The inclusion of both textual and numerical data allows the system to capture a holistic view of the market, considering both sentiment-driven factors and quantitative market indicators.

In a step 2810, the collected data is preprocessed separately for each source, depending on the data type. This step involves cleaning, normalizing, and formatting the data to ensure it's suitable for further processing. For financial news data, this might include natural language processing techniques to extract key information and sentiment. For trading data, it could involve normalizing price data, calculating technical indicators, or handling missing values. In a step 2820, the system generates codebooks for each data type using a specialized codebook generator. This step is critical for creating efficient, compressed representations of the financial data. The codebook generator is adaptive, continuously updating to reflect changing market conditions and emerging patterns. This ensures that the codewords used are always relevant and informative, capturing the latest trends in both news sentiment and market behavior.

In a step 2830, codewords are allocated to the preprocessed data. This step effectively compresses the complex financial information into discrete, efficient representations. For instance, a series of positive news articles about a company's earnings might be encoded into a single codeword, while a particular pattern in a stock's price movement could be encoded as another codeword.

In a step 2840, the allocated codewords from each data type are processed through a projection network to create a single vector representing each data type. The projection network allows for the integration of textual data (from news) and numerical data (from trading), creating a unified representation that captures the interrelationships between these different data types.

In a step 2850, the projected data is processed through a machine learning core. This core can be implemented as a latent transformer, as mentioned in FIG. 1C. The latent transformer architecture is particularly well-suited for this task as it can efficiently handle the compressed codeword representations without the need for embedding or positional encoding layers. This step involves learning complex patterns and relationships within the fused data, enabling the system to make accurate predictions about future market behavior.

In a step 2860, the system outputs the generated results. These results could include short-term price predictions for relevant securities, along with associated confidence levels. The output is designed to be actionable for financial decision-makers, providing comprehensive, data-driven insights that combine information from both news and trading data sources. This method enables the compound LCM system to process vast amounts of diverse financial data in real-time, continuously updating its predictions as new information becomes available. By fusing textual and numerical financial data in this sophisticated manner, the system aims to provide a more comprehensive and nuanced view of market dynamics, enabling more accurate and timely market predictions.

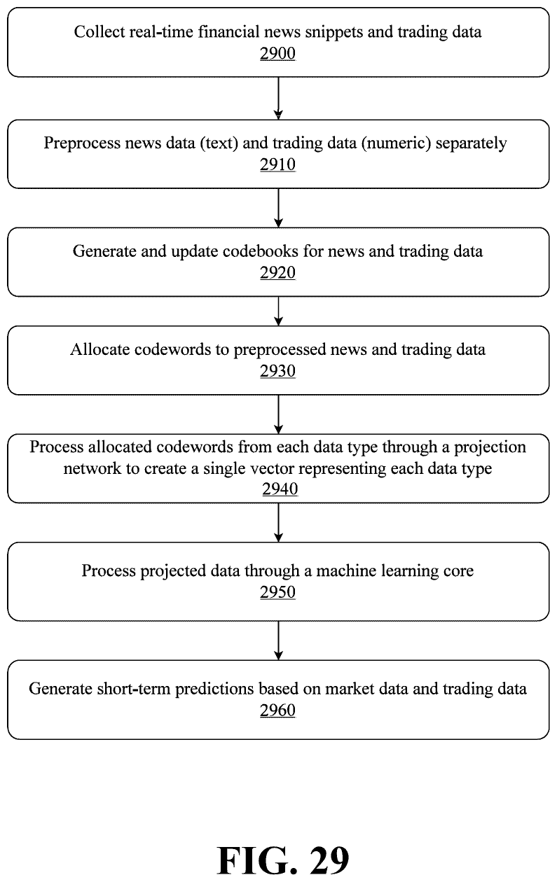

FIG. 29 is a flow diagram illustrating an exemplary method for a compound large codeword model that processes financial data. In a first step 2900, the system collects real-time financial news snippets and trading data. This step is crucial for capturing the dual nature of information that influences financial markets. The financial news snippets provide qualitative, sentiment-driven data that can affect market behavior, while the trading data offers quantitative insights into actual market movements. By collecting both types of data in real-time, the system ensures it has the most up-to-date information for making predictions.

In a step 2910, the system preprocesses the news data (text) and trading data (numeric) separately. For the news data, preprocessing might involve natural language processing techniques such as tokenization, sentiment analysis, and entity recognition to extract key financial information from the text. For the trading data, preprocessing could include normalization of price data, calculation of technical indicators, and handling of any missing values or outliers.

In a step 2920, the system generates and updates codebooks for both the news and trading data. The codebooks may be continuously updated to reflect emerging market trends, new financial products, or shifts in trading behavior. For news data, the codebook might encode common financial phrases, sentiment indicators, or event types. For trading data, it could represent different market patterns, trend indicators, or volatility regimes.

In a step 2930, codewords are allocated to the preprocessed news and trading data. This step effectively compresses the complex financial information into discrete, efficient representations. For instance, a series of positive news articles about a company's earnings might be encoded into a single codeword representing “strong positive earnings sentiment,” while a particular pattern in a stock's price movement could be encoded as “bullish breakout pattern.”

In a step 2940, the allocated codewords from each data type are processed through a projection network to create a single vector representing each data type. The projection network allows for the integration of news sentiment and trading patterns, creating a unified representation that captures the interrelationships between these different data types. This fusion enables the system to understand how news events might correlate with or influence trading patterns.

In a step 2950, the projected data is processed through a machine learning core. This core, which can be implemented as a latent transformer as described in FIG. 1C, is specially trained to identify complex patterns in financial data. It leverages the fused representations to recognize intricate relationships between news sentiment, trading patterns, and market outcomes. The latent transformer architecture is particularly effective at processing these compressed codeword representations efficiently.

In a step 2960, the system generates short-term predictions based on the processed market and trading data. These predictions could include price forecasts for individual securities, predictions of market-wide movements, or alerts for potential significant events. The predictions are designed to be actionable for traders or investors, potentially including confidence intervals to provide a sense of the forecast's reliability. This method enables the compound LCM system to process vast amounts of diverse financial data in real-time, continuously updating its predictions as new information becomes available. By fusing textual news data with numerical trading data in this sophisticated manner, the system aims to provide a more comprehensive and nuanced view of market dynamics. This approach positions the system as a powerful tool for making accurate and timely short-term market predictions, capable of capturing subtle patterns and relationships that might be overlooked by traditional analysis methods.

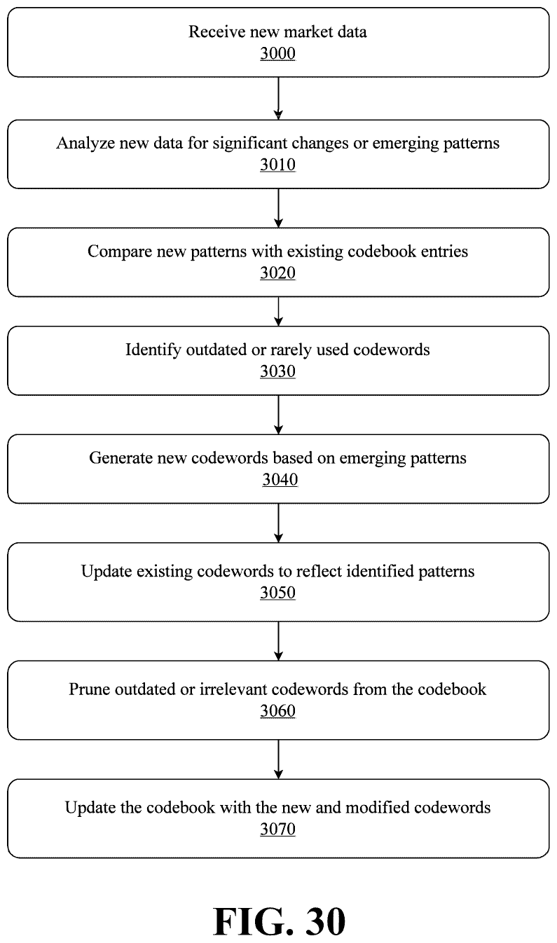

FIG. 30 is a flow diagram illustrating an exemplary method for a compound large codeword model with adaptive codeword generation. In a first step 3000, the system receives new market data. This step is the entry point for the adaptive process, where fresh financial information flows into the system. This data could include real-time trading information, breaking news, economic indicators, or social media sentiment related to financial markets. The continuous influx of new data is essential for keeping the model attuned to the latest market trends and events.

In a step 3010, the system analyzes the new data for significant changes or emerging patterns. This step involves sophisticated data analysis techniques to distinguish between noise and meaningful market signals. For financial markets, this could mean detecting new trading patterns, recognizing shifts in market sentiment, or identifying the emergence of new financial instruments or market sectors. This analysis is crucial for determining which aspects of the new data warrant updates to the codebook.

In a step 3020, the system compares the newly identified patterns with existing codebook entries. This comparison helps determine whether the new patterns are truly novel or if they can be adequately represented by existing codewords. This step is essential for maintaining the efficiency of the codebook by avoiding redundant entries while ensuring comprehensive coverage of market phenomena.

In a step 3030, the system identifies outdated or rarely used codewords. This step involves analyzing the frequency and recency of codeword usage within the system. In the context of financial data, this could mean identifying codewords that represent market patterns or events that are no longer relevant or frequent in current market conditions. This process is crucial for maintaining the codebook's efficiency and relevance.

In a step 3040, the system generates new codewords based on emerging patterns. When the analysis identifies truly novel patterns or significant market events that cannot be adequately represented by existing codewords, this step creates new entries in the codebook. For instance, if a new type of financial instrument gains prominence or if a novel trading strategy becomes popular, new codewords would be created to represent these phenomena.

In a step 3050, the system updates existing codewords to reflect identified patterns. This step modifies the parameters or definitions of existing codewords to better capture evolving market dynamics. For example, a codeword representing a particular market trend might be adjusted to account for changes in its typical duration or intensity. This ensures that existing codewords remain accurate and relevant.

In a step 3060, the system prunes outdated or irrelevant codewords from the codebook. This step removes codewords that have been identified as no longer relevant or useful. Pruning helps maintain the efficiency of the codebook and prevents the system from being influenced by outdated market patterns or events.

In a step 3070, the system updates the codebook with the new and modified codewords. This final step consolidates all the changes made in the previous steps, resulting in an updated codebook that reflects the current state of the financial markets. This updated codebook is then used by the broader compound LCM system to encode incoming financial data, ensuring that the machine learning core always works with the most up-to-date and relevant representations of market conditions.

This adaptive codebook generation method is particularly valuable in financial contexts where new factors can quickly become significant market drivers. It allows the compound LCM system to rapidly adapt to represent the market impact of global events, emerging technologies, or shifts in investor behavior. By continuously updating the codebook based on new market data, this method enables the system to maintain high predictive accuracy even as market conditions change. It captures nuanced and evolving relationships between various financial indicators and market outcomes, potentially identifying predictive signals that might be missed by more static analysis methods. This adaptive capability is crucial for any system aiming to provide reliable insights in the complex and rapidly changing landscape of global financial markets.

### Deep Learning for Time Series Prediction System Architecture

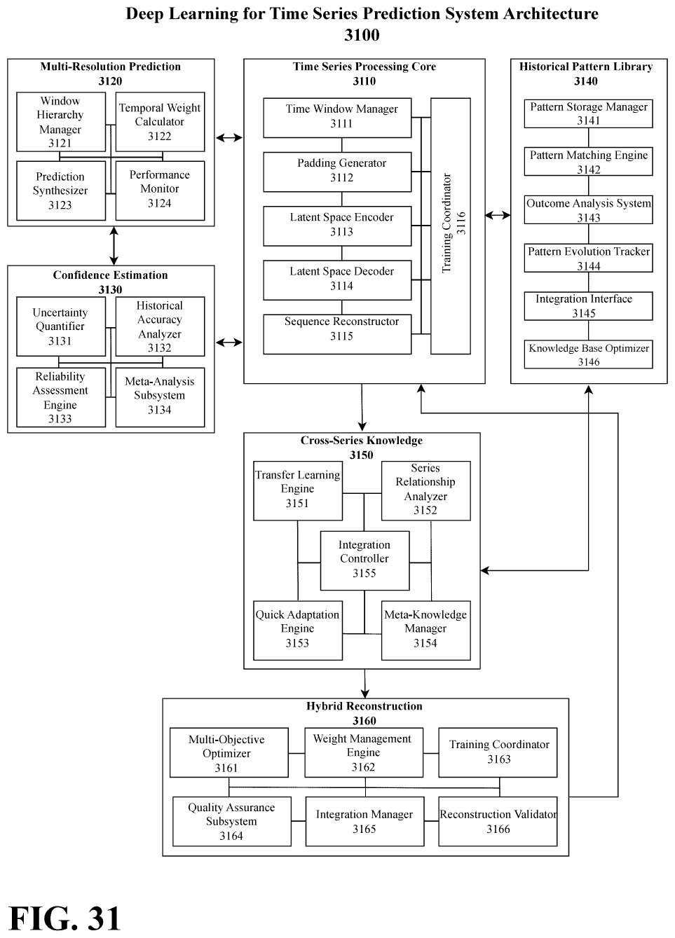

FIG. 31 is a block diagram illustrating exemplary architecture of deep learning for time series prediction system 3100. System 3100 includes multiple interconnected subsystems functioning together to perform time series prediction through deep learning techniques.

System 3100 described herein comprises multiple subsystems that can be selectively implemented based on specific application requirements and computational constraints. While the time series processing core 3110 provides essential predictive autoencoder functionality, other subsystems such as multi-resolution prediction 3120, confidence estimation 3130, historical pattern library 3140, cross-series knowledge 3150, and hybrid reconstruction 3160 provide optional enhancements that can be included or omitted as needed. Each optional subsystem interfaces with the core through well-defined integration managers, allowing for modular deployment. For example, applications requiring only single-horizon predictions may omit the multi-resolution prediction subsystem, while those needing maximum accuracy might implement all subsystems. This modular architecture enables system configurations to be optimized for different trade-offs between functionality, computational resources, and complexity

Time series processing core subsystem 3110 serves as central coordinator, handling input sequences and managing core prediction operations. Multi-resolution prediction subsystem 3120 connects to time series processing core 3110, generating predictions at various time horizons through nested window processing. Confidence estimation subsystem 3130 interfaces with multi-resolution prediction subsystem 3120, providing uncertainty quantification and reliability assessment for predictions. Historical pattern library subsystem 3140 maintains records of latent space patterns and connects to time series processing core 3110, enabling pattern matching against current sequences. Cross-series knowledge subsystem 3150 interfaces with historical pattern library 3140, facilitating transfer learning and relationship analysis between different time series. Hybrid reconstruction subsystem 3160 connects to time series processing core 3110 and manages multiple reconstruction objectives while preserving statistical properties and trends.

Data flows from time series processing core 3110 to each specialized subsystem through bidirectional connections. Time series processing core 3110 receives input sequences, performs truncation and padding operations, and coordinates processing across other subsystems. Multi-resolution prediction subsystem 3120 processes data at multiple time horizons, with results feeding into confidence estimation subsystem 3130 for uncertainty analysis. Historical pattern library subsystem 3140 stores and matches patterns in latent space, sharing relevant historical information with cross-series knowledge subsystem 3150. Cross-series knowledge subsystem 3150 enables transfer learning between related time series, feeding insights back to time series processing core 3110. Hybrid reconstruction subsystem 3160 ensures quality reconstruction by balancing multiple objectives and providing feedback to time series processing core 3110.

Integration managers within each subsystem coordinate resource allocation and state synchronization. Feedback paths connect subsystems in hierarchical arrangement, with time series processing core 3110 maintaining primary system state while other subsystems maintain local states. Error handling procedures flow through integration managers, with local errors handled within subsystems and system-wide errors triggering coordinated recovery procedures starting from time series processing core 3110. Through this architecture, system 3100 processes time series data efficiently while maintaining prediction quality and reliability across multiple time horizons.

Time series processing core subsystem 3110 serves as central coordinator for time series prediction operations, interfacing with multi-resolution prediction subsystem 3120, confidence estimation subsystem 3130, historical pattern library subsystem 3140, cross-series knowledge subsystem 3150, and hybrid reconstruction subsystem 3160. Time window manager subsystem 3111 buffers input sequences, processes truncation, adapts windows dynamically, validates quality, analyzes temporal patterns, and maintains cross-batch consistency. Padding generator subsystem 3112 analyzes statistical properties, calculates context-aware values, generates pattern-based padding, scores relevance through attention mechanisms, optimizes padding strategies, and assesses quality. Latent space encoder subsystem 3113 implements compression operations, extracts foundational patterns, manages feature mapping, optimizes dimensional reduction, and validates encoding quality. Latent space decoder subsystem 3114 performs decompression operations, reconstructs patterns, interprets feature mappings, optimizes dimensional expansion, and monitors decoding quality. Sequence reconstructor subsystem 3115 predicts terminal values, validates output sequences, verifies pattern consistency, and calculates performance metrics. Training coordinator subsystem 3116 manages loss functions, controls optimization, tracks performance, synchronizes encoder-decoder operations, and adapts models.

Input processing flow in subsystem 3110 handles continuous data ingestion through configurable buffers, processes variable rates, performs initial validation, and assesses quality. Window processing through subsystem 3111 verifies sequence lengths, executes truncation at specified ratios, adapts window sizes, and maintains cross-batch consistency. Adaptive padding flow through subsystem 3112 analyzes statistical characteristics including property extraction, pattern identification, seasonality detection, and trend analysis. Context-aware padding computation incorporates historical pattern analysis, temporal correlation assessment, statistical property preservation, and context vector generation. Padding strategies undergo evaluation, value generation, pattern-based adjustment, and quality verification. Attention-based optimization in subsystem 3112 includes relevance scoring, weight calculation, context integration, and refinement.

Encoding operations through subsystem 3113 perform dimension analysis, feature extraction, pattern recognition, and temporal relationship analysis, with continuous encoding quality monitoring. Decoding operations through subsystem 3114 manage latent space navigation, pattern reconstruction, and feature mapping interpretation, maintaining optimal dimensional expansion. Sequence reconstruction through subsystem 3115 processes decoded representations, validates pattern consistency, generates terminal value predictions, and ensures reconstruction quality. Training coordination through subsystem 3116 optimizes the encoder-decoder architecture through synchronized loss functions, balanced optimization strategies, and adaptive model refinement. Input requirements for subsystem 3110 specify numeric arrays with configurable lengths, variable sampling rates, missing value handling, distribution parameters, seasonality indicators, trend components, and volatility measures. Internal processing utilizes latent vectors, window configurations, feature mappings, and padding contexts containing statistical summaries, pattern indicators, temporal relationships, and context weights.

The predictive sequence reconstruction process operates by coordinating the actions of all subsystems. The time window manager 3111 first processes an input sequence of a predetermined length (such as 1000 points), truncating a specified number of terminal values (such as 50 points). The padding generator 3112 then appends padding values (such as zeros) to restore the sequence to its original length. This padded sequence is processed by the latent space encoder 3113 to create a compressed representation in latent space. The latent space decoder 3114 learns to reconstruct complete sequences during training, focusing particularly on accurately reproducing the terminal values that were truncated from the input. During inference, when the decoder receives a latently encoded sequence containing padding values, it generates predictions for those positions based on learned patterns. The sequence reconstructor 3115 validates and refines these predictions, while the training coordinator 3116 optimizes the entire process by minimizing the difference between predicted and actual values in the truncated regions during training. This architecture enables the system to learn temporal patterns and dependencies that extend from the known sequence into the prediction horizon.

Data flow through time series processing core 3110 follows both forward and feedback paths. In the forward path, raw time series data enters time window manager 3111 as floating-point arrays, where it is validated and organized into processing windows. Each window is annotated with metadata including quality metrics and temporal indicators before passing to padding generator 3112. Padding generator 3112 augments the truncated sequences with computed padding values, maintaining the original data format while adding padding quality indicators. The padded sequences are then transformed by latent space encoder 3113 into compressed vector representations, with each vector accompanied by encoding confidence metrics. Latent space decoder 3114 processes these vectors to generate preliminary reconstructions, which sequence reconstructor 3115 refines into final predictions. Concurrently, multiple feedback paths operate; reconstruction quality metrics flow from sequence reconstructor 3115 back to padding generator 3112 to optimize padding strategies. Encoding quality metrics from latent space encoder 3113 inform time window manager 3111 for window adaptation; and training coordinator 3116 propagates loss gradients through all components during training. The system supports parallel processing of multiple sequences, with synchronization points at each major transformation stage to maintain consistency

Multi-resolution prediction subsystem 3120 generates predictions at multiple time horizons through coordinated operation of specialized window processors. Window hierarchy manager subsystem 3121 processes data through short-term windows covering, for example, 10 points, medium-term windows covering, for example, 25 points, and long-term windows covering, for example, 50 points while managing synchronization and resolving resolution conflicts. Temporal weight calculator subsystem 3122 scores importance of different time horizons, calculates resolution-specific losses, optimizes weight distribution, and processes dynamic adjustments. Prediction synthesizer subsystem 3123 integrates cross-resolution predictions, builds consensus across time horizons, validates quality, and estimates confidence levels. Performance monitor subsystem 3124 tracks resolution-specific metrics, assesses cross-resolution quality, optimizes resource utilization, and analyzes error patterns.

Nested window generation flow initializes window hierarchy, processes short-term predictions at 10 points, medium-term predictions at 25 points, and long-term predictions at 50 points while maintaining cross-window synchronization. Resolution weight calculation assesses temporal importance, scores resolution-specific factors, calculates weight distributions, implements dynamic adjustments, and balances across resolutions. Prediction aggregation collects multi-resolution inputs, synthesizes across resolutions, builds prediction consensus, generates final predictions, and assesses quality.

Input specifications require multi-resolution data including sequence specifications for each time horizon, temporal alignment markers, and quality indicators. Internal processing utilizes window-specific parameters, weight distribution formats, synthesis configurations, and temporal relationship markers. Output format provides aggregated predictions with multi-horizon forecast values, confidence metrics per horizon, resolution-specific quality scores, and synthesis quality indicators.

Training procedures, in an embodiment, optimize individual prediction horizons, tune resolution-specific parameters, coordinate across resolutions, and validate performance. Weight optimization distributes initial weights, learns dynamic adjustments, balances across resolutions, and assesses performance. Aggregation training optimizes synthesis parameters, refines consensus building, enhances output quality, and validates system-wide performance.

Performance optimization, in an embodiment, enhances processing through parallel resolution handling, memory access optimization, computation scheduling, and resource utilization balancing, in an embodiment. Memory management optimizes multi-resolution buffers, utilizes caches effectively, allocates memory efficiently, and implements resource sharing protocols. Latency reduction parallelizes pipelines, synchronizes cross-resolution processing, prioritizes processing tasks, and eliminates bottlenecks.

Confidence estimation subsystem 3130 comprises multiple interconnected components that work together to provide uncertainty quantification and reliability assessment for time series predictions.

Uncertainty quantifier 3131 implements, in an embodiment, Monte Carlo dropout during inference, running multiple forward passes with randomly deactivated neurons to generate a distribution of predictions. This subsystem calculates confidence intervals using statistical methods like bootstrapping and quantile estimation. Prediction bounds are generated through both parametric methods, assuming Gaussian distributions, and non-parametric methods based on empirical distributions of the dropout-based predictions. Distribution analysis employs kernel density estimation and mixture modeling to characterize prediction uncertainty.

Historical accuracy analyzer 3132 maintains sliding windows of prediction errors across different time horizons and conditions. Error pattern detection utilizes time series decomposition to separate systematic errors from random variations. Temporal accuracy assessment employs exponential weighting to emphasize recent performance while maintaining historical context. Confidence adjustments are calculated using Bayesian updating based on observed error patterns. Performance trend analysis implements regression models to identify systematic changes in prediction accuracy over time.

Reliability assessment engine 3133 computes quality metrics through normalized error measures and uncertainty calibration scores. Confidence scoring combines multiple indicators including prediction variance, historical accuracy, and model uncertainty estimates. Validation processing implements statistical hypothesis testing to verify reliability metrics. Alert generation uses dynamic thresholding based on rolling statistics of quality measures. Performance tracking maintains separate metrics for different prediction horizons and data regimes.

Meta-analysis subsystem 3134 employs correlation analysis and clustering to identify patterns across multiple predictions. Long-term trend detection uses changepoint detection algorithms to identify shifts in prediction reliability. Systematic bias correction implements adaptive bias terms based on rolling error statistics. Quality improvement recommendations are generated through decision tree analysis of performance metrics and operating conditions.

Through these algorithmic components, confidence estimation subsystem 3130 provides quantitative uncertainty estimates while adapting to changing prediction patterns and maintaining computational efficiency. The subsystem's modular architecture allows for updates and improvements to individual components while maintaining overall system functionality.

Input requirements may include raw prediction values, model state parameters, historical accuracy records, temporal context markers, and quality indicators. Internal processing utilizes confidence interval parameters, error distribution metrics, reliability scores, and historical pattern records. Output format may include prediction intervals, confidence scores, reliability indicators, error bounds, and quality assessments.

Training procedures, in various embodiments, optimize dropout patterns, refine interval calculations, tune bound generation, and validate performance for uncertainty quantification. Historical analysis training recognizes error patterns, learns temporal correlations, optimizes adjustment factors, and assesses accuracy. Reliability score training tunes scoring parameters, calibrates quality metrics, refines reliability assessment, and verifies performance.

Performance optimization may include parallel inference execution, batch confidence calculation, memory access optimization, and resource utilization balancing. Memory management implements historical data buffering, cache utilization strategies, memory allocation efficiency, and state retention optimization. Latency reduction employs pipeline parallelization, confidence calculation optimization, processing prioritization, and bottleneck elimination.

Through these components and processes, confidence estimation subsystem 3130 provides comprehensive uncertainty quantification and reliability assessment capabilities for time series predictions while maintaining computational efficiency and performance.

Historical pattern library 3140 implements efficient storage and retrieval of time series patterns in latent space. Pattern storage manager 3141 employs locality-sensitive hashing for latent space indexing, hierarchical clustering for pattern categorization, and adaptive compression for storage optimization. Retrieval acceleration uses approximate nearest neighbor search algorithms, while consistency validation implements checksum verification and redundancy checks.

Pattern matching engine 3142 calculates similarity using cosine distance metrics in latent space, ranks matches using weighted scoring functions, and analyzes context through temporal windowing. Feature comparison employs dimensionality reduction techniques, with quality assessment based on statistical significance testing of match scores.

Outcome analysis system 3143 maintains running statistics of prediction success rates, evaluates pattern effectiveness through regression analysis, and calculates prediction adjustments using weighted averaging of historical outcomes. Performance tracking implements time-decay metrics to emphasize recent outcomes.

Pattern evolution tracker 3144 detects temporal drift using changepoint analysis, manages pattern aging through exponential decay functions, and schedules updates based on usage frequency. Integration interface 3145 coordinates data exchange using publish-subscribe mechanisms, synchronizes state through distributed consensus protocols, and allocates resources using priority queuing.

Knowledge base optimizer 3146 implements compression using principal component analysis, analyzes access patterns through frequency counting, and optimizes cache using least-recently-used replacement policies. Performance tuning employs gradient-based optimization of retrieval parameters.

Input processing may accept, for example, latent space vectors encoded from time series data, along with temporal sequences and metadata. Internal storage maintains vector representations in compressed format with corresponding pattern characteristics and historical outcomes. Output generation provides similar pattern vectors with confidence scores and outcome predictions.

Training procedures in various embodiments optimize storage through index structure learning and retrieval efficiency tuning. Pattern matching training refines similarity metrics and ranking algorithms through supervised learning on known pattern pairs. Outcome analysis training tunes success metrics and adjustment calculations using historical performance data.

Performance optimization in various embodiments focuses on storage efficiency through optimized index structures and compression techniques. Search performance improvements utilize parallel pattern matching and cached query results. Analysis efficiency maintains through optimized outcome calculations and balanced resource utilization.

Through these components and algorithms, historical pattern library 3140 provides efficient storage, matching, and analysis of time series patterns while maintaining scalability and performance. Integration with other subsystems enables pattern-based prediction enhancement and knowledge transfer across different time series.

Cross-series knowledge subsystem 3150 facilitates knowledge transfer between different time series through multiple interconnected components. Transfer learning engine 3151 implements pattern extraction using convolutional filters, manages knowledge bases through distributed storage systems, and detects features using hierarchical feature learning. Transfer optimization employs gradient-based methods while performance validation uses cross-validation on held-out data.

Series relationship analyzer 3152 detects correlations through, for example, sliding window analysis, maps features using dimensionality reduction techniques, and assesses similarities using distance metrics in feature space. Pattern matching utilizes approximate nearest neighbor search, while relationship strength calculations employ weighted scoring functions.

Quick adaptation engine 3153 processes fast learning through few-shot learning techniques, optimizes knowledge transfer using meta-learning approaches, and tracks performance through rolling statistics. Resource management implements priority-based allocation for computational resources.

Meta-knowledge manager 3154 analyzes cross-domain patterns using clustering algorithms, detects universal features through unsupervised learning, and consolidates knowledge using weighted averaging. Quality assessment employs statistical significance testing of transfer results.

Integration controller 3155 coordinates cross-system operations through message passing interfaces, allocates resources using scheduling algorithms, and synchronizes states through distributed consensus protocols. Performance monitoring implements real-time metrics collection and analysis.

Input processing may handle multiple time series values, relationship metadata, and feature descriptions. Internal processing maintains shared pattern vectors and relationship matrices in distributed storage. Output generation provides adapted knowledge and cross-series insights with associated confidence metrics.

Training procedures may optimize pattern extraction and knowledge base organization through supervised learning on known relationships. Relationship analysis training refines correlation detection and mapping algorithms using historical data. Adaptation mechanism training tunes quick-learn parameters and transfer efficiency through iterative optimization.

Performance optimization, in various embodiments, focuses on transfer speed through accelerated pattern extraction and efficient memory access patterns. Relationship analysis performance improves through parallel processing and cached calculations. Adaptation speed maintains through optimized quick-learn procedures and prioritized processing pipelines.

Through these components and algorithms, cross-series knowledge subsystem 3150 enables efficient knowledge transfer between time series while maintaining computational performance. Integration with other subsystems facilitates improved prediction accuracy through shared knowledge across different domains.

Hybrid reconstruction subsystem 3160 optimizes multiple reconstruction objectives while maintaining sequence quality. Multi-objective optimizer 3161 scores sequence reconstructions using mean squared error metrics, validates statistical properties through hypothesis testing, and processes trend analysis using regression techniques. Balance optimization implements Pareto-efficient solutions while quality assessment employs multiple validation criteria.

Weight management engine 3162 calculates objective importance through gradient-based methods, adjusts weights dynamically using adaptive algorithms, and tracks performance through rolling statistics. Balance validation implements constraint checking and feasibility analysis.

Training coordinator 3163 aggregates loss functions using weighted combinations, balances training objectives through multi-task learning, and manages cross-validation using k-fold splitting. Performance optimization employs gradient descent with momentum.

Quality assurance subsystem 3164 validates property preservation using statistical tests, checks trend consistency through correlation analysis, and assesses statistical accuracy using confidence intervals. Performance monitoring implements real-time metric tracking.

Integration manager 3165 coordinates cross-system operations using message passing protocols, allocates resources through priority scheduling, and synchronizes states using distributed consensus algorithms. Reconstruction validator 3166 assesses output quality through multiple metrics, verifies properties using statistical tests, and validates accuracy using error analysis.

Input processing may handle original sequences, statistical properties, and trend indicators with associated quality markers. Internal processing maintains objective weights and loss calculations in distributed memory. Output generation provides reconstructed sequences with statistical validations and quality metrics.

Training procedures may optimize objective functions and refine reconstruction quality through iterative learning. Weight management training optimizes calculation methods and adjustment mechanisms using historical performance data. Training coordination refines loss functions and tunes objective balancing through cross-validation.

Performance optimization, in various embodiments, focuses on reconstruction efficiency through parallel processing and optimized memory access. Weight management performance improves through accelerated calculations and strategic caching. Training efficiency maintains through optimized loss calculations and resource allocation.

Through these components and algorithms, hybrid reconstruction subsystem 3160 enables multi-objective sequence reconstruction while maintaining computational efficiency. Integration with other subsystems facilitates improved reconstruction quality through balanced optimization of multiple objectives.

Time series processing core 3110 functions as primary system entry point, where time window manager 3111 processes raw time series data through initial preprocessing stages. Padding generator 3112 and latent space processor 3113 then create base representations used by downstream system components.

System interactions flow between major subsystems. Time window manager 3111 sends preprocessed sequences to window hierarchy manager 3121, while latent space processor 3113 provides compressed data to temporal weight calculator 3122. Sequence reconstructor 3114 generates baseline predictions used by prediction synthesizer 3123.

Latent space processor 3113 transmits encoded patterns to pattern storage manager 3141, and training coordinator 3115 supplies performance data to outcome analysis system 3143. Prediction synthesizer 3123 forwards multi-horizon predictions to uncertainty quantifier 3131, as performance monitor 3124 sends metrics to historical accuracy analyzer 3132.

Pattern matching engine 3142 exchanges similarity metrics with series relationship analyzer 3152. Knowledge base optimizer 3146 works with meta-knowledge manager 3154, while pattern evolution tracker 3144 updates transfer learning engine 3151. Transfer learning engine 3151 sends cross-series patterns to multi-objective optimizer 3161, and quick adaptation engine 3153 provides adaptive weights to weight management engine 3162.

Feedback paths exist between subsystems. Quality assurance system 3164 feeds back to training coordinator 3115, while reconstruction validator 3166 updates padding generator 3112. Reliability assessment engine 3133 adjusts temporal weight calculator 3122 weights. Outcome analysis system 3143 provides historical data to training coordinator 3115.

Integration managers 3145, 3155, and 3165 may handle resource coordination, managing memory allocation, processing bandwidth, cache optimization, and load balancing in various embodiments. Each subsystem may maintain local states, synchronized periodically with time series processing core 3110 through integration managers. Critical state changes propagate through integration managers 3145, 3155, and 3165.

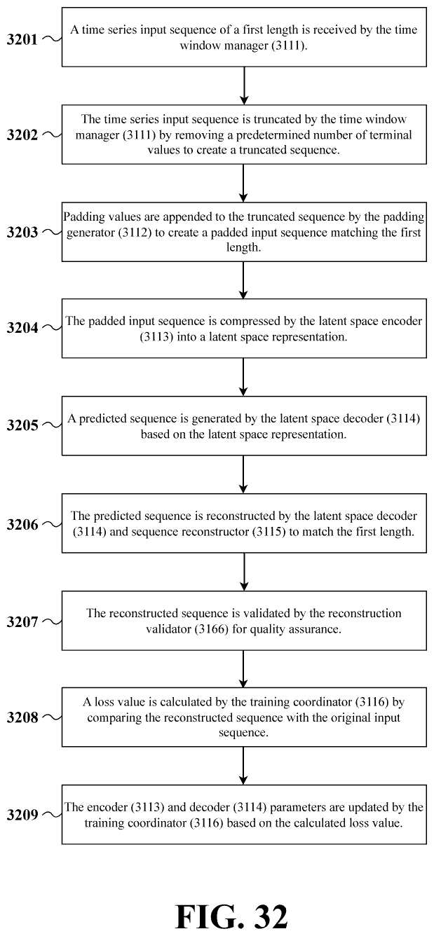

FIG. 32 is a method diagram illustrating the core time-series processing flow of system 3100 in an embodiment. A time series input sequence of a first length is received by the time window manager 3111, which validates and organizes the data into processing windows 3201. The time series input sequence is truncated by the time window manager 3111 by removing a predetermined number of terminal values to create a truncated sequence, with the truncation length dynamically adjusted based on temporal characteristics of the input data 3202. The padding generator 3112 analyzes statistical properties of the time series and applies context-aware padding values to the truncated sequence to create a padded input sequence matching the first length, using attention mechanisms to optimize the padding strategy 3203. The padded input sequence is compressed by the latent space encoder 3113 into a latent space representation through dimensional reduction and feature extraction, while maintaining essential temporal patterns and relationships 3204. A predicted sequence is generated by the latent space decoder 3114 based on the latent space representation, leveraging learned patterns to reconstruct the missing terminal values 3205. The predicted sequence is reconstructed by the latent space decoder 3114 and sequence reconstructor 3115 to match the first length, preserving both statistical properties and trend directions 3206. The reconstructed sequence is validated by the reconstruction validator 3166 for quality assurance, checking pattern consistency and statistical accuracy 3207. A loss value is calculated by the training coordinator 3116 by comparing the reconstructed sequence with the original input sequence across multiple weighted objectives 3208. The encoder 3113 and decoder 3114 parameters are updated by the training coordinator 3116 based on the calculated loss value, optimizing the system's predictive capabilities through iterative refinement 3209.

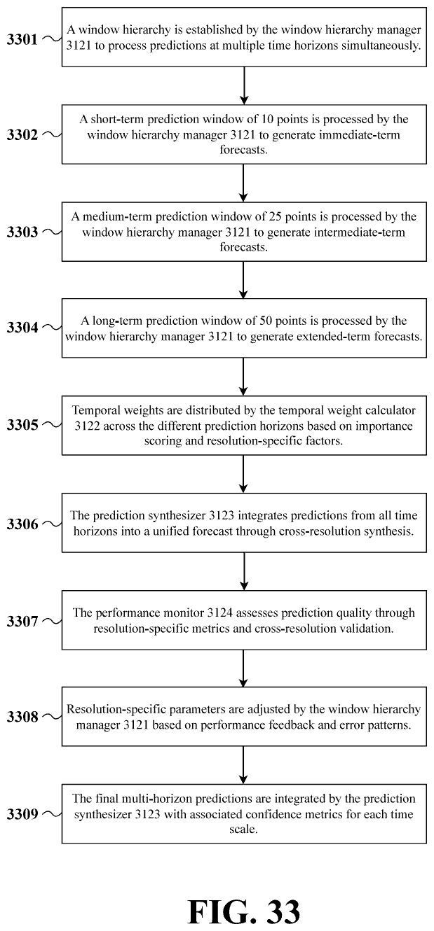

FIG. 33 is a method diagram illustrating the multi-resolution prediction flow of system 3100, in an embodiment. A window hierarchy is established by the window hierarchy manager 3121 to process predictions at multiple time horizons simultaneously, implementing dynamic window sizing and temporal alignment markers 3301. A short-term prediction window of 10 points is processed by the window hierarchy manager 3121 to generate immediate-term forecasts, focusing on high-precision near-term predictions 3302. A medium-term prediction window of 25 points is processed by the window hierarchy manager 3121 to generate intermediate-term forecasts, balancing precision with extended prediction range 3303. A long-term prediction window of 50 points is processed by the window hierarchy manager 3121 to generate extended-term forecasts, capturing broader temporal patterns and trends 3304. Temporal weights are distributed by the temporal weight calculator 3122 across the different prediction horizons based on importance scoring and resolution-specific factors, with dynamic adjustment processes optimizing the balance between horizons 3305. The prediction synthesizer 3123 integrates predictions from all time horizons into a unified forecast through cross-resolution synthesis, employing consensus building algorithms to resolve conflicts between different time scales 3306. The performance monitor 3124 assesses prediction quality through resolution-specific metrics and cross-resolution validation, tracking error patterns across different time horizons 3307. Resolution-specific parameters are adjusted by the window hierarchy manager 3121 based on performance feedback and error patterns, optimizing each prediction horizon independently while maintaining cross-resolution consistency 3308. The final multi-horizon predictions are integrated by the prediction synthesizer 3123 with associated confidence metrics for each time scale, providing a comprehensive forecast with uncertainty quantification across all prediction horizons 3309.

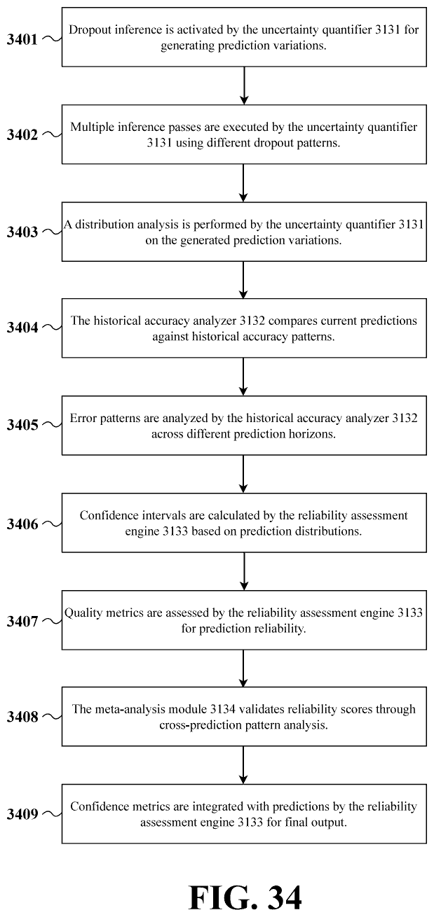

FIG. 34 is a method diagram illustrating the confidence estimation process of system 3100 in an embodiment. Dropout inference is activated by the uncertainty quantifier 3131 for generating prediction variations, initializing randomized neuron deactivation patterns 3401. Multiple inference passes are executed by the uncertainty quantifier 3131 using different dropout patterns, generating a diverse set of predictions that capture model uncertainty 3402. A distribution analysis is performed by the uncertainty quantifier 3131 on the generated prediction variations, employing statistical techniques to characterize the prediction uncertainty and establish initial confidence bounds 3403. The historical accuracy analyzer 3132 compares current predictions against historical accuracy patterns, incorporating temporal decay weights to emphasize recent performance while maintaining historical context 3404. Error patterns are analyzed by the historical accuracy analyzer 3132 across different prediction horizons, using time series decomposition to separate systematic errors from random variations 3405. Confidence intervals are calculated by the reliability assessment engine 3133 based on prediction distributions, combining both parametric and non-parametric statistical methods to generate robust uncertainty estimates 3406. Quality metrics are assessed by the reliability assessment engine 3133 for prediction reliability, implementing multiple validation criteria including statistical consistency and trend preservation 3407. The meta-analysis module 3134 validates reliability scores through cross-prediction pattern analysis, detecting long-term trends and systematic biases in uncertainty estimates 3408. Confidence metrics are integrated with predictions by the reliability assessment engine 3133 for final output, providing comprehensive uncertainty quantification that accounts for both model uncertainty and historical performance 3409.

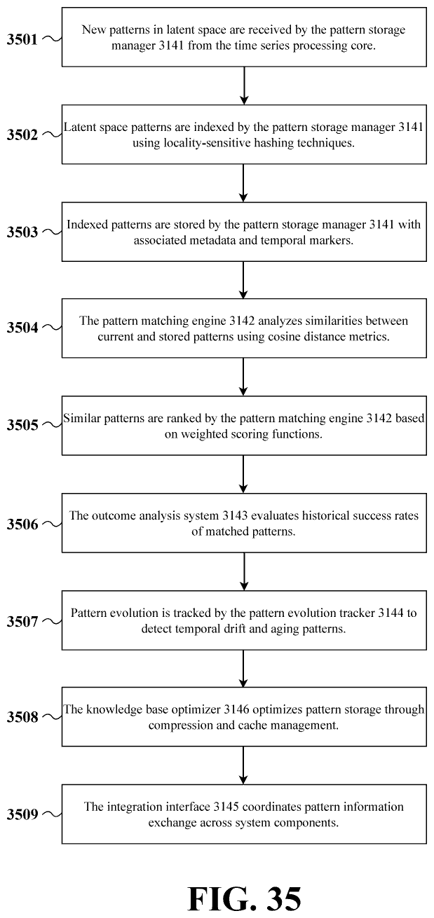

FIG. 35 is a method diagram illustrating the pattern matching and storage process of system 3100 in an embodiment. New patterns in latent space are received by the pattern storage manager 3141 from the time series processing core, with initial validation and quality assessment of the incoming patterns 3501. Latent space patterns are indexed by the pattern storage manager 3141 using locality-sensitive hashing techniques, creating efficient search structures for rapid pattern retrieval and comparison 3502. Indexed patterns are stored by the pattern storage manager 3141 with associated metadata and temporal markers, implementing hierarchical clustering for organized pattern categorization 3503. The pattern matching engine 3142 analyzes similarities between current and stored patterns using cosine distance metrics, employing dimensionality reduction techniques to enhance comparison efficiency 3504. Similar patterns are ranked by the pattern matching engine 3142 based on weighted scoring functions, incorporating contextual relevance and temporal proximity in the ranking criteria 3505. The outcome analysis system 3143 evaluates historical success rates of matched patterns, maintaining running statistics and calculating prediction adjustments through weighted averaging of historical outcomes 3506. Pattern evolution is tracked by the pattern evolution tracker 3144 to detect temporal drift and aging patterns, using changepoint analysis and exponential decay functions to manage pattern relevance over time 3507. The knowledge base optimizer 3146 optimizes pattern storage through compression and cache management, analyzing access patterns and implementing least-recently-used replacement policies 3508. The integration interface 3145 coordinates pattern information exchange across system components, employing publish-subscribe mechanisms and distributed consensus protocols for synchronized pattern utilization 3509.

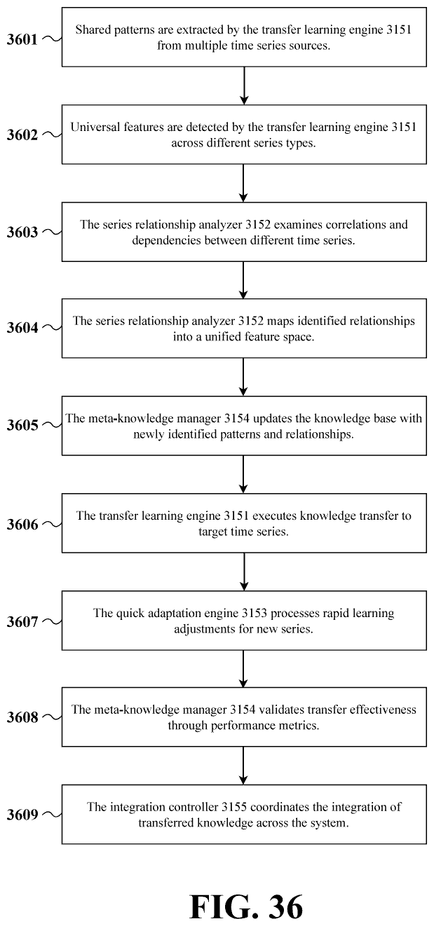

FIG. 36 is a method diagram illustrating the cross-series knowledge transfer method of system 3100 in an embodiment. Shared patterns are extracted by the transfer learning engine 3151 from multiple time series sources, using convolutional filters to identify common structural elements 3601. Universal features are detected by the transfer learning engine 3151 across different series types, employing hierarchical feature learning to capture multi-scale patterns and relationships 3602. The series relationship analyzer 3152 examines correlations and dependencies between different time series, utilizing sliding window analysis and distance metrics in feature space 3603. The series relationship analyzer 3152 maps identified relationships into a unified feature space, applying dimensionality reduction techniques to create efficient representations of cross-series patterns 3604. The meta-knowledge manager 3154 updates the knowledge base with newly identified patterns and relationships, employing clustering algorithms to organize and consolidate the shared knowledge 3605. The transfer learning engine 3151 executes knowledge transfer to target time series, implementing gradient-based optimization methods to adapt shared patterns to specific series characteristics 3606. The quick adaptation engine 3153 processes rapid learning adjustments for new series, utilizing few-shot learning techniques and meta-learning approaches to accelerate knowledge adaptation 3607. The meta-knowledge manager 3154 validates transfer effectiveness through performance metrics, employing statistical significance testing and cross-validation procedures 3608. The integration controller 3155 coordinates the integration of transferred knowledge across the system, using message passing interfaces and distributed consensus protocols to maintain system-wide consistency 3609.

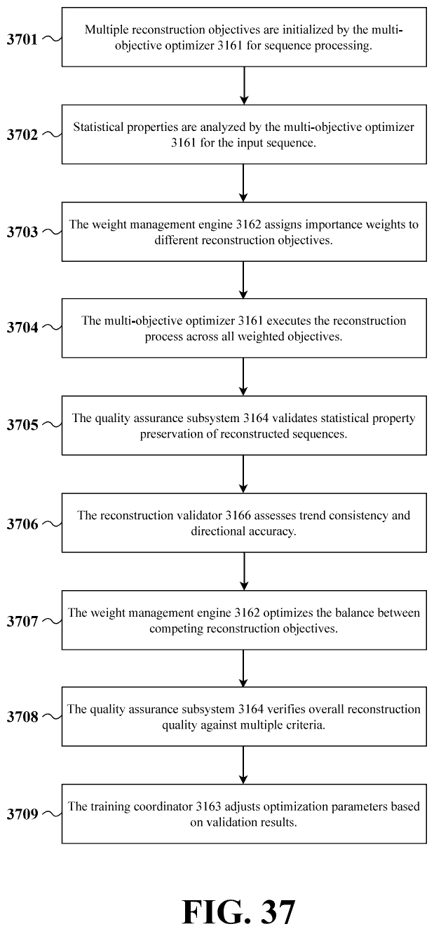

FIG. 37 is a method diagram illustrating the hybrid reconstruction optimization method of system 3100 in an embodiment. Multiple reconstruction objectives are initialized by the multi-objective optimizer 3161 for sequence processing, establishing targets for full sequence reconstruction, statistical property preservation, and trend direction accuracy 3701. Statistical properties are analyzed by the multi-objective optimizer 3161 for the input sequence, employing hypothesis testing and regression techniques to characterize key sequence attributes 3702. The weight management engine 3162 assigns importance weights to different reconstruction objectives, implementing dynamic adjustment algorithms to balance competing priorities 3703. The multi-objective optimizer 3161 executes the reconstruction process across all weighted objectives, utilizing Pareto-efficient solutions to manage trade-offs between different quality metrics 3704. The quality assurance subsystem 3164 validates statistical property preservation of reconstructed sequences, applying rigorous statistical tests to verify distributional characteristics and temporal dependencies 3705. The reconstruction validator 3166 assesses trend consistency and directional accuracy, implementing correlation analysis and pattern consistency checks across multiple time scales 3706. The weight management engine 3162 optimizes the balance between competing reconstruction objectives, employing constraint checking and feasibility analysis to maintain solution validity 3707. The quality assurance subsystem 3164 verifies overall reconstruction quality against multiple criteria, including statistical accuracy, pattern preservation, and temporal consistency 3708. The training coordinator 3163 adjusts optimization parameters based on validation results, implementing multi-task learning approaches to refine the reconstruction process through iterative improvement 3709.

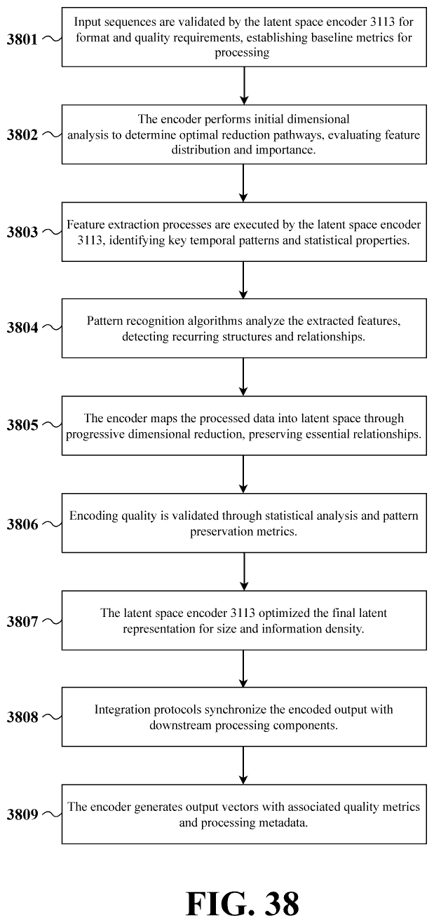

FIG. 38 is a method diagram illustrating the latent space encoding process of system 3100 in an embodiment. Input sequences undergo comprehensive validation through statistical analysis, quality metric computation, and format verification, establishing multidimensional quality baselines that account for temporal consistency, statistical stationarity, and data completeness 3801. Dimensional analysis employs principal component analysis, correlation studies, and information entropy measurements to determine optimal reduction pathways, calculating feature importance scores and distribution characteristics while maintaining temporal dependencies 3802. Feature extraction implements wavelet decomposition, statistical moment analysis, and temporal pattern detection, capturing both local and global characteristics of the time series while preserving critical statistical properties and seasonal patterns 3803. Pattern recognition combines hierarchical clustering, temporal motif detection, and similarity analysis to identify recurring structures, relationships, and dependencies within the data, creating a comprehensive pattern dictionary 3804. The encoding process maps data into latent space through iterative dimensional reduction using variational encoding techniques, preserving essential relationships through careful balancing of compression ratios and information retention 3805. Quality validation employs multiple metrics including reconstruction error measurement, pattern preservation verification, and statistical property comparison, ensuring the encoded representation maintains critical data characteristics 3806. Latent representation optimization applies adaptive compression techniques and entropy coding to achieve optimal size while preserving information density, dynamically adjusting to data characteristics 3807. Integration protocols implement synchronized state management and data flow control, ensuring seamless interaction with other system components through standardized interfaces 3808. Output generation produces latent vectors accompanied by comprehensive metadata including quality metrics, encoding parameters, and statistical summaries 3809.

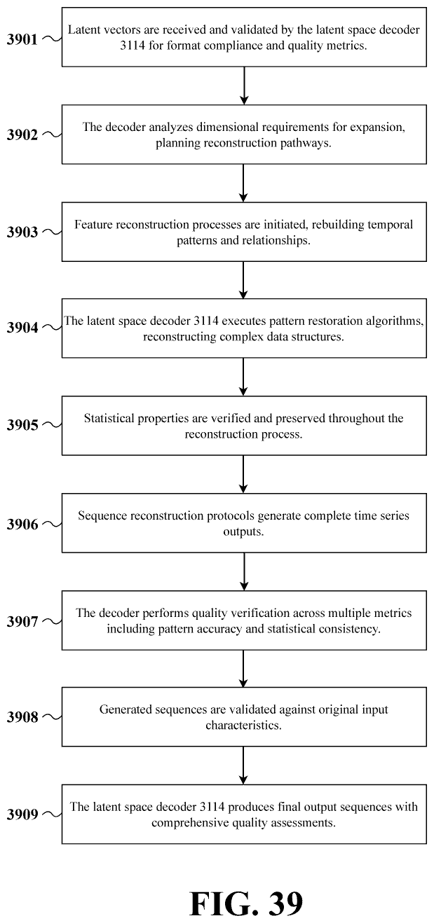

FIG. 39 is a method diagram illustrating the latent space decoding process of system 3100 in an embodiment. Latent vectors undergo rigorous validation including format verification, quality metric assessment, and consistency checking, establishing baseline criteria for reconstruction accuracy and reliability 3901. Dimensional expansion analysis employs adaptive scaling techniques and feature importance weighting to determine optimal reconstruction pathways, planning progressive restoration of temporal patterns and statistical properties 3902. Feature reconstruction implements inverse transformations and pattern matching algorithms to rebuild temporal structures and relationships, utilizing stored pattern dictionaries and statistical models 3903. Pattern restoration employs hierarchical reconstruction techniques and temporal consistency enforcement to rebuild complex data structures, ensuring coherence across multiple time scales 3904. Statistical property preservation implements moment matching, distribution alignment, and temporal correlation maintenance throughout the reconstruction process, ensuring consistency with original data characteristics 3905. Sequence reconstruction protocols utilize adaptive interpolation, pattern-based generation, and temporal consistency enforcement to produce complete time series outputs that maintain both local and global structure 3906. Quality verification implements multiple validation stages including pattern accuracy assessment, statistical property comparison, and temporal consistency checking, ensuring reconstruction fidelity 3907. Generated sequences undergo comprehensive validation against original input characteristics through statistical testing, pattern matching, and temporal correlation analysis 3908. Final output generation produces reconstructed sequences with detailed quality assessments, confidence metrics, and statistical property verification 3909.

These processes maintain continuous feedback loops enabling dynamic optimization of encoding and decoding parameters. The encoding process emphasizes efficient compression while preserving essential patterns through careful feature selection and dimensional reduction. The decoding process focuses on accurate reconstruction through progressive feature restoration and statistical property preservation, ensuring high-fidelity output generation while maintaining computational efficiency.

System 3100's time series prediction capabilities may be applied across diverse domains to address various real-world challenges. For instance, in urban traffic management, the system could predict congestion patterns across multiple intersections to optimize signal timing. In renewable energy integration, it could forecast wind turbine performance by analyzing vibration signatures and stress measurements to predict maintenance needs. The system could enhance supply chain optimization by predicting inventory levels across multiple warehouses while accounting for seasonal demands and supplier constraints. In agricultural applications, it could process soil sensor data to predict irrigation needs and crop yields. For financial risk management, it could analyze transaction patterns to detect fraudulent activities in real-time. In climate science, it could process atmospheric data to predict severe weather events. Within telecommunications, it could forecast network loads across different cell towers to prevent service degradation. The system's ability to handle multiple time horizons while providing confidence estimates makes it particularly valuable in scenarios where early warning and proactive response are critical for operational success.

In a non-limiting use case example, system 3100 may be employed in electricity demand forecasting for a power grid. Time series processing core 3110 receives input sequences representing hourly electricity consumption data with a length of 1000 hours. The time window manager 3111 truncates the last 50 hours of data, while the padding generator 3112 applies context-aware padding based on historical usage patterns, seasonal trends, and weather data.

The latent space encoder 3113 compresses this padded sequence into a compact representation that captures essential consumption patterns, daily cycles, and weekly trends. Meanwhile, the multi-resolution prediction subsystem 3120 generates forecasts at multiple horizons—10 hours for immediate operational planning, 25 hours for day-ahead scheduling, and 50 hours for longer-term resource allocation.

The confidence estimation subsystem 3130 provides uncertainty bounds for each prediction horizon, accounting for factors like weather variability and historical prediction accuracy. The historical pattern library 3140 matches current consumption patterns with similar historical periods, while the cross-series knowledge subsystem 3150 leverages patterns learned from related substations or regions.

The hybrid reconstruction subsystem 3160 ensures the predicted consumption values maintain both statistical properties (like daily min/max patterns) and trend directions (such as gradual demand increases during peak hours). The system generates predictions with associated confidence intervals, enabling grid operators to optimize power distribution while maintaining appropriate reserve margins.

This application demonstrates the system's ability to handle complex time series data with multiple seasonal patterns, external influences, and the need for multi-horizon predictions with uncertainty quantification. However, the system's capabilities are not limited to electricity demand forecasting and may be applied to various time series prediction tasks across different domains.

In another non-limiting use case example, system 3100 may be employed in hospital patient monitoring for early detection of clinical deterioration. The time series processing core 3110 receives input sequences of patient vital signs, including heart rate, blood pressure, respiratory rate, and oxygen saturation, with each sequence containing 1000 minutes of data. The time window manager 3111 truncates the last 50 minutes of data, while the padding generator 3112 applies context-aware padding based on patient-specific baselines and known physiological patterns.

The latent space encoder 3113 compresses these multi-parameter sequences into compact representations that preserve crucial physiological relationships and temporal dependencies. The multi-resolution prediction subsystem 3120 generates predictions at different time horizons—5 minutes for immediate clinical response, 15 minutes for near-term care planning, and 30 minutes for resource allocation and staff scheduling.

The confidence estimation subsystem 3130 calculates uncertainty bounds for each prediction, incorporating factors such as measurement reliability and patient-specific variability. The historical pattern library 3140 identifies similar deterioration patterns from previous cases, while the cross-series knowledge subsystem 3150 leverages patterns learned across different patient populations and conditions.

The hybrid reconstruction subsystem 3160 ensures the predicted vital signs maintain both physiologically plausible relationships and clinically relevant trends. The system generates predictions with confidence intervals for each vital sign, enabling medical staff to anticipate potential deterioration and intervene proactively.

This application demonstrates the system's ability to process multiple concurrent time series with complex interdependencies while providing actionable predictions at different time horizons. However, the system's capabilities are not limited to patient monitoring and may be applied to various time series prediction tasks across different domains.

In another non-limiting use case example, system 3100 may be employed in manufacturing quality control for predictive defect detection in semiconductor wafer production. In this non-limiting example, the time series processing core 3110 receives input sequences from multiple sensor streams monitoring the photolithography process, with each sequence containing 2000 seconds of high-frequency measurements including temperature, pressure, optical alignment, and particle counts. The time window manager 3111 truncates the last 100 seconds of data, while the padding generator 3112 applies context-aware padding based on equipment-specific baselines and known process variations.

The latent space encoder 3113 compresses these multi-sensor sequences into compact representations that preserve critical process relationships and microscale temporal patterns. The multi-resolution prediction subsystem 3120 generates predictions at different time horizons—b 15 seconds for real-time process adjustment, 45 seconds for preventive intervention, and 90 seconds for batch quality forecasting.

The confidence estimation subsystem 3130 calculates uncertainty bounds for each prediction, incorporating factors such as equipment drift and environmental variability. The historical pattern library 3140 identifies similar defect patterns from previous production runs, while the cross-series knowledge subsystem 3150 leverages patterns learned across different equipment types and product specifications.

The hybrid reconstruction subsystem 3160 ensures the predicted measurements maintain both physically realistic relationships and manufacturing tolerance limits. The system generates predictions with confidence intervals for each sensor stream, enabling operators to adjust process parameters proactively and prevent defect formation.

This application demonstrates the system's ability to process high-frequency sensor data with strict physical constraints while providing predictions at manufacturing-relevant timescales. However, the system's capabilities are not limited to semiconductor manufacturing and may be applied to various time series prediction tasks across different domains.

### Exemplary Computing Environment

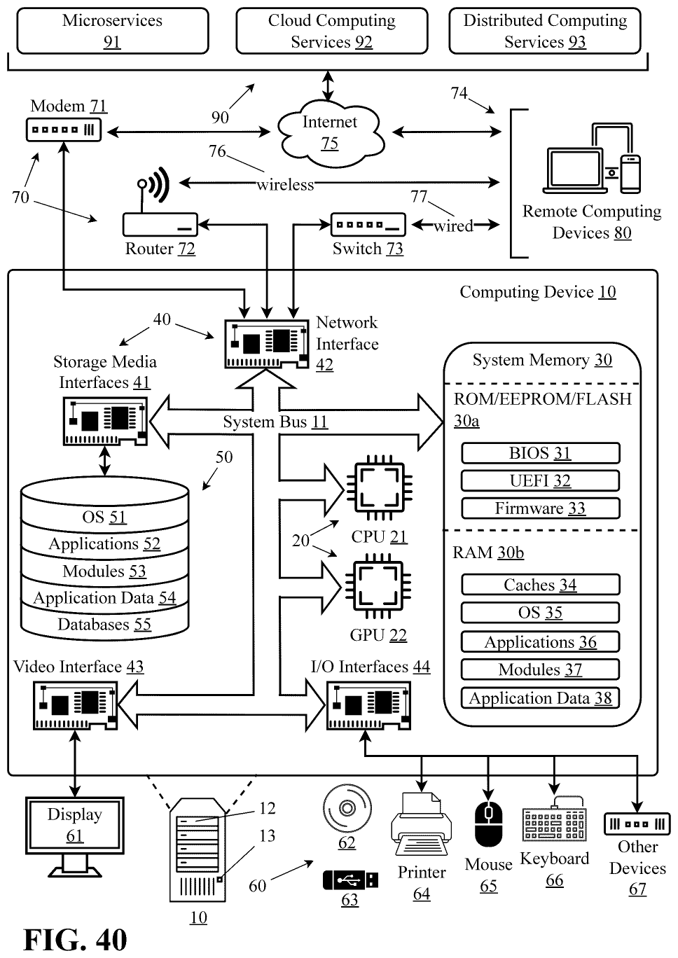

FIG. 40 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

1. A deep learning system for time series prediction comprising:
a data preprocessor configured to:
receive a time series input sequence of a first length;
truncate the time series input sequence by removing a predetermined number of terminal values to create a truncated sequence;
append padding values to the truncated sequence to create a padded input sequence matching the first length;
an encoder configured to compress the padded input sequence into a latent space representation;
a decoder configured to reconstruct, from the latent space representation, a predicted sequence matching the first length, wherein the decoder is trained to reconstruct values matching the removed terminal values in positions corresponding to the padding values;
a training system configured to optimize the encoder and decoder by minimizing differences between original time series input sequences and corresponding predicted sequences;
a pattern matching engine configured to compare the latent space representation of the truncated sequence against a plurality of historical patterns; and
an outcome analysis system configured to modify the predicted sequence based on the results of the pattern matching engine.

2. The system of claim 1, further comprising a time window manager configured to dynamically adjust the first length and the predetermined number of terminal values based on temporal characteristics of the time series input sequence.

3. The system of claim 1, wherein the decoder is configured to generate predictions at multiple time horizons by reconstructing nested subsets of the removed terminal values, and wherein the training system applies different weights to reconstruction errors at different time horizons.

4. The system of claim 1, further comprising a confidence estimation subsystem configured to generate confidence intervals for the predicted values by applying dropout during inference.

5. The system of claim 1, wherein the data preprocessor includes an adaptive padding generator subsystem configured to learn optimal padding values based on statistical properties of the time series input sequence.

6. The system of claim 1, further comprising:
a pattern library storing historical patterns in latent space;
a pattern matching engine configured to identify similar historical patterns to the current truncated sequence; and
an outcome analysis system integrated with the pattern matching engine, configured to modify the predicted sequence based on outcomes of similar historical patterns.

7. The system of claim 1, further comprising a cross-series knowledge subsystem including a transfer learning engine configured to:
learn shared patterns across multiple related time series;
store the shared patterns in a knowledge base; and
apply the shared patterns to improve predictions for new time series with limited training data.

8. The system of claim 1, wherein the training system implements multiple reconstruction objectives comprising:
full sequence reconstruction;
statistical property preservation; and
trend direction accuracy;
wherein the multiple reconstruction objectives are weighted according to configurable importance factors.

9. The system of claim 1, wherein the encoder and decoder comprise a transformer-based architecture operating directly on latent space vectors without embedding or positional encoding layers.

10. A method for time series prediction comprising:
receiving, by a data preprocessor, a time series input sequence of a first length;
truncating the time series input sequence by removing a predetermined number of terminal values to create a truncated sequence;
appending padding values to the truncated sequence to create a padded input sequence matching the first length;
compressing, by an encoder, the padded input sequence into a latent space representation;
reconstructing, by a decoder from the latent space representation, a predicted sequence matching the first length, wherein the decoder is trained to reconstruct values matching the removed terminal values in positions corresponding to the padding values;
optimizing the encoder and decoder by minimizing differences between original time series input sequences and corresponding predicted sequences;
comparing a latent space representation of the truncated sequence against a plurality of historical patterns to identify similar historical patterns; and
modifying the predicted sequence based on outcomes of the similar historical patterns identified by the pattern matching engine.

11. The method of claim 10, further comprising dynamically adjusting the first length and the predetermined number of terminal values based on temporal characteristics of the time series input sequence.

12. The method of claim 10, further comprising:
generating predictions at multiple time horizons by reconstructing nested subsets of the removed terminal values; and
applying different weights to reconstruction errors at different time horizons.

13. The method of claim 10, further comprising generating confidence intervals for the predicted values by applying dropout during inference.

14. The method of claim 10, further comprising learning optimal padding values based on statistical properties of the time series input sequence.

15. The method of claim 10, further comprising:
storing historical patterns in latent space;
identifying similar historical patterns to the current truncated sequence; and
modifying the predicted sequence based on outcomes of similar historical patterns.

16. The method of claim 10, further comprising:
learning shared patterns across multiple related time series;
storing the shared patterns in a knowledge base; and
applying the shared patterns to improve predictions for new time series with limited training data.

17. The method of claim 10, wherein optimizing the encoder and decoder comprises implementing multiple reconstruction objectives comprising:
full sequence reconstruction;
statistical property preservation; and
trend direction accuracy;
wherein the multiple reconstruction objectives are weighted according to configurable importance factors.

18. The method of claim 10, wherein compressing and reconstructing comprise operating directly on latent space vectors without embedding or positional encoding layers using a transformer-based architecture.
